(19) United States
(12) Patent Application Publication
(10) Pub. No.: US 2026/0319918 A1
(43) Pub. Date: Oct. 15, 2026

(54) SYSTEM AND METHODS FOR TESTING MICROSERVICES

(71) Applicant: SKYRAMP INC., San Francisco, CA (US)

(72) Inventors: Nithin MICHAEL, San Francisco, CA (US); Ki Suh LEE, San Francisco, CA (US); Kolja HECK, San Francisco, CA (US); Syed ABDUR, San Francisco, CA (US); Roshini MICHAEL, San Francisco, CA (US); Shiny CHIMRA, San Francisco, CA (US); Mrugesh MASTER, San Francisco, CA (US); Per PETTERSSON, San Francisco, CA (US); Jacob POYE, San Francisco, CA (US); Mourad CHELFI, San Francisco, CA (US)

(21) Appl. No.: 19/718,512

(22) Filed: Jun. 24, 2026

Related U.S. Application Data
(63) Continuation-in-part of application No. 18/500,729, filed on Nov. 2, 2023.
(63) Continuation-in-part of application No. 18/500,736, filed on Nov. 2, 2023.
(60) Provisional application No. 63/421,840, filed on Nov. 2, 2022.
(60) Provisional application No. 63/421,840, filed on Nov. 2, 2022.
(60) Provisional application No. 63/829,235, filed on Jun. 24, 2025.

(51) Int. Cl. G06F 11/3604

(52) U.S. Cl. CPC G06F 11/3608

(57) ABSTRACT

Skyramp integrates AI that tests code with AI that writes code to understand application behavior and environment and enable autonomous code development. The platform fully automates software testing by automatically generating, validating and maintaining tests to provide full-stack coverage. It automatically exercises and tests every layer of a target application from backend services and databases to APIs and UI flows, and load testing. A developer simply describes a scenario, records user interactions, or points at a target application or API specs and the platform automatically generates a full test suite including functional and performance tests, covering everything from API endpoints to full user flows. Skyramp automatically generates and maintains regression tests and performs regression testing including running a defined set of tests against every code change during development to verify that previously working functionality continues to work.

### RELATED APPLICATION

This application claims the benefit of United States (US) Patent Application No. 63/829,235, filed Jun. 24, 2025.

This application is a continuation in part application of U.S. patent application Ser. Nos. 18/500,729 and 18/500,736, both filed Nov. 2, 2023, both of which claim the benefit of U.S. Patent Application No. 63/421,840, filed Nov. 2, 2022.

### TECHNICAL FIELD

Embodiments are generally directed to integration, performance, and testing of cloud native applications and, more particularly, to systems and methods for interactive isolation and testing of cloud native microservices.

### BACKGROUND

Testing of cloud native applications under development is difficult and time consuming and can significantly slow the development process. The complexity involved in setting up test frameworks often introduces significant delays in software development, and for this reason is often pushed back to a later point in the development cycle. However, issues uncovered late in the development cycle are frequently much more complicated and time consuming to resolve. The flexibility of distributed software development brings with it the challenge of rapidly identifying and resolving problems, whether they be functional of performance, that can lurk among the various microservices making up an application. Consequently, there is a need for a testing solution that automates the setup of a testing framework and enables incremental testing of microservices in a simple and extensible manner.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE FIGURES

FIG. 1 is a block diagram of the Skyramp architecture, under an embodiment.

FIG. 2 is a flow diagram of a Skyramp method for testing an application, under an embodiment.

FIGS. 3A-3P show a screenshot sequence for Skyramp when testing and mocking microservices in a Kubernetes cluster, under an embodiment.

FIGS. 4A-4M show a screenshot sequence when using the hot code reload feature of Skyramp to enable real-time iterative testing and debugging of code, under an embodiment.

FIGS. 5A-5K show a screenshot sequence for Skyramp when testing and mocking microservices in a Docker cluster in any dev environment using GitHub code spaces, under an embodiment.

FIG. 6 is a block diagram of Skyramp components, under an alternative embodiment.

FIG. 7 is a flow diagram of deployment of Skyramp components, under an alternative embodiment.

FIG. 8 is a flow diagram of Skyramp deployment of a target (e.g., “up” command), under an alternative embodiment.

FIG. 9 is a block diagram of Skyramp components in an example deployment, under an alternative embodiment.

FIG. 10 is a block diagram of the Skyramp architecture comprising the MCP server, under an embodiment.

FIG. 11 is a block diagram of the Skyramp testbot architecture, under an embodiment.

### DETAILED DESCRIPTION

Embodiments described herein, and referred to herein as “Skyramp”, significantly reduce or eliminate the challenges encountered in the testing of cloud native applications by providing an interactive testing product where users can “probe” a microservice in insolation by mocking dependencies. Skyramp is configured for local integration, performance, and load testing, and works with any language. Skyramp reduces the burdens of testing by making it easy to deploy (locally or remotely) any subset of the application or “target” by automatically mocking in the cluster the necessary dependencies, enabling interaction with targets by triggering any application programming interface (API) endpoints needed during the testing, and storing functional and performance tests for quick future access/use.

The following terms as they may be used herein are intended to have the general meaning described below. The terms are not however limited to the meanings stated herein as the meanings of any term can include other meanings as understood in the art or as applied by one skilled in the art.

“API Signature” as used herein includes the parameters comprising the API request and/or response along with their data types, ranges, and any additional constraints.

“Binary” or “Skyramp binary” as used herein includes the executable which a developer can download to interact with Skyramp. This executable is used on the local terminal to run various commands to trigger Skyramp workflows.

“Container” as used herein includes an atomic unit of describing the microservice-under-test, or an ingredient list so to speak.

“Container Description” as used herein includes everything needed to bring up the container in question, including links to binaries, listening ports, API signatures, and other services with which the container communicates.

“Microservice-under-test” as used herein includes any service that the user wishes to evaluate for functionality or performance. Microservice-under-test will have one or more containers that are implemented. The service under test might have multiple APIs working together in conjunction for gathering the necessary parameters to exercise the service. These may come from mocks that are user defined or from direct inputs that are user defined.

“Mocker” as used herein includes a feature of the Worker directed to Mocking. Using a provisioned Kubernetes cluster, the Worker is Helm-installed into the cluster. The Skyramp binary can then be used to run “mocker create” to create default configurations for mock values and to run “mocker deploy” to configure the running worker with the mock values. Note the Mocker feature does not require the cluster, application, etc. of the user to be deployed via Skyramp, rather, it will work in a pre-provisioned cluster where the arbitrary software is already running.

“Project directory” as used herein includes the root of the directory where Skyramp-related configurations for mocks, targets, tests, etc. reside. It can comprise folders for the aforementioned configurations (such as mocks/, targets/, tests/). This directory is intended to live in a source-controlled repository so a developer can save and modify the Skyramp configurations over time. Note that this is different from Skyramp system level configurations (such as resources for remote VMs, licensing information, panic logs, etc.) which reside in “~/.skyramp”.

“Skyramp Input” as used herein includes the set of inputs required for a test-container description, test description, tes etc.

“Target” as used herein includes a subset of an application to deploy. The targets/folder in a Skyramp project include all defined targets. These comprise information about which containers to bring up, which ones are mocked, and other configurations relevant to the bring up.

“Test” as used herein includes an attempt at evaluating functional or performance metrics for a particular target. A test can include one or more APIs for the target.

“Test Inputs” as used herein includes inputs to the target (microservice-under-test).

“Trace” as used herein includes a way for the user to provide sample input/s corresponding to the API signatures that the test relies on to run successfully. This is useful when the APIs called rely on non-primitive data types for inputs.

“Worker” or as used herein includes a container which runs in a Kubernetes cluster and includes functionality such as mocking and testing.

All example code blocks and descriptions described herein are presented as examples only and actual code necessary to implement the corresponding functionality is not limited by these examples.

For teams with modular application architectures, there is a sense that testing is inadequate. Specifically, sufficient functional integration and performance tests (also called services tests) are missing both in the inner dev loop and in the pipeline. The current reality is that it is very difficult to effectively model the system under test, execute good tests and avoid costly production outages.

In the inner dev loop, with the proliferation of microservices architectures, it has become very difficult for engineers to test beyond unit tests while developing and debugging. The problems stem from there being a lack of easy tooling either to isolate the subsystem under development reliably or to evaluate any scenario more complicated than point API tests. This forces engineers to rely on pipeline tests with costly feedback delays. Since existing pipeline tests do not usually cover new functionality, this state of affairs almost guarantees that problems are caught very late or worse, in production.

For pipeline tests, the test pyramid is the well accepted organizing principle (see e.g., https://martinfowler.com/articles/practical-test-pyramid.html). However, most teams have a test hourglass with many unit tests and end-to-end tests but very few services tests. Unfortunately, unit tests do not verify application functionality and given the combinatorial complexity of testing modern microservices applications, end-to-end tests are insufficient. On the flipside, this is indicative of a willingness among engineers to write more tests when an easy test writing pattern is available. The problem is that for services tests, each team typically has a poorly maintained DIY framework which presents a barrier to their own engineers to easily create these tests as critical as they are.

Modern modular applications typically communicate via APIs. It logically follows that services tests for these applications are chains of requests and responses. To make services testing easier, then it is necessary to have an “easy” API client and server. Here “easy” refers to user experience (UX) that is context dependent, but in all cases Skyramp described herein lets the engineer focus on the test payload instead of the attendant boilerplate code and networking required to make a test work.

Skyramp is configured for use by developers in writing and running services tests for modern modular applications as part of their workflow (e.g., quality assurance (QA), test automation engineers and developers, etc.) and, as such, is configured for use in functional integration and performance testing in situations including inner dev loop and pipeline as described in detail herein.

For the inner dev loop, Skyramp can be configured on the fly from the integrated development environment (IDE) or terminal to easily and dynamically execute complex requests and mock responses to test code while it is being written. Therefore, when a user is building and fixing their microservices, Skyramp is configured to help them test things as they go, so problems are detected early.

For writing pipeline tests, Skyramp is packaged as a library that saves on lines of code while dramatically improving readability and modularity by exposing primitives to isolate the system under test, trigger functional and performance test requests, configure mocks etc. In the pipeline phase, when the code is ready to push, Skyramp is configured for use in the automated testing pipeline to ensure everything still works correctly.

Skyramp generally includes a system comprising a library component executing on a client computer. The library component comprises a deployer configured to deploy in a cluster a microservice of an application. Skyramp further comprises a worker component executing in the cluster and coupled to the library component. The worker component comprises a tester and a mocker. The tester is configured to execute a test to test operation of the microservice. The mocker is configured to execute a mock to mimic the endpoints of the microservice during the test.

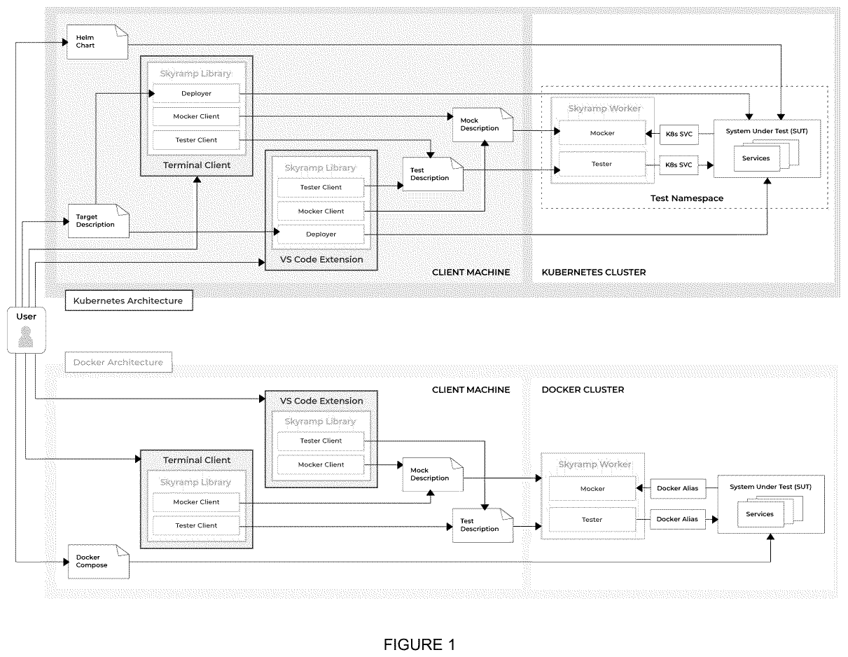

More specifically, FIG. 1 is a block diagram of the Skyramp architecture, under an embodiment. The Skyramp architecture includes a Skyramp Library (also referred to herein as the “library”), a Skyramp Worker (also referred to herein as the “worker”), and Skyramp Clients including a terminal client, a mocker client, and a tester client. The library includes the mocker client and tester client. The worker includes a mocker component (also referred to herein as the “mocker”) and a tester component (also referred to herein as the “tester”). Skyramp is configured to support both Kubernetes and Docker Compose cluster orchestration as shown in the architecture diagram and described in detail herein.

Skyramp exposes all key abstractions used for distributed testing via the library on the client side. For inner development (“dev”) loop testing the functionality of the library is configured to be accessed through the terminal client, the mocker client and the tester client. Alternatively, a user can directly use the libraries in their continuous integration (CI) pipelines to create custom testing solutions. Additionally, Skyramp includes a deployer configured as a client-side abstraction exposed by the library and configured to deploy a subset of an application given a Helm Chart.

The library in the client environment is configured to interact with the worker deployed in-cluster to implement service mocking and testing via the mocker and the tester of the worker, respectively. The worker is deployed into the cluster via Helm or Docker Compose and is configured to implement the core functionality of mocker and tester. Communication with the worker happens either directly via the library or by using one or more of the mocker and tester clients. The worker provides management features that are useful for testing and development including running and managing mocks, generating load for tests, and managing and visualizing tests but are not so limited.

Generally, when a developer wants to get a system under test up and running, the deployer is used to bring up just the services targeted for testing. Deployer is also configured to increase the speed of test iterations through features like hot code reload described herein. Mocker can be thought of as a master of disguise for target services because it is configured to mimic or pretend to be other endpoint services so a developer can easily isolate the services under test. Tester runs desired tests and neatly organizes the results while making it easy to reach hard-to-get-to endpoints in a cluster.

Skyramp further includes a terminal client and a VS Code extension for inner dev loop testing. The terminal client includes a comprehensive list of command line interface (CLI) commands configured for use in ad-hoc testing. The VS Code extension provides a visual way to interact with Skyramp from the development environment.

With distributed applications a developer cannot solely rely on unit tests and end-to-end tests because the combinatorial complexity is just too high. Consequently, distributed integration and performance testing of key parts of applications is needed. Skyramp provides a flexible way to enable distributed testing of modular applications by being configured to enable a developer to bring up just a portion of an application, isolate the microservices for testing, and easily trigger tests and get meaningful results that are easy to parse.

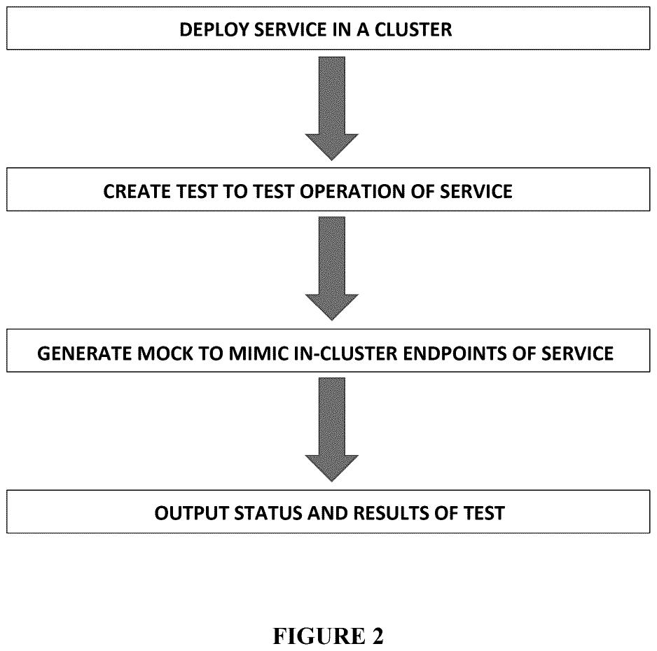

FIG. 2 is a flow diagram of a Skyramp method for testing an application, under an embodiment. The method is configured to deploy within a cluster at least one microservice of the application 202. The method is further configured to generate a test configured to test operation of the microservice 204 and generate a mock configured to mimic in the cluster endpoints of the microservice when the test is executing 206. Additionally, the method comprises providing status and results of the test when executed on the microservice 208.

Detailed descriptions follow of the components and methods of Skyramp.

### Skyramp Used Through VS Code

For testing in the inner dev loop, Skyramp is configured for use through either the VS Code Extension or the Terminal Client as described herein. The following describes the use of Skyramp through VS Code Extension. Skyramp is configured to enable developers to easily isolate services under test from surrounding dependencies and write and run integration and performance tests as you develop and debug, directly in VS Code.

The “Set Up Cluster” command is run to configure a Kubernetes cluster to use with Mocker and Tester. A new Worker container is then deployed or installed in the cluster by running the “Deploy New Worker Container” command.

Mocker is an in-cluster solution configured to create API mock servers. To use mocker in the VS code extension to mock a service, run the “Generate Mock” command to generate a mock configuration in the form of a “yaml” file in the mocks folder of the working directory. An API schema file is selected to mock against and configuration details are added to this file including the Kubernetes service name, port number, and proto service name (if applicable). Mocker generates default values for responses based on the API signature. The default values can be edited by editing the generated mock in the mocks folder.

The mock configuration is pushed to mocker by running the “Apply Mocks” command. All calls to the mocked service/s are now routed to mocker and it responds with the default values in the configuration. Mocker does not automatically update the mocks when the responses are updated in the mock configuration file but embodiments are not so limited. The “Apply Mocks” command can be run again when the mock values change.

Tester is a solution configured to simplify the process of both writing and running tests for complicated distributed apps. To use tester in the VS code extension to test a service, the “Generate Test” command is run to generate a test configuration in the form of a “yaml” file in the tests folder of the working directory. An API schema file is selected to test against and configuration details are added to this file including the test name, Kubernetes service name, port number, and proto service name (if applicable).

Tester generates default values for requests based on the API signature. The default values can be edited to add request steps by editing the generated test in the tests folder. The test configurations are started by running the “Start Test” and, in response, tester will execute the test and output on the test results in the “results” output directory.

Skyramp Used through Terminal Client

Using internet connectivity, Skyramp and its terminal client are installed on the client computer with a prespecified install command (e.g., “bash-c”$(curl-fsSL https://skyramp.dev/installer.sh)”) and instructions presented in the terminal. Installation of Skyramp is then checked using a prespecified command (e.g., “skyramp version”).

### Install Worker

Skyramp worker acts as the essential foundation for both mocker, enabling service mocking capabilities, and tester, facilitating the execution of in-cluster tests. Skyramp provides the flexibility to deploy the worker in either a Kubernetes cluster or via Docker Compose. Following are instructions for both deployment approaches.

The Kubernetes deployment of worker uses Helm but is not so limited. The developer adds the Skyramp Helm repository (“repo”) using a prespecified command (e.g., “helm repo add skyramp https://letsramp.github.io/helm/”), and this repo is configured to access Skyramp charts. To ensure the latest chart versions are available, the repositories are updated using a prespecified command (e.g., “helm repo update”).

The Skyramp Worker application is then deployed to the Kubernetes cluster using a prespecified command (e.g., “KUBECONFIG=/path/to/kubeconfig helm install-n <namespace><release-name>skyramp/worker”). Then “/path/to/kubeconfig” is replaced with the path to the Kubernetes configuration file (kubeconfig). The Kubernetes namespace where deployment of the Skyramp Worker chart is desired is used to replace “<namespace>”.

A namespace in Skyramp is a logical grouping of resources within a cluster, and a user is free to choose an existing namespace or create a new one. A name for this Helm release is then used to replace “<release-name>”. A release is a unique instance of a Helm chart installation so a meaningful name should be used for this release.

To interact with the worker, the cluster is registered with the Skyramp terminal client (e.g., “skyramp cluster register <path to kubeconfig file>”). If services are deployed using Skyramp deployer, worker is automatically installed, and no Helm install of worker or separate cluster registration is necessary.

When deploying worker via Docker Compose, add the following to an existing docker-compose.yaml or create a new one with the following services and volumes necessary for updating the Docker network:

```
services:
  skyramp:
    image: public.ecr.aws/j1n2c2p2/rampup/worker:latest
    volumes:
      - skyramp:/etc/skyramp
      - /var/run/docker.sock:/var/run/docker.sock
    ports:
      - 35142:35142
    restart: always
volumes:
  skyramp:
```

Deploy the Skyramp worker by running a prespecified command (e.g., “docker compose up-d-wait”).

### Set Up a Cloud-Native Application for Trying Out Skyramp

A description demonstrating testing and mocking microservices in a Kubernetes cluster with Skyramp follows. This example makes use of a cloud-native microservices demo app, Online Boutique, which is a web-based e-commerce app with sample functionality including product catalog, shopping cart, recommendations, and payment that uses gRPC APIs. Skyramp has also added support for REST and Thrift APIs in its fork of the repo.

This example demonstration tests whether the checkout subsystem of Online Boutique is functioning correctly. Typically, the API endpoints of the services needing to be tested can only be accessed from within the Kubernetes cluster, so a developer either has to set up a very permissive gateway or proxy, or manually package tests into a container that can run in the cluster. However, Skyramp tester is configured to skip the manual work, save time, and focus on the test payload.

To begin the example, developer clones the sample project (e.g., “git clone https://github.com/letsramp/sample-microservices.git”). From the ‘sample-microservices’ project directory, developer changes to the ‘skyramp/grpc-demo’ directory (e.g., “cd skyramp/grpc-demo”). A local Kubernetes cluster is created for testing the microservices (e.g., “skyramp cluster create-local”), and the microservices are deployed to the cluster (e.g., “skyramp deployer up checkout-system”). The status of the services is then checked (e.g., “skyramp deployer status”).

Two tests available are available which were originally generated using Skyramp (e.g., “Is tests”). A test is run for the checkout service in order to test whether the checkout subsystem of the app is functioning correctly (e.g., “skyramp tester start checkout-test-n test-grpc-demo”). It is assumed for purposes of this example the test failed because the payment service is missing. Skyramp makes it easy to mock internal or external dependencies, like the payment service, and avoid the complexity of deploying the missing dependency.

A pre-built mock is available (e.g., “cat mocks/payment-service-k8s.yaml”), but mocks can also be automatically generated using Skyramp as described in detail herein. The developer sends the mock description to the worker so that it can stand in for the payment service (e.g., “skyramp mocker apply-n test-grpc-demo”), and the test run is repeated with the mock in place (e.g., “skyramp tester start checkout-test-n test-grpc-demo”). The test now passes. This example demonstrates that with Skyramp, missing dependencies will no longer derail the testing process. A load test can also be run (e.g., “skyramp tester start test-load-n test-grpc-demo”). The test cluster can now be removed (e.g., “skyramp cluster remove—local”).

Detailed descriptions now follow for embodiments of each component of the Skyramp system or platform. Skyramp, however, is not limited to the embodiments described but is to be accorded the widest scope consistent with the description including various modifications that may be apparent to those skilled in the art.

### Deployer

Skyramp Deployer is configured to render and deploy Helm charts through simple target descriptions, thereby enabling deployment of selected subsets of services within the inner development loop, including enabling the optional Hot Code Reload feature. Deployer is configured to streamline Kubernetes resource deployment for developers by providing a toolset configured to enable developers to deploy specific subsets of services seamlessly within the inner development loop. Deployer enables swift deployment of Helm Charts in Kubernetes environments, precise control over Kubernetes resource deployment, and flexible management of Helm sub-charts during deployment. Deployer thus optimizes the inner development loop, resulting in quicker and more efficient deployment of Kubernetes resources.

Deployer provides a toolset for use in deploying Kubernetes resources. Using Skyramp, a developer creates a deployment target description (optionally, enables debugging with hot code reload), brings up a target, and manages the deployment. Each of these methods is described in detail herein.

Creation of a deployment description includes creating a folder called “targets” at the root of the target microservice repository. This folder is used to store the target description files. Inside the “targets” folder, the developer creates a target description file (e.g. “helm-demo.yaml”) to describe the target they want to deploy. The target description file is then customized to match the deployment needs. An example deployment target description follows.

```
namespace: helm-namespace
containers:
  - type: helm
    releaseName: my-release
    path: charts/test1
    valuesPath: files/values.yaml
    values:
      server:
        enabled: true
        service:
          port: 10000
      service:
        port: 5000
        type: ClusterIP
    includes:
      - Deployment/my-release-test1
      - Job/* # include all jobs
      - server/* # include subchart server with all subresources
```

The values of the deployment target description can be modified according to requirements of a specific deployment. The target description file includes the “namespace” field, which defines the target Kubernetes namespace. The target description file further includes a “containers” section, where the deployment settings are configured, including the release name (“releaseName”), the path to the Helm charts (“path”), an optional values file path (“valuesPath”), and additional values to override (“values”).

Also included in the target description file is an “includes” field (alternatively, “excludes”), which specifies the resources to include in the deployment. Specific resources can be specified or the * wildcard can be used to include matching resources.

Deployer optionally supports a powerful debugging feature referred to herein as Hot Code Reload. This feature allows developers to debug their services in real-time while a test is running without the need for re-deployments by attaching their debugger, step through code, and making changes while their service is running.

To enable Hot Code Reload, a “debug” section is included in the target description file under “containers”. An example debugging code section is as follows.

```
debug:
  - containerName: Deployment/my-service
    runtimeType: go
    command: myservice
    debugPort: 33333
    mountPaths:
      - /workspaces/myproject/src/myservice
```

This debug section is configured to enable Hot Code Reload for debugging purposes. The parameters that can be configured in the debug section include “containerName” which includes the name of the container to use in debug mode. The parameters “runtimeType”, which is the runtime type of the service (“e.g., “go”, “node”, or “python”), and “command”, which is the application entry point that will run in a loop relative to the first path specified in “mountPaths”, are also configurable in the debug section. Additionally, parameters which can be configured in the debug section include “debugPort” defining the local port of the running service to debug, and “mountPaths” defining path(s) mounted to the remote container.

With Hot Code Reload, any code changes made will immediately take effect, thereby streamlining the debugging process. An example involving the Hot Code Reload feature is described herein.

Following creation of a deployment target description, the target is brought up by running the “up” command to deploy the target, replacing “helm-demo” with the target name (e.g., “skyramp deployer up helm-demo”). Deployer is configured to read the target description file and launch the deployment process. Deployer also handles deployment of Helm charts using the configurations from the target description. Deployer creates or updates the necessary Kubernetes resources, removing the need for manual management. The mocker should be used to deploy mocks for excluded service dependencies.

Following running of “deployer up” on a target, deployer is configured to enable viewing of the status of the deployment by running the “status” command (e.g., skyramp deployer status”) which outputs the status of the deployment in a digestible table format.

After testing or when finished with the deployment, the target is brought down using the “down” command (e.g., “skyramp deployer down helm-demo). Deployer is configured to clean up all resources deployed using the “skyramp deployer up” command.

### Target Description

The target description file used with deployer is a component of the deployer and includes the configuration parameters used to deploy the system-under-test efficiently. This file is placed under the “targets” folder at the root of the microservice repository. The target description file, which can be named with a “yaml” extension (e.g., “my-deployment.yaml”), is used to define and control how services are deployed and configured within the Kubernetes cluster.

A target description file of an embodiment includes a “namespace” parameter representing the Kubernetes namespace for the cluster. Additionally, it includes a “containers” section that defines the specific deployment settings. All the parameters described herein are specified under the “containers” section. An example target description file including the “namespace” parameter and the “containers” section is as follows.

```
namespace: helm-namespace
containers:
  - type: helm
    releaseName: my-release
    path: charts/test1
```

To define Helm values, a developer provides a path to the “values.yaml” file for their Helm chart using “valuesPath”. Additional values to override or extend the configuration from the “values.yaml” file can be added to the “values” section. Both “valuesPath” and “values” are placed under “containers”. A code example defining Helm values is as follows.

```
valuesPath: files/values.yaml
values:
  server:
    enabled: true
    service:
      port: 10000
  service:
    port: 5000
    type: ClusterIP
```

Skyramp provides the option to explicitly include or exclude specific services in a deployment by specifying them in the “includes” or “excludes” section under “containers”. A code example for including or excluding services is as follows.

```
includes:
  - Deployment/my-service
  - Service/my-service
  - Job/* # include all jobs
  - server/* # include subchart server with all subresources
  - /* # include all resources in root chart
excludes:
  - Deployment/excluded-service
```

### Mocker

Mocker is an in-cluster solution for creating mock API services by generating a mock, configuring the mock (optional), and applying the configuration to the worker container, thereby replacing service dependencies with lightweight, static and dynamic mocks. Mocker can be used via the VSCode Extension, the Skyramp CLI, or the various supported language libraries.

Mocker is configured to provide fine-grained control over dependencies to be mocked. Mocker is configured to include the ability to mock gRPC, REST, JSON-RPC WebSocket, and JSON-RPC HTTP endpoints but is not so limited. Mock is also configured to perform automatic creation of mock configurations from API files, and to dynamically route calls from live to mocked services. Mocker comprises powerful gRPC mocking including the ability to proxy gRPC calls, and support for client streaming, server streaming, and bidirectional streaming. Mocker also includes support for mock values generated via generative artificial intelligence and is configured to include the ability to configure response latencies to test and debug real-world scenarios. Mocker is further configured to include support for returning error codes to test error cases.

The mock includes a mock description configured to enable developers to create lightweight static and dynamic mocks to simulate service dependencies. The mocker comprises a container that is deployed inside the Kubernetes cluster or in Docker and contains core logic for implementing mocks and handling networking for the mocks.

Mocker further comprises a mock configuration file, response configuration file, and endpoint configuration files. The mock configuration file, residing in the “mocks” folder, defines the overall behavior of the mock and as such enables configuring of proxying, delays, errors, and more, facilitating comprehensive testing of an application. The mock configuration file is configured to capture the signatures for the endpoints to be mocked and corresponding static mock responses. It is automatically generated from one of an OpenAPI API spec (either by file path or URL reference), a protocol buffer API spec, or a JSON-RPC response file. Mock values can be easily edited as needed.

The response configuration files, located in the “responses” folder, define response behavior for specific endpoint methods or methods, thereby enabling developers to configure payloads and dynamic responses. The endpoint configuration files, found in the “endpoints” folder, specify details related to the service networking aspects, supporting gRPC, REST, JSON-RPC WebSocket, and JSON-RPC HTTP endpoints.

Following is an example of how to dynamically generate a mock description by providing service-level information. Alternatively, a mock definition can be created from scratchby creating “yaml” files in the “mocks”, “responses”, and “endpoints” directories of the project (e.g., my-mock.yaml, my-response.yaml, and my-endpoint.yaml) and configure the necessary information by following the guidelines below.

### Generate A Mock

To generate a mock configuration, use the “generate” command provided by mocker. This command creates three files, including an endpoint, a response, and a mock configuration. Mocks can be generated for different types of services such as gRPC, OpenAPI, JSON-RPC HTTP, JSON-RPC WebSocket, and JSON-RPC REST using a prespecified set of commands corresponding to each service. An example mock follows for a gRPC service.

```
skyramp mocker generate \
  --protocol protobuf \
  --api-schema <path to .proto file> \
  --alias <name of Kubernetes service or Docker alias to mock> \
  --port <port number for the service> \
  --proto-service <service name>
```

An embodiment runs the “generate” command in the source code repository so mocks are versioned and shareable.

In response to running the “skyramp mocker generate” command, a mock configuration file is created in the “mocks” folder for the specified service or alias. Additionally, a response configuration file is created in the “responses” folder for each method defined in the service. If the endpoint definition does not already exist then an endpoint configuration file is created in the “endpoints” folder.

### Configure the Mock

The mock description automatically generated using the “mocker generate” command is preconfigured with default values for responses based on the API signature. However, default values or configuration details can be added or changed to customize mocks by editing the generated mock in the mocks folder. Examples follow of mock, response, and endpoint configurations.

The mock configuration serves as the central component of the mock definition and defines the overall mock behavior. To configure the overall mock behavior, edit the mock configuration file in the “mocks” folder. An example follows of a mock configuration for a gRPC service.

```
version: v1
mock:
  description: routeguide
  responses:
    - responseName: ListFeatures
    - responseName: RecordRoute
    - responseName: RouteChat
      lossPercentage: 50
      delayConfig:
        minDelay: 1000
        maxDelay: 2000
  proxies:
    - endpointName: routeguide-svc-RouteGuide
      methodName: GetFeature
```

In this example, the top-level mock behavior is configured, including setting a description and specifying the responses to mock as defined in the response configuration. The “description” provides a description of the mock configuration, “responses” allows a developer to specify responses for various gRPC methods, and “proxies” enables gRPC proxying for specific endpoints and methods. This example also includes advanced mock capabilities, including gRPC proxying (routing mock data to specific endpoints and methods), and delays and errors (simulating network conditions by introducing delays and error percentages).

Skyramp provides the capability to act as a proxy for gRPC services, selectively mocking certain methods while forwarding the rest to the live service. To enable this feature, the endpoint and methods to be proxied can be specified in the “proxies” section of the mock configuration.

An example mock configuration is as follows:

```
version: v1
mock:
  description: routeguide
  responses:
    - responseName: ListFeatures
    - responseName: RecordRoute
    - responseName: RouteChat
  proxies:
    - endpointName: routeguide-svc-RouteGuide
      methodName: GetFeature
```

In this gRPC configuration example, requests to the “GetFeature” method are directed to the live service, while all other requests to the “routeguide” service are mocked. If a gRPC method is defined in the ‘.proto’ file but not listed in the mock description, Skyramp is configured to implicitly forward the corresponding request(s) to the live service. This flexibility allows developers to control the behavior of specific gRPC methods in their mock configurations.

In a mock configuration, developers can introduce delays and error configurations using corresponding properties. The “lossPercentage” property specifies the percentage of requests that will result in an error response, and the “delayConfig” property defines the delay configuration for the mock response, including the minimum (minDelay) and maximum (maxDelay) delay in milliseconds. When “minDelay” and “maxDelay” share the same value, the delay is static. However, if these values differ, Skyramp is configured to apply a random delay within a specified range, with a maximum delay of 10,000 milliseconds (10 seconds) but embodiments are not so limited.

Another mock configuration example is as follows:

```
version: v1
mock:
  description: routeguide
  responses:
    - responseName: GetFeature
    - responseName: ListFeatures
    - responseName: RecordRoute
    - responseName: RouteChat
      lossPercentage: 50
      delayConfig:
        minDelay: 1000 # in ms
        maxDelay: 2000 # in ms
```

In this example, the “RouteChat” mock response will experience a random delay between 1,000 and 2,000 milliseconds before being returned. Additionally, around 50% of requests will result in an error response.

A user has the flexibility to specify delays and errors for a specific method or for the entire endpoint. This example demonstrates how to configure delays and errors for a specific response. To apply the same delay and error settings to all responses, the “lossPercentage” and “delayConfig” are defined in the mock section such that, in this example, all responses will encounter a delay between 1,000 and 2,000 milliseconds, and approximately 50% of requests will result in an error response.

### Response Configuration

The response configuration file defines the response behavior for a specific method of the service. To configure responses, the response configuration files are edited in the “responses” folder. Following is an example of a response configuration showing support for mocking various gRPC methods, including Unary RPC, Server Streaming RPC, Client Streaming RPC, and Bidirectional Streaming RPC. This example also demonstrates the use of dynamic responses for more complex testing scenarios.

```
version: v1
responses:
  # Unary RPC
  - name: GetFeature
    blob: |-
      {
        “name”: “fake”,
        “location”: {
          “latitude”: 400,
          “longitude”: 600
        }
      }
    endpointName: routeguide-svc-RouteGuide
    methodName: GetFeature
  # Server Streaming RPC
  - name: ListFeatures
    javascript: |
      function handler(req) {
        const values = [ ];
        for (let i = 0; i < 5; i) {
          values[i] = {
            name: “random” + i,
            location: {
              longitude: i * 100,
              latitude: i * 100
            }
          };
        }
        return {
          values: values
        };
      }
    endpointName: routeguide-svc-RouteGuide
    methodName: ListFeatures
  # Client Streaming RPC
  - name: RecordRoute
    javascript: |
      function handler(req) {
        var 1 = req.values.length;
        return {
          value: {
            pointCount: 1,
            featureCount: 1,
            distance: 1 * 100,
            elapsedTime: 0
          }
        };
      }
    endpointName: routeguide-svc-RouteGuide
    methodName: RecordRoute
  # Bidirectional Streaming RPC
  - name: RouteChat
    javascript: |-
      const msgs = [ ];
      function handler(req) {
        msgs.push(req.value);
        return {
          values: msgs
        };
      }
    endpointName: routeguide-svc-RouteGuide
    methodName: RouteChat
```

In this example, response behavior is defined for a specific method of the service, specifying the endpoint and method name as defined in the endpoint configuration. The response payload can be customized using a static JSON blob.

### Dynamic Responses

Dynamic responses offer flexibility in customizing response generation logic and simulating complex response configurations. Different attributes can be used to specify dynamic response behavior, such as “javascript”, “javascriptPath”, “python”, or “pythonPath”. Each attribute enables defining custom response handling logic and return a JSON representation of the response value.

To create JavaScript-based dynamic responses, the “javascript” attribute is used for a response in the response configuration. A function is defined called “handler” that takes any necessary parameters. The custom JavaScript logic is implemented within the “handler” function and a JSON object is returned representing the response value. An example follows of this response configuration.

```
version: v1
responses:
  - name: RecordRoute
    javascript: |
      function handler(req) {
        var1 = req.values.length;
        return {
          value: {
            pointCount: 1,
            featureCount: 1,
            distance: 1 * 100,
            elapsedTime: 0
          }
        },
      }
    endpointName: routeguide-svc-RouteGuide
    methodName: RecordRoute
```

Alternatively, the “javascriptPath” attribute can be used to specify the path to an external JavaScript script file containing custom response handling logic. The external JavaScript script file “recordRoute.js” defines a “handler” function to process incoming requests and generate appropriate responses. An example follows of a response configuration using the “javascriptPath” attribute.

```
version: v1
responses:
  - name: RecordRoute
    javascriptPath: scripts/recordRoute.js
    endpointName: routeguide-svc-RouteGuide
    methodName: RecordRoute
```

### Endpoint Configuration

The endpoint configuration file defines networking-level service details for an endpoint. Endpoint configuration files can be found in the “endpoints” folder. The generated endpoint configuration comprises networking-level service details, including its name, port, alias, and protocol. Additionally, it includes metadata related to various endpoints that a service can have, including the methods it supports and the associated proto file. Typically, no additional user configuration is required for endpoints.

An example follows of an endpoint configuration for a gRPC service.

```
version: v1
services:
  - name: routeguide
    port: 50051
    alias: routeguide
    protocol: grpc
endpoints:
  - name: routeguide-svc-RouteGuide
    methods:
      - name: GetFeature
      - name: ListFeatures
      - name: RecordRoute
      - name: RouteChat
    defined:
      path: ./pb/route_guide.proto
      name: RouteGuide
    serviceName: routeguide
```

Configuration of the endpoint file includes a number of key attributes. A “services” section lists the services available in the project. In this example, there is one service named “routeguide”. The “endpoints” section defines individual endpoints, specifying the available methods, the service definition path, and the service name. In the example above, an endpoint named “routeguide-svc-RouteGuide” is used for the RouteGuide service.

Within each endpoint, available “methods” are listed. This example includes methods like “GetFeature”, “ListFeatures”, “RecordRoute”, and “RouteChat”. The methods assist with specifying the details of each method and how it should behave. A “defined” attribute specifies the service definition file path and the service name. The service definition file (“route_guide.proto”) outlines the structure of the service and its methods.

By configuring endpoints, the available services and methods within a project are defined, facilitating mocking services in their distributed application. Further, it is recommended to dynamically generate a mock by providing service-level information.

### Apply the Mock to the Work Container

The mock configuration is pushed to mocker in cluster by running the “apply” command which applies the mock configurations included in the “mocks” folder to the worker. All calls to any mocked service are now routed to mocker, which responds with the default values specified in the mock description. Mocker does not automatically update the mocks when the responses are updated in the mock configuration file but embodiments are not so limited. The “Apply Mocks” command can be rerun when the mock values change. When mocking a gRPC service the container is redeployed if the proto definition of the mock changes.

### Tester

Tester is a configured to simplify the process of both writing and running tests for complicated distributed apps. Tester is available for use via the VSCode Extension, the Skyramp CLI, or the various supported language libraries. Tester features include the simplicity of specifying API requests in a test, which can be static or dynamically generated via a script, overriding mock configurations (such as the responses configured for a mock), and validation for responses received from the system under test. Tester features further include the ability to chain request and response values throughout the life of a test, load testing, report generation based on the results of a test, and metrics collection from the system under test (CPU and memory). In conjunction with Skyramp deployer and mocker, tester is configured to run powerful integration and load tests on a subset of an application under development, thereby increasing confidence and saving developers from flaky end-to-end tests.

Skyramp worker comprises tester which includes the core logic for running tests. Tester can be deployed in a variety of ways, such as a container in a Kubernetes cluster. Tester includes a test description that captures the instructions for running the test (what is called, where the call is made to, how the response should look, etc.). Further, Tester includes Javascript support for specifying pre-execution steps, post-execution steps, or for creating inputs for load tests.

Once the Skyramp worker is running, the VSCode extension, the Skyramp CLI, or a language library can be used to generate and manage distributed functional integration and performance tests. When ready to test a microservice, one of the methods described herein is used to send tests to the worker which controls the start of the tests. Once tests are completed the corresponding test results are presented.

Tester is configured to simplify the process of both writing and running tests for complicated distributed apps by enabling users to write and run functional and load tests using a simple declarative description. The Terminal Client is installed before using Tester, and the Skyramp worker is installed in the environment (e.g., in-cluster) where the tests will be run. The following steps of an embodiment to use Tester in the VS code extension include generating a test, editing the test, and starting the test.

### Generate the Test

Skyramp is configured to provide a simple way to generate some default tests that work out of the box and can be a starting point for more complicated testing logic in different applications. Generally, when ready to test a service, the “Generate Test” command is run to generate a test configuration in the form of a “yaml” file in the tests folder of the working directory. A prompt is provided to select an API schema file to test against and input some necessary configuration details including the test name, Kubernetes service name, port number, and proto service name (if applicable). More specifically, the “skyramp tester generate” command is used to generate tests for gRPC and OpenAPI services.

The “Generate Test” command creates a test configuration file in the “tests” folder for the specified service or alias, creates a scenario configuration file in the “scenarios” folder for each method defined in the microservice to be tested, and if the endpoint definition does not already exist, creates an endpoint configuration file in the “endpoints” folder. The generated test configuration “yaml” files can be edited as described herein.

### Configure the Test

The test description generated using the “tester generate” command is configured to run using default values for requests based on the API signature. Embodiments are configured to enable developers to edit the default values and add request steps by editing the generated test in the tests folder, thereby adding or changing configuration details to customize your tests. Examples follow of test, scenario, and endpoint configurations.

To configure the overall test behavior, a developer edits the test configuration file in the “tests” folder. An example of a test configuration for a gRPC service follows.

```
version: v1
test:
  name: routeguide
  testPattern:
    - requestName: SRouteguideERouteGuideMGetFeature
      startAt: 1
    - requestName: SRouteguideERouteGuideMListFeatures
      startAt: 1
    - requestName: SRouteguideERouteGuideMRecordRoute
      startAt: 1
    - requestName: SRouteguideERouteGuideMRouteChat
      startAt: 1
```

In this example, top-level test behavior is configured, including setting a name for the test and specifying the test pattern by referencing requests and scenarios as defined in the scenario configuration. Advanced capabilities like configuring load testing are available in the Test Description page as described in detail herein.

Scenarios are likewise configurable by editing the scenario configuration file in the “scenarios” folder. An example of a scenario configuration for a gRPC service is as follows.

```
version: v1
requests:
  - name: SRouteguideERouteGuideMGetFeature
    blob: |-
      {
        “latitude”: 0,
        “longitude”: 0
      }
    endpointName: s-routeguide-e-RouteGuide
    methodName: GetFeature
  - name: SRouteguideERouteGuideMListFeatures
    blob: |-
      {
        “hi”: {
          “latitude”: 0,
          “longitude”: 0
        },
        “lo”: {
          “latitude”: 0,
          “longitude”: 0
        }
      }
    endpointName: s-routeguide-e-RouteGuide
    methodName: ListFeatures
```

In this example, request behavior is defined for a specific method of the service and the endpoint and method name are specified as defined in the endpoint configuration. The request payload is customized using a static JSON blob. More complex requests can be created through the addition of advanced capabilities such as defining dynamic requests and adding overrides and parameters.

The scenario file generated using “tester generate” by default lists or includes the aforementioned requests. Advanced capabilities like assertions and chaining can be added through creation of additional scenario files in the scenarios folder. These files can reference the generated requests and provide more complex test scenarios.

Endpoint configuration files are located in the “endpoints” folder. An example of an endpoint configuration for a gRPC service follows.

```
version: v1
services:
  - name: routeguide
    port: 50051
    alias: routeguide
    protocol: grpc
endpoints:
  - name: routeguide-svc-RouteGuide
    methods:
      - name: GetFeature
      - name: ListFeatures
      - name: RecordRoute
      - name: RouteChat
    defined:
      path: ./pb/route_guide.proto
      name: RouteGuide
    serviceName: routeguide
```

The generated endpoint configuration comprises networking-level service details, including name, port, alias, and protocol. Additionally, it includes metadata related to various endpoints that a service can have, including the methods it supports and the associated proto file. Generally, no additional user configuration is required for endpoints.

### Run the Test

Once the test description is in place then the test is ready to be run. To run the test, the specific test file to be used is referenced. To do this, refer to the “tests” directory. The name of the test will be the name of the respective file including the test, without the file extension. For example, if the file is located at “tests/checkout-test.yaml”, the test file name will be “checkout-test”.

After running the “Start Test” command to start the test, tester is configured to execute the test and output the test results in the “results” output directory. Output on the progress/status of the test is provided until completion of the test. If the command is interrupted (such as by sending a “SIGINT”), the test will continue to run in the background in the worker. For an ongoing test, status can be checked by running “skyramp tester status <test file name>” and providing either the “address” or “namespace”, as described herein.

In order to stop an ongoing test, the command “skyramp tester stop <test file name>” is run with either the “address” or “namespace” arguments.

### Test Description

The Skyramp test description simplifies the process of writing and running tests for complex distributed applications. The test description comprises a test configuration file, scenario configuration files, and endpoint configuration files but is not so limited. The test configuration file, residing in the “tests” folder, defines the overall behavior of the test and enables the user to configure test patterns and load testing.

The scenario configuration files are located in the “scenarios” folder. These files define request behavior for specific methods or chains of requests and asserts in scenarios. The scenario configuration files also allow developers to configure payloads, dynamic requests, and set overrides and parameters.

Endpoint configuration files are located in the “endpoints” folder. These files specify details related to the service's networking aspects, supporting gRPC, REST, JSON-RPC WebSocket, and JSON-RPC HTTP endpoints.

Skyramp is configured to dynamically generate a test description using service-level information. Alternatively, if it is preferred to create a test definition from scratch, developers can create “yaml” files in the tests, scenarios, and endpoints directories of their project (e.g., my-test.yaml, my-scenario.yaml, and my-endpoint.yaml) and configure the necessary information as described in detail herein.

### Test Configuration

The test configuration is the central component of the test definition and defines the overall test behavior. An example test configuration follows.

```
version: v1
test:
  name: routeguide
  testPattern:
    - startAt: 1
      scenarioName: scenario1
      atOnce: 2
      targetRPS: 3000
      duration: 10
      rampUp:
        duration: 3
        interval: 1
  override:
    mock:
      - endpointName: helloworld
        methodName: SayHello
        blob: |
          {
            “message”: “myTest”
          }
```

In this example, “name” specifies the name of the test, “testPattern” enables the definition of various test scenarios, and “override” is configured to enable overriding of mock behavior. This example showcases advanced test capabilities including overrides and load testing. Overrides customize endpoint behaviors by specifying mocks. Load testing simulates heavy user traffic with features like target RPS and ramp-up controls.

### Overrides

The “override” attribute in the test configuration is configured to enable customization of specific endpoints within tests, providing flexibility in testing scenarios. By setting the “override” attribute, a mock can be specified to modify an “endpoint” defined elsewhere in the project folder. This customization is configured to enable simulation of various scenarios for effective testing of application robustness. An example test configuration follows using the “override” attribute.

```
version: v1
test:
  name: routeguide
  testPattern:
    - startAt: 1
      scenarioName: scenario1
  override:
    mock:
      - endpointName: routeguide-svc-RouteGuide
        methodName: GetFeature
        blob: |-
          {
            “name”: “fake”,
            “location”: {
              “latitude”: 400,
              “longitude”: 600
            }
          }
```

The “override” attribute is configured to customize endpoints. The “mock” section in this example specifies the details of the override using “endpointName”, “methodName”, and “blob” fields. The “endpointName” field identifies the endpoint to override, in this case, “routeguide-svc-RouteGuide”. The “methodName” field specifies the specific method of the endpoint to modify, here, “GetFeature”. The “blob” field includes the customized data or response to replace the original response from the endpoint. Leveraging the override attribute enables seamless adaptation of endpoint behaviors within tests, allowing for creation of various testing scenarios and evaluation of application performance under different conditions.

### Load Testing

Load testing is configured to enable simulation of heavy user traffic on a microservice under test by transforming functional tests into load tests. This is achieved by incorporating specific load profile keywords into tests. An example test configuration follows including load testing parameters.

```
version: v1
test:
  name: routeguide
  testPattern:
    - startAt: 1
      scenarioName: scenario1
      atOnce: 2
      targetRPS: 3000
      duration: 10
      rampUp:
        duration: 3
        interval: 1
```

The “atOnce” attribute in the “testPattern” of this example signifies the concurrency of the “scenario1”. For example, with “atOnce” set to 2, everything defined in “scenario1” runs with a concurrency of two (2), happening in parallel.

Embodiments include parameters configured to control the load. The “targetRPS” parameter specifies the target Requests Per Second (RPS) the application should handle. The “duration” parameter indicates the total duration of the load test in seconds. The “rampUp” parameter enables a gradual increase in the load on an endpoint. The “duration” parameter specifies how long it takes for the traffic ramp-up to occur, and the “interval” parameter signifies the rate at which traffic increases.

In the example above, the load increases over three (3) seconds, with increments every second until it reaches the target RPS of 3000. Modification of these values enables the modelling of traffic behavior for an application to test how the application responds to varying levels of load. If “targetRPS” is not specified, tester will attempt to send as many requests as possible within the system's context.

### Scenario Configuration

The scenario configuration file of embodiments defines request behaviors for specific methods and creates scenarios as chains of defined requests and asserts. An example scenario configuration file follows.

```
version: v1
scenarios:
  - name: scenario1
    steps:
      - requestName: SRouteguideERouteGuideMGetFeature
      - asserts: requests.SRouteguideERouteGuideMGetFeature.res.name == “fake”
requests:
  - name: SRouteguideERouteGuideMGetFeature
    javascript: |-
      function handler(req) {
        // Your JavaScript logic here
        return {
          value: {
            latitude: x,
            longitude: y
          }
        };
      }
  - name: SRouteguideERouteGuideMListFeatures
    blob: |-
      {
        “hi”: {
          “latitude”: 0,
          “longitude”: 0
        },
        “lo”: {
          “
latitude”: 0,
          “longitude”: 0
        }
      }
    endpointName: s-routeguide-e-RouteGuide
    methodName: ListFeatures
```

In this example, the “scenarios” parameter enables different test scenarios to be defined, and this example includes a scenario named “scenario1”. The “requests” parameter includes configurations for individual requests (to be referenced in scenarios by name).

Advanced capabilities of the scenario configuration of embodiments includes scenarios and asserts for creating end-user use cases and validating responses, dynamic requests configured to customize request handling logic, and chaining and overrides configured to chain values between sequential requests and override them as needed.

### Scenarios and Asserts

Scenarios are representations of end-user use cases that require testing, allowing developers to define a sequence of actions to be performed, typically involving requests to specific endpoints. Each named scenario includes a “steps” attribute, listing these actions, which can be executed sequentially or concurrently, simulating various usage patterns, including load tests. In “scenarios”, the associated steps are executed sequentially. To execute items in parallel, refer to the “testPattern” defined in the test configuration. An example scenario configuration follows.

```
version: v1
scenarios:
  - name: scenario1
    steps:
      - requestName: SRouteguideERouteGuideMGetFeature
      - asserts: requests.SRouteguideERouteGuideMGetFeature.res.name == “fake”
requests:
  - name: SRouteguideERouteGuideMGetFeature
    endpointName: s-routeguide-e-RouteGuide
    methodName: GetFeature
    javascript: |-
      function handler(req) {
        // Your JavaScript logic here
        return {
          value: {
            latitude: x,
            longitude: y
          }
        };
      }
```

In this example, “scenario1” is defined to include two steps executed sequentially. The first step utilizes the “requestName” attribute, referencing a “request” object previously defined in the configuration. The second step is an “assert” statement, used to verify that the response from the request matches the expected value.

To use an assert, the “asserts” parameter is defined within the step, with a value in the format “requests.<name of request>.res.message==“<expected value>”” for example, where “<name of request>” refers to the name of the previously defined “request”, and “<expected value>” is a string representing the expected return value from the request. Values returned by services are interpreted as JavaScript for evaluating “assert” statements. The type may not always be a “string” but could be a “Boolean” or a “number”, among other types. When working with a “Boolean”, the “<expected value>” should be “true” or “false” and not “true” or “false” in the “assert” statement.

### Dynamic Requests

Dynamic requests provide the flexibility to customize request handling logic in scenario configurations. Different attributes can be used to specify dynamic request behavior, such as “python”, “pythonPath”, “javascript”, or “javascriptPath”. Each attribute enables the defining of custom request handling logic and returns a JSON representation of the response value.

The creation of JavaScript-based dynamic requests of an embodiment includes use of the “javascript” attribute within the “requestValue” section of a request definition. A function is defined called handler that takes the req parameter. Developers can implement their custom JavaScript logic within the “handler” function and return a JSON object representing the response value. An example scenario configuration follows.

```
version: v1
requests:
  - name: SRouteguideERouteGuideMGetFeature
    javascript: |-
      function handler(req) {
        // Your JavaScript logic here
        return {
          value: {
            latitude: x,
            longitude: y
          }
        };
      }
    endpointName: s-routeguide-e-RouteGuide
    methodName: GetFeature
```

Alternatively, creation of JavaScript-based dynamic requests of an embodiment includes use of the javascriptPath attribute to specify the path to an external JavaScript script file that includes the custom request handling logic. An example scenario configuration follows.

```
version: v1
requests:
  - name: SRouteguideERouteGuideMGetFeature
    javascriptPath: scripts/getFeature.js
    endpointName: s-routeguide-e-RouteGuide
    methodName: GetFeature
```

The external JavaScript script file “getFeature.js” defines a “handler” function to process incoming requests and generate appropriate responses.

### Installing NPM-Based Packages

If JavaScript-based dynamic requests use NPM-based packages, Skyramp is configured to enable specification of the packages in the “npmPackages” section of a test definition. The testing framework automatically installs these packages before running the test. An example test configuration follows.

```
version: v1
test:
  name: routeguide
  testPattern:
    - requestName: SRouteguideERouteGuideMGetFeature
      startAt: 1
    - requestName: SRouteguideERouteGuideMListFeatures
      startAt: 1
    - requestName: SRouteguideERouteGuideMRecordRoute
      startAt: 1
    - requestName: SRouteguideERouteGuideMRouteChat
      startAt: 1
  npmPackages:
    - mathjs
    - chart
```

### Python Dynamic Requests

The creation of Python dynamic requests of an embodiment includes use of the “python” attribute within the “request Value” section of a request definition. This attribute enables developers to define a function referred to herein as “handler” that takes the “req” parameter, representing the incoming request. Within the “handler” function, the custom Python logic is implemented. Finally, return a JSON representation of the response value using “Skyramp Value”. An example scenario configuration follows.

```
version: v1
requests:
  - name: SRouteguideERouteGuideMGetFeature
    python: |-
      def handler(req):
        // Your Python logic here
        return Skyramp Value(
          value={
            “latitude”: x,
            “longitude”: y
          }
        )
    endpointName: s-routeguide-e-RouteGuide
    methodName: GetFeature
```

Alternatively, the creation of Python dynamic requests of an embodiment includes use of the pythonPath attribute to specify the path to an external Python script file containing custom request handling logic. An example scenario configuration follows.

```
version: v1
requests:
  - name: SRouteguideERouteGuideMGetFeature
    pythonPath: scripts/get_feature.py
    endpointName: s-routeguide-e-RouteGuide
    methodName: GetFeature
```

The external Python script file “get_feature.py” defines a “handler” function to process the request and generate the response.

### Chaining and Overrides

Tester is configured to chain values between sequential requests and override them. Using this feature, dynamic test scenarios can be created for which the output of one request influences the behavior of subsequent requests, making the testing more versatile and powerful. An example test configuration follows.

```
version: v1
test:
  name: routeguide
  testPattern:
    - startAt: 1
      scenarioName: scenario1
  override:
    mock:
      - endpointName: routeguide-svc-RouteGuide
        methodName: RouteChat
        javascript: |-
          function handler(req) {
            return {
              value: {
                message: req.value.message + “temp”,
                location: {
                  latitude: req.value.latitude,
                  longitude: req.value.longitude
                }
              }
            }
          }
```

An example scenario configuration follows.

```
version: v1
scenarios:
  - name: scenario1
    steps:
      - requestName: SRouteguideERouteGuideMRouteChat
      - asserts: requests.SRouteguideERouteGuideMRouteChat.res.message ==
“message1temp”
      - requestName: SRouteguideERouteGuideMRouteChat
        override:
          message: requests.SRouteguideERouteGuideMRouteChat.res.message
      - asserts: requests.SRouteguideERouteGuideMRouteChat.res.message ==
“message1temp1temp”
      - requestName: SRouteguideERouteGuideMRouteChat
        override:
          message: requests.SRouteguideERouteGuideMRouteChat.res.message
      - asserts: requests.SRouteguideERouteGuideMRouteChat.res.message ==
“message1temp1temp1temp”
requests:
  - name: SRouteguideERouteGuideMRouteChat
    endpointName: s-routeguide-e-RouteGuide
    methodName: RouteChat
    vars:
      message: “message”
    javascript: |
      i = 0
      function handler( ) {
        i++
        return {
          value: {
            message: vars.message + i,
            location: {
              latitude: req.value.latitude,
              longitude: req.value.longitude
            }
          }
        }
      }
```

In this example, the “override” attribute in the “test” section allows for customization of the behavior of an “endpoint” defined elsewhere in the project folder by specifying a “mock”.

Within the “scenarios” section, multiple steps are defined. Each step calls the “SRouteguideERouteGuideMRouteChat” request and includes an “assert”. What sets them apart is that in subsequent “requestName” calls, the “message” variable is overridden. The “message” variable takes on the value of the response returned by the request. This chaining is done multiple times to create a sequence of messages.

The “requests” attribute shows how the “vars” keyword is used to define a new variable called “message” in the “SRouteguideERouteGuideMRouteChat” request. This variable is utilized in the JavaScript snippet using “vars.message”. By overriding this variable in “scenario1”, the message content can be modified in the subsequent requests.

### Request Parameters and Headers

When making REST calls, requests often require headers, such as Basic Authentication information, and variables in the path. This is achieved using the request object. An example scenario configuration is as follows.

```
version: v1
requests:
  - name: addCartRequest
    endpointName: cart-service
    methodName: cart-service-post
    blob: |
      {
          “product_id”: “OLJCESPC7Z”,
          “quantity”: 1
      }
    headers:
      Authorization: “Basic YWxhZGRpbjpvcGVuc2VzYW1l”
    params:
      - name: user_id
        in: path
        value: abcde
```

In the “cart-service” endpoint of this example, if the path includes a path parameter (/cart/user_id/{user_id}), developers can define a “params” attribute and set “user_id” to “abcde”. Importantly, because “in” is set to “path”, it is treated as a path parameter. Further, “in” can also be set to “query” to make it a REST query parameter.

The “headers” attribute adds a header with the key “Authorization” and the value “Basic YWxhZGRpbjpvcGVuc2VzYWII”. This allows for inclusion of headers in the requests, which can be used for authentication and other purposes.

### Endpoint Configuration

The endpoint configuration file defines networking-level service details for an endpoint. An example endpoint configuration follows.

```
version: v1
services:
  - name: routeguide
    port: 50051
    alias: routeguide
    protocol: grpc
endpoints:
  - name: routeguide-svc-RouteGuide
    methods:
      - name: GetFeature
      - name: ListFeatures
      - name: RecordRoute
      - name: RouteChat
    defined:
      path: ./pb/route_guide.proto
      name: RouteGuide
    serviceName: routeguide
```

Numerous attributes are included for use in configuring the endpoint file. The “services” attribute lists the services available in the project. In this example, there is one service named “routeguide”. Under the “endpoints” section, individual endpoints are defined, specifying the available methods, the service definition path, and the service name. This example includes an endpoint named “routeguide-svc-RouteGuide” for the RouteGuide service. Within each endpoint, available methods are listed using the “methods” attribute. This example includes methods like “GetFeature”, “ListFeatures”, “RecordRoute”, and “RouteChat”. This helps specify the details of each method and how it should behave. The “defined” attribute is configured to specify the service definition file path and the service name. The service definition file (“route_guide.proto”) outlines the structure of the service and its methods.

By configuring endpoints, developers define the available services and methods within their project, facilitating the testing of their distributed application. It is recommended that users dynamically generate a test by providing service-level information but embodiments are not so limited.

### Dashboard

Skyramp embodiments include a Dashboard configured for in managing the testing environment including test results and mocks. Execution of the command “skyramp dashboard up” is configured to deploy the Skyramp Dashboard. This command automates the deployment process, creating essential Kubernetes assets (client, server, and MongoDB Kubernetes Operator) within the “skyramp” namespace of the cluster, and also initiates port forwarding for local access. Once the dashboard is live, the Terminal Client is configured to provide the forwarding address and the browser automatically opens.

Running the command “skyramp dashboard up” opens the dashboard in a new browser tab. Once the dashboard is running, tester is used to execute tests in-cluster and view the results automatically in the Test Results section of the dashboard as described in detail herein. For example, if two tests referred to as “Checkout system testcase” and “Checkout system load test testcase” are run, then their respective results are displayed in the Test Results section of the dashboard. From the Test Results page of the dashboard, a developer can click through to the “Checkout system testcase” to see the functional test results, including output, errors, duration, and status.

The Dashboard is configured so a developer can navigate to the “Checkout system load test testcase” to view the load test results including various load-related outputs and graphs related to latency, error rate, requests per second (RPS), and pod-specific utilization. Dashboard test results are valuable for retaining test run history and sharing among development team members on a shared cluster.

With the dashboard running, mocker can be used to apply mocks in-cluster and track active mocks as described in detail herein. For example, if the “payment-service” is mocked using “skyramp mocker apply”, then active mocks and responses can be viewed in the Mocked Services section of the Dashboard. This is particularly useful when managing multiple mocks across teams on a shared cluster and keeping track of the payloads for each endpoint.

### Skyramp Operational Examples

Following are descriptions of operational examples involving use of Skyramp.

### Skyramp & Github Codespaces for Kubernetes Development

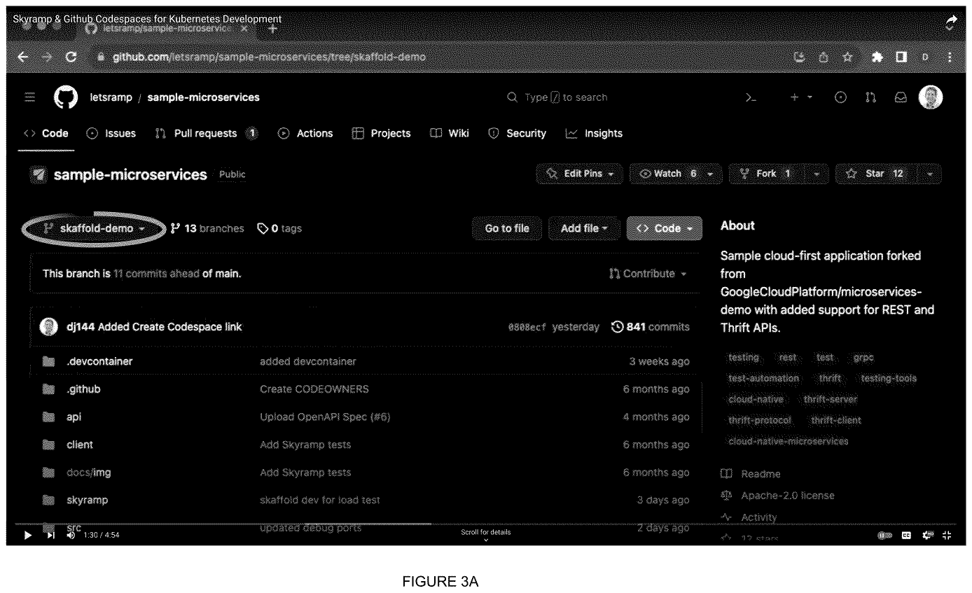

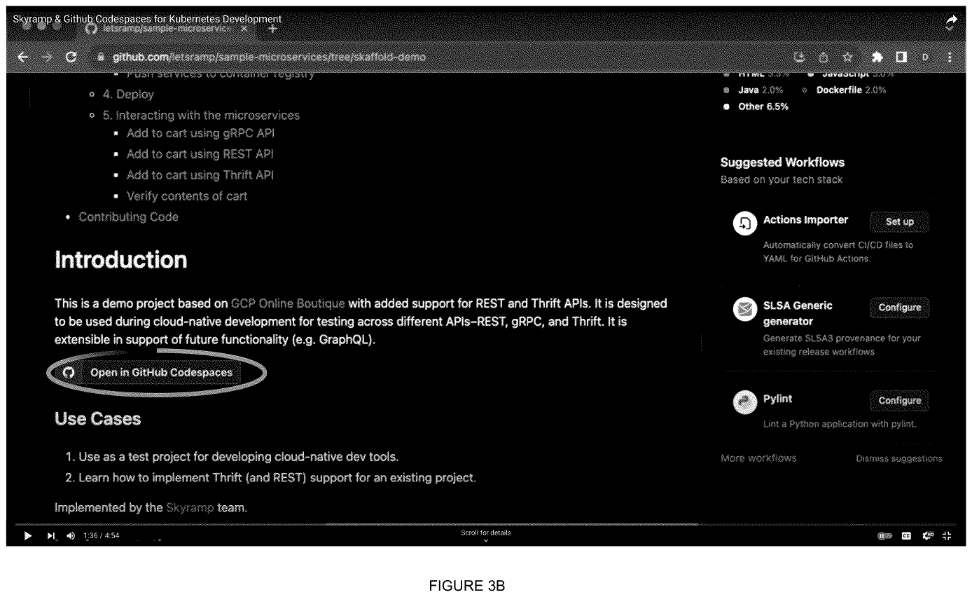

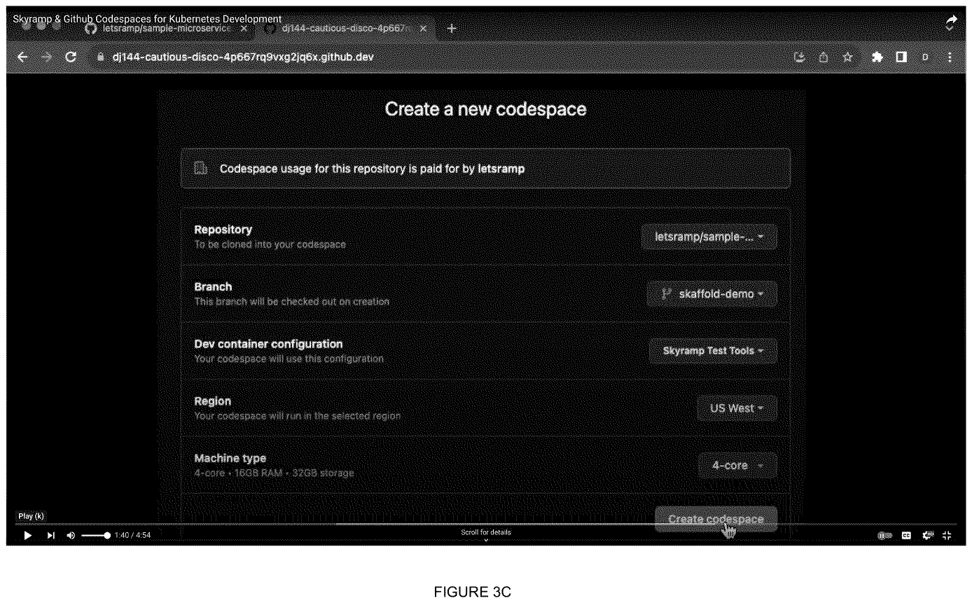

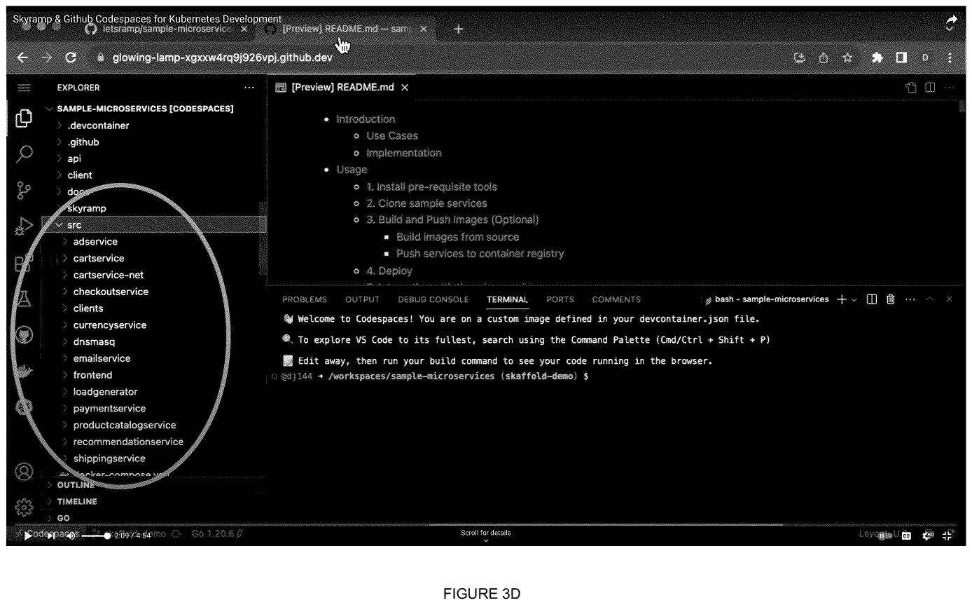

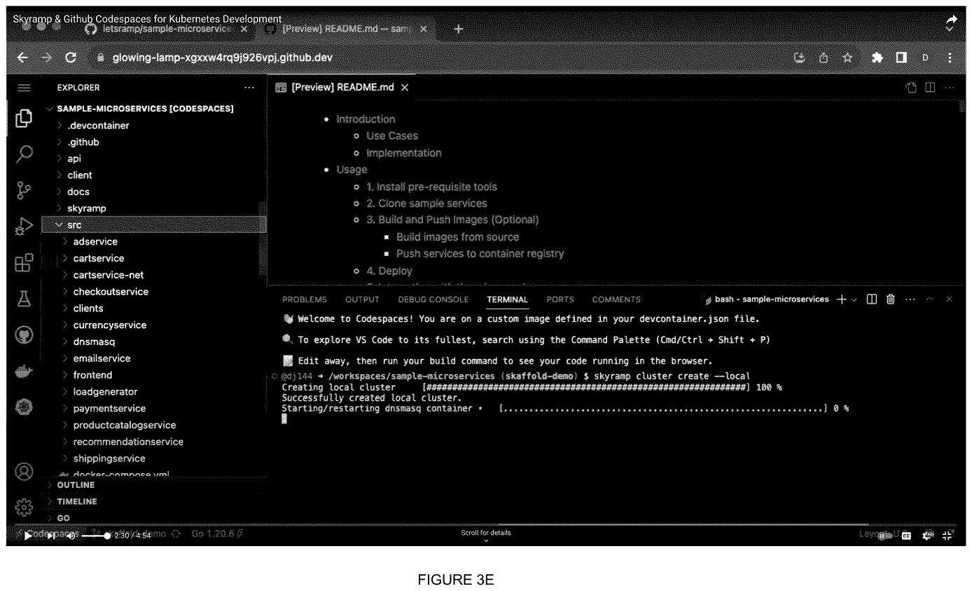

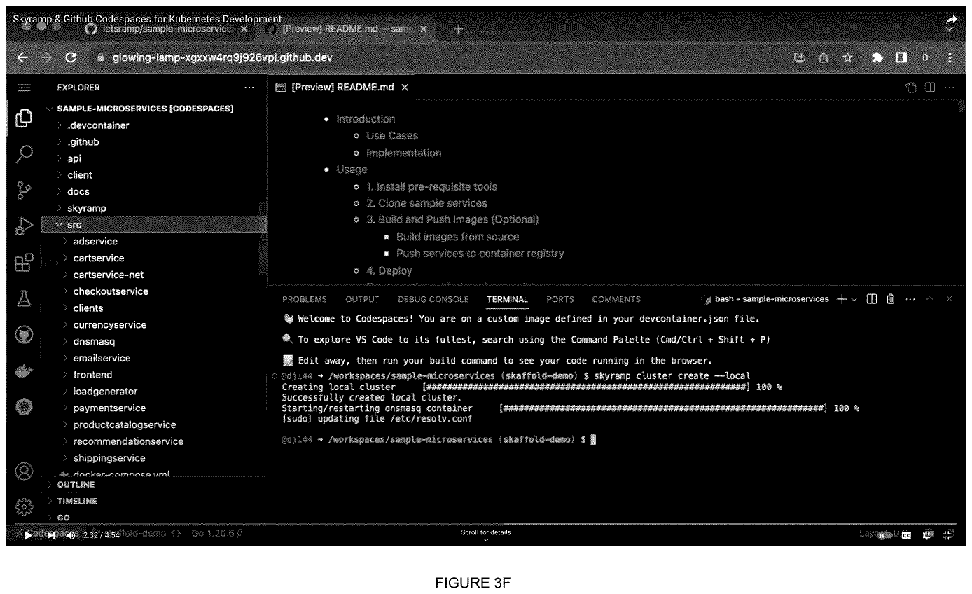

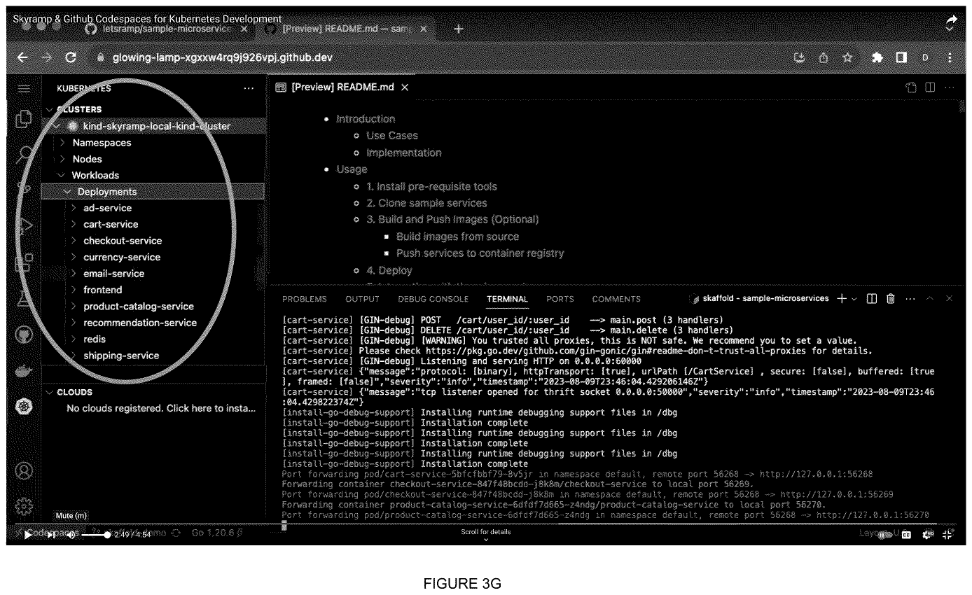

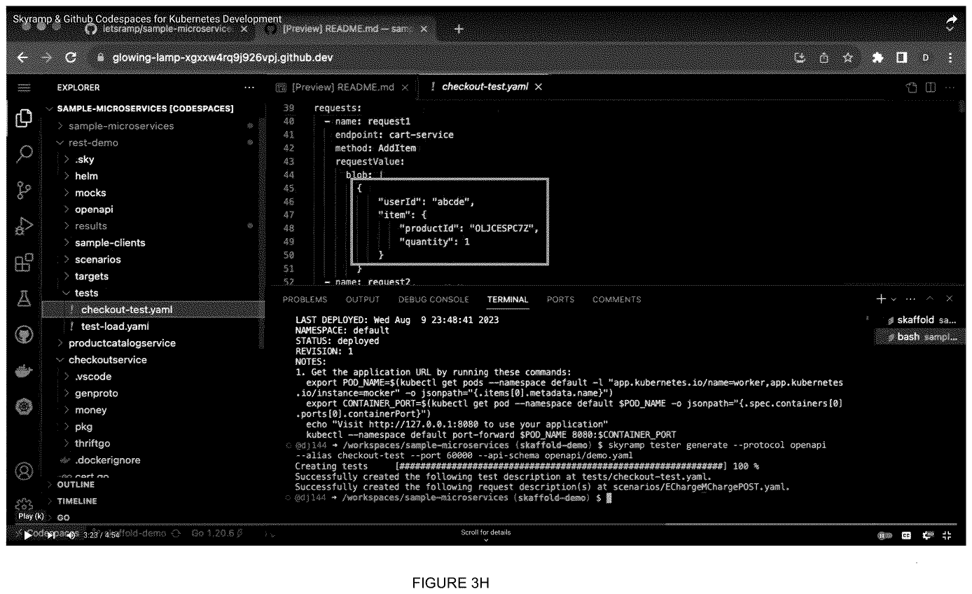

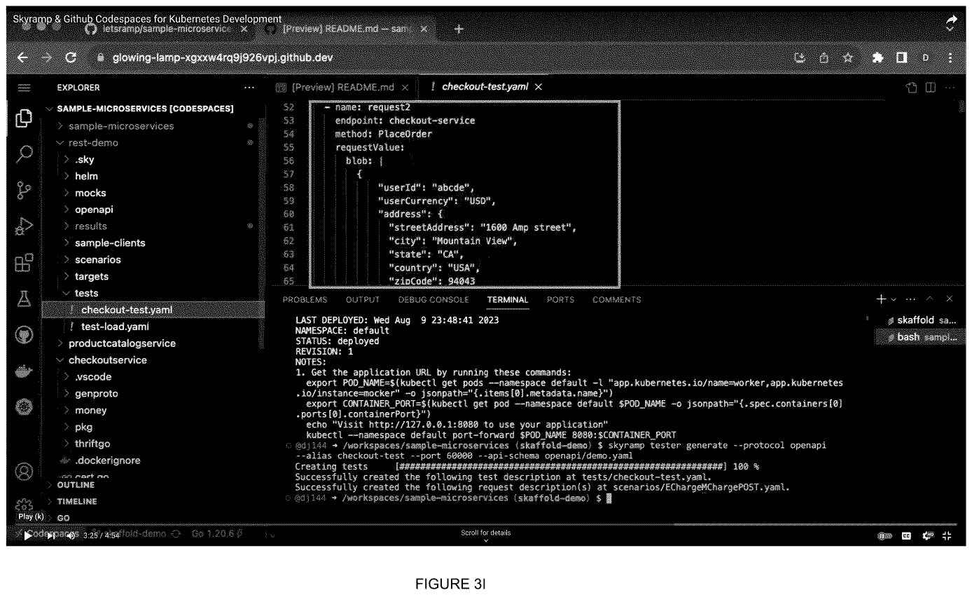

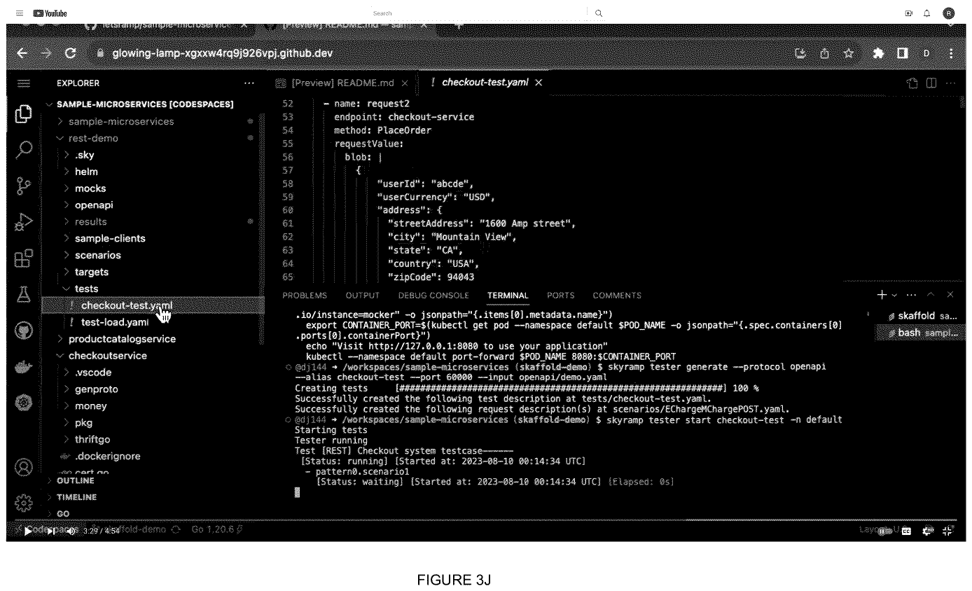

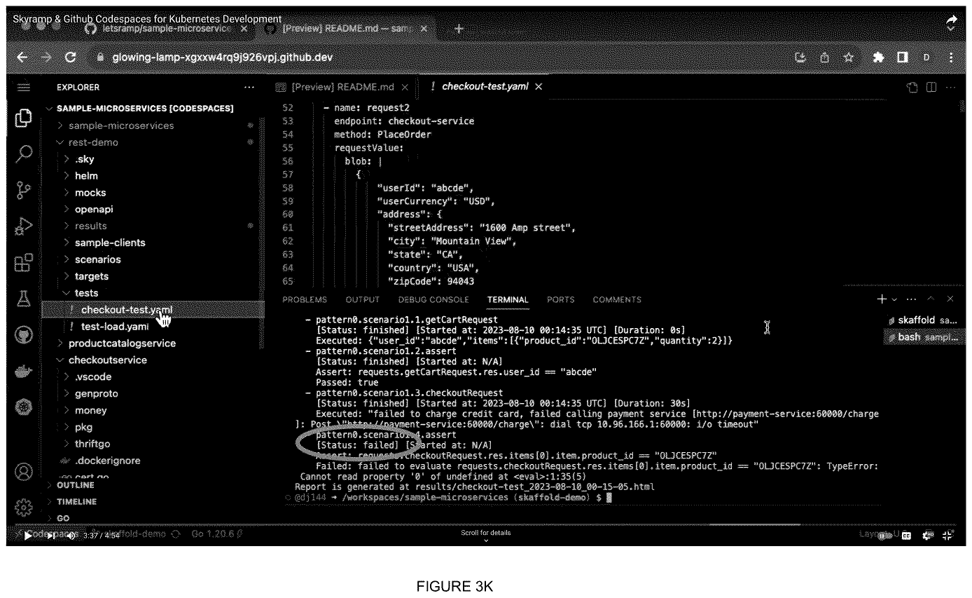

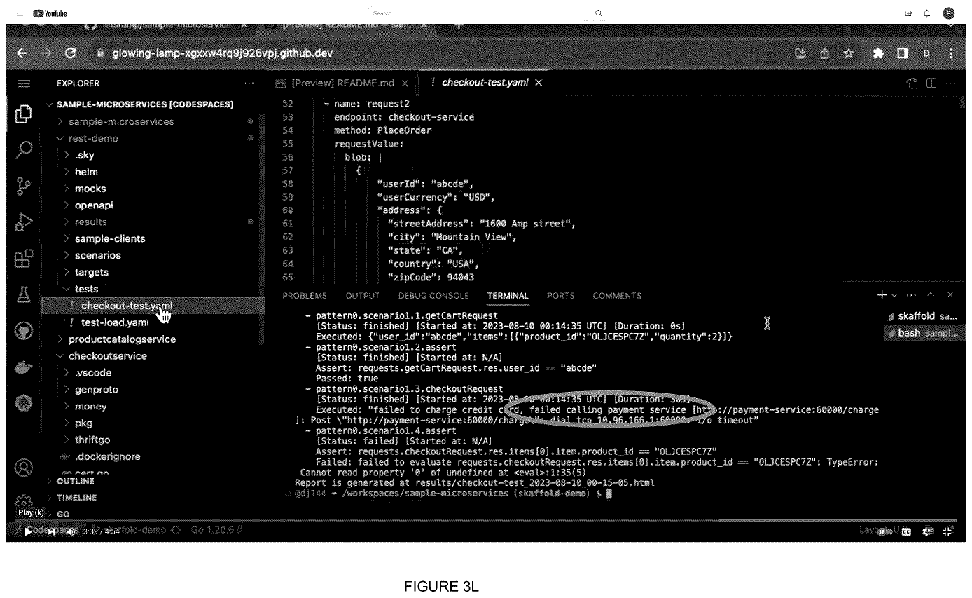

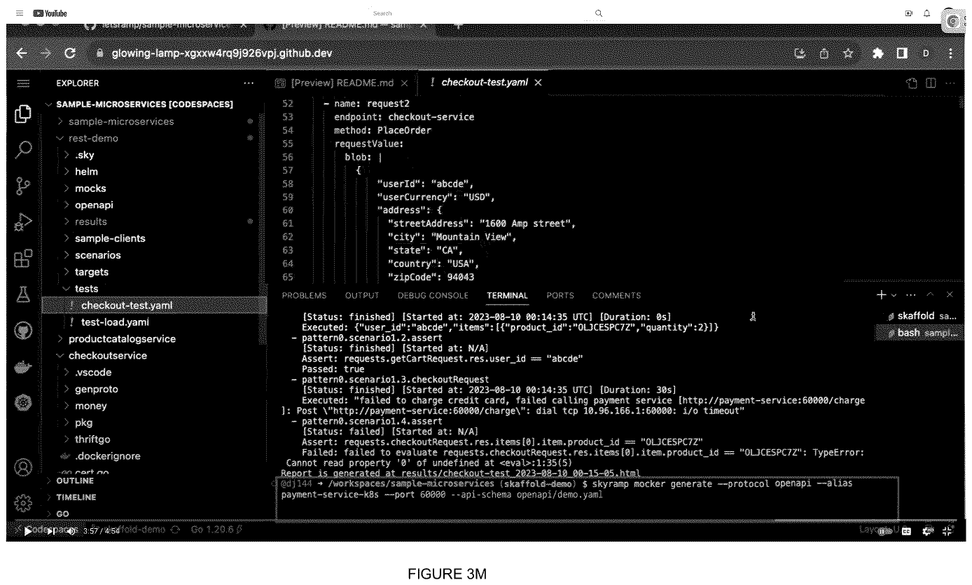

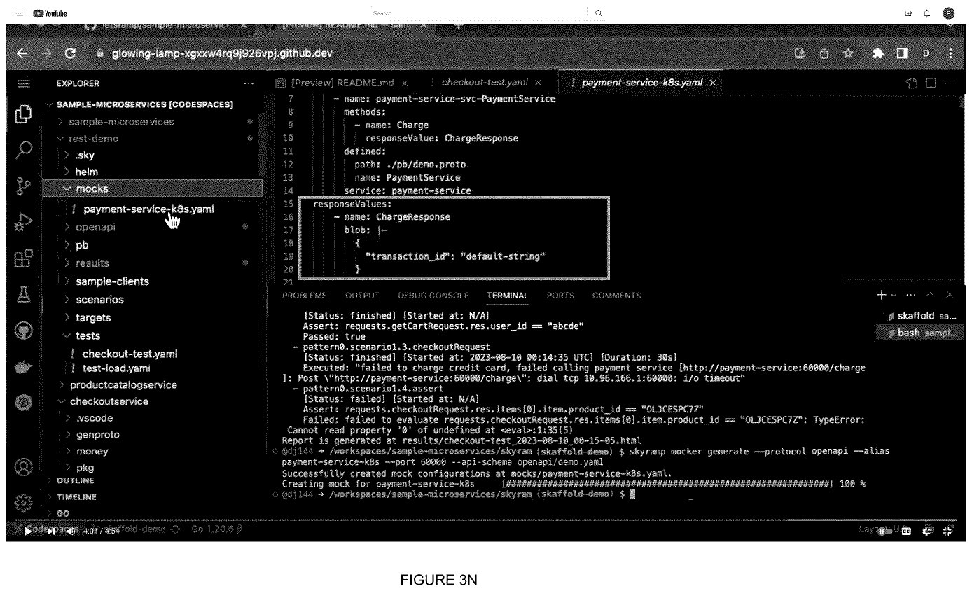

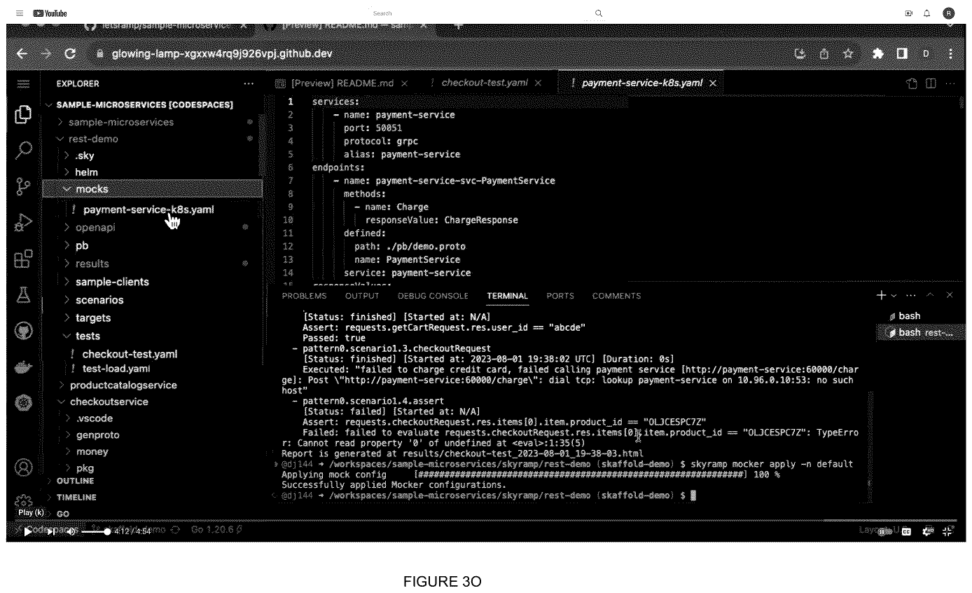

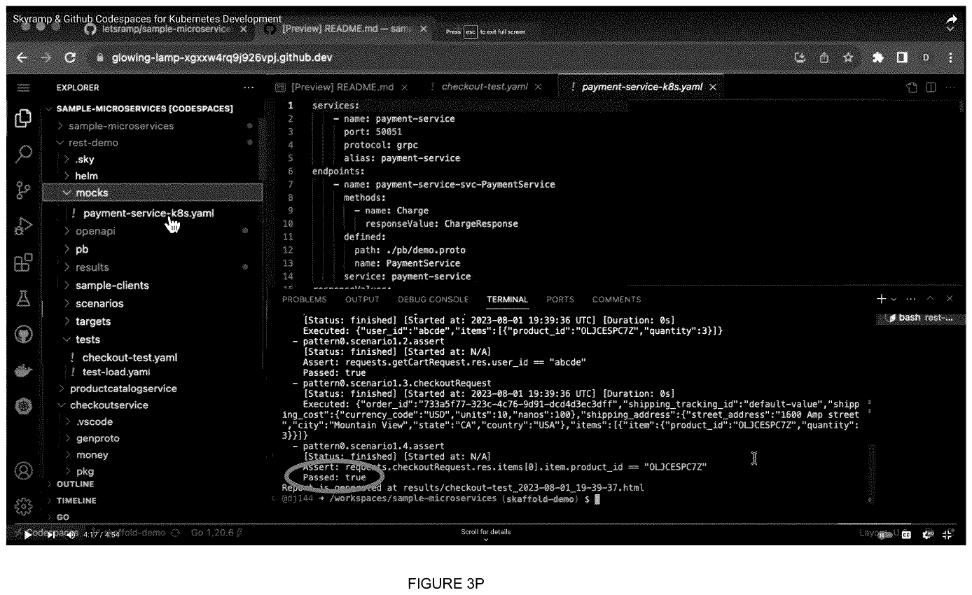

Skyramp makes integration and performance testing for distributed applications easier by automating manual tasks to save you time. FIGS. 3A-3P show a screenshot sequence for Skyramp when testing and mocking microservices in a Kubernetes cluster, under an embodiment. This example demonstrates how Skyramp can be used in any development (dev) environment to test and mock microservices by leveraging GitHub code spaces.

This example includes the Cloud native microservices demo application Online Boutique, a web-based e-commerce app with sample functionality including product catalog, shopping cart, recommendations and payment that uses GRPC APIs. Skyramp also includes support for REST and Thrift APIs in the fork of the repository.

More specifically, this example demonstrates testing whether the checkout subsystem of Online Boutique is functioning correctly. Typically, the API endpoints of the services under test can only be accessed from within the Kubernetes cluster so you either have to set up a very permissive Gateway or proxy, or manually package tests into a container that can run in the cluster. Use of the Skyramp tester avoids this manual work, thereby saving time and enabling focus on the test payload.

From the skaffold demo branch (FIG. 3A) in the sample-microservices repository, click “Open in GitHub Codespaces” from the readme (FIG. 3B), then click “create code space” (FIG. 3C). The codespace virtual machine (VM) is running a Visual Studio (VS) code server and a Dev container with the Skyramp client pre-installed from the configuration defined in the devcontainer.json file. Upon creation of the code space, a VS code workspace is present in the browser tab with the source code pre-loaded (FIG. 3D).

In this example a local cluster is spun up using the command “skyramp cluster create-local” (FIG. 3E). This cluster is used to host testing of the microservices and mocking of their dependencies. Optionally, Skyramp provides the option for the user to register their own cluster.

The services of the checkout subsystem are then deployed using scaffold (FIG. 3F). With the microservice under test now deployed in the code space the Kubernetes VS code extension is used to see the cluster and deployments (FIG. 3G). In order to avoid needing a gateway or a proxy or manually packaging the tests to run in the cluster, Helm is used to install the Skyramp worker for use in conducting the test. With the checkout subsystem and the worker in place the functional integration testing can proceed.

With a few simple user inputs, a natural test description is created that attempts to add an item to the cart (FIG. 3H) and then to check out (FIG. 3I). Skyramp tester is then run to send the generated test description to the worker to test the checkout subsystem (FIG. 3J). In this example the test fails (FIG. 3K) because the payment service is missing (FIG. 3L).

Skyramp is used to mock internal or external dependencies like the payment service (FIG. 3M) and avoid the complexity of deploying the missing dependency. Just like tests, mocks are also generated by Skyramp. Mock responses can either be static as in this generated description (FIG. 3N) or dynamically generated by a script. Following generation, the mock description is sent to the worker to mimic or stand in for the payment service (FIG. 3O). The test is repeated again with the mock in place and it now passes (FIG. 3P).

Missing dependencies will no longer derail the microservice testing process when using Skyramp. In this manner Skyramp makes functional integration testing for distributed applications easier by saving valuable time through automation and avoiding complicated dependency management. In combination with the flexibility of GitHub code spaces, Skyramp lets you confidently go beyond unit testing and deliver rock solid applications.

### Hot Code Reload: Testing and Debugging Microservices in Real Time

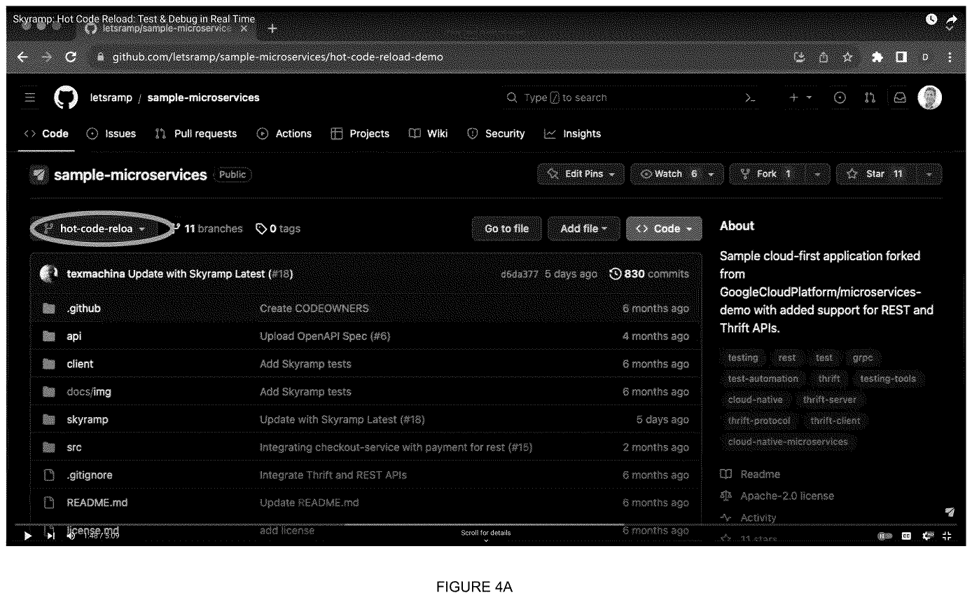

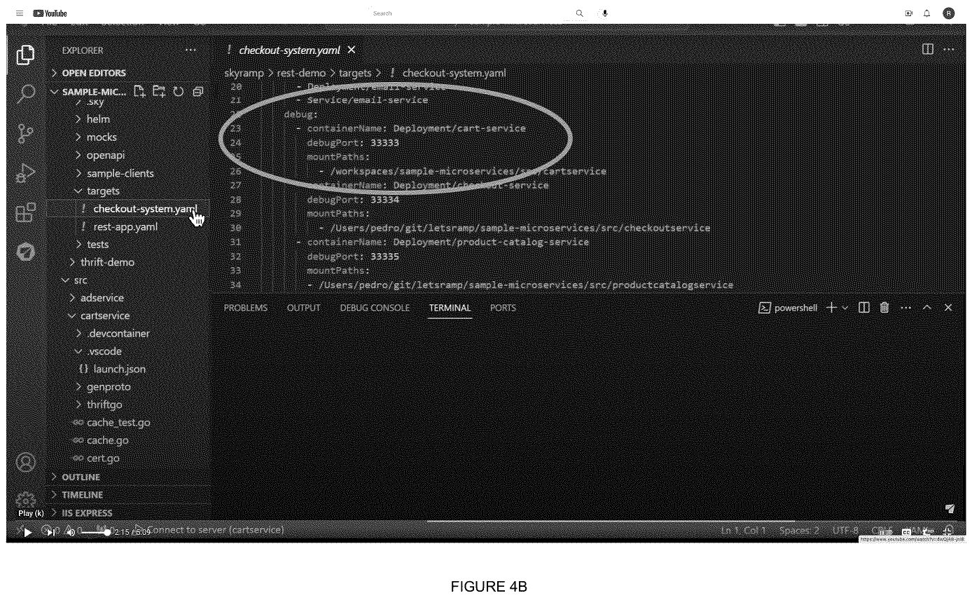

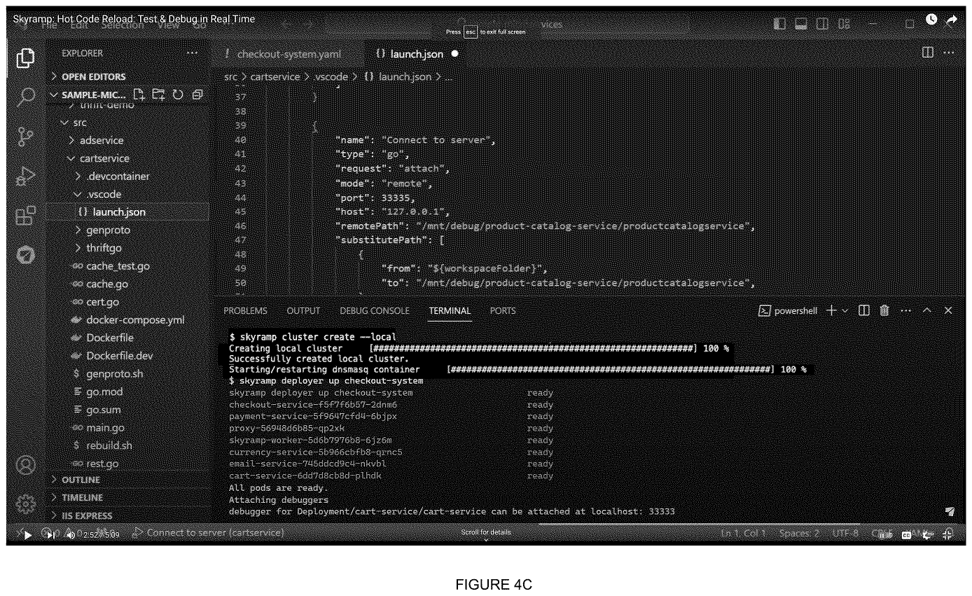

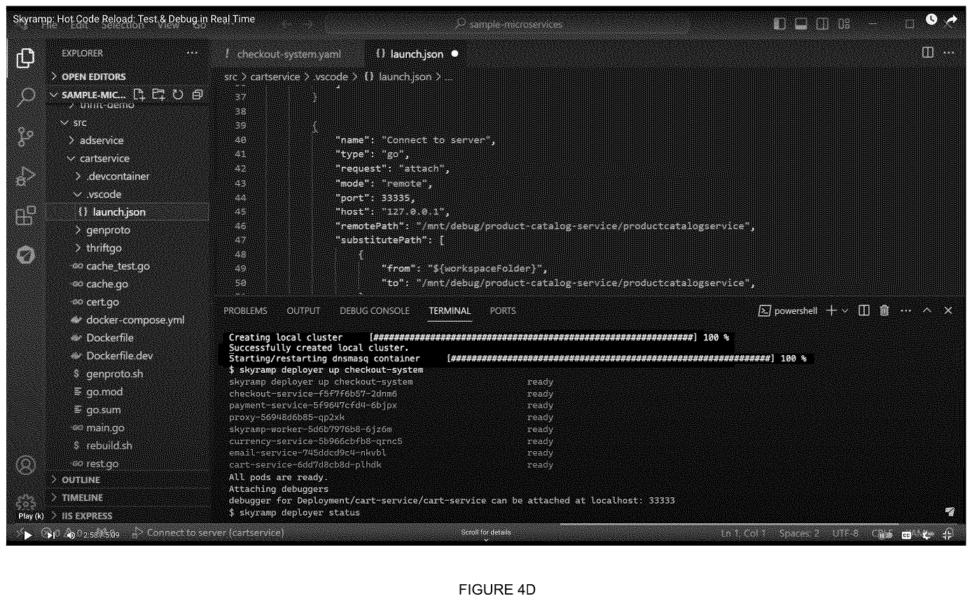

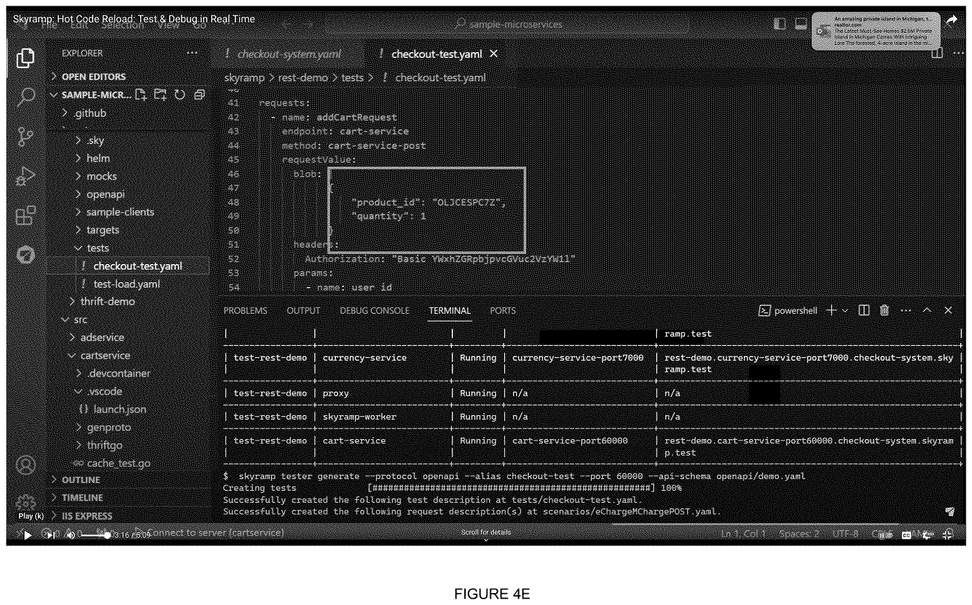

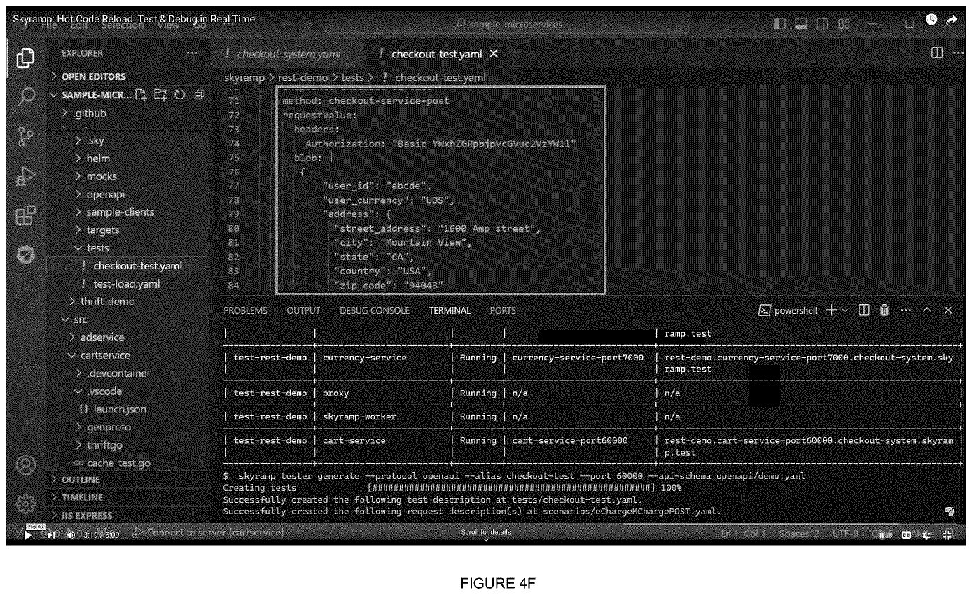

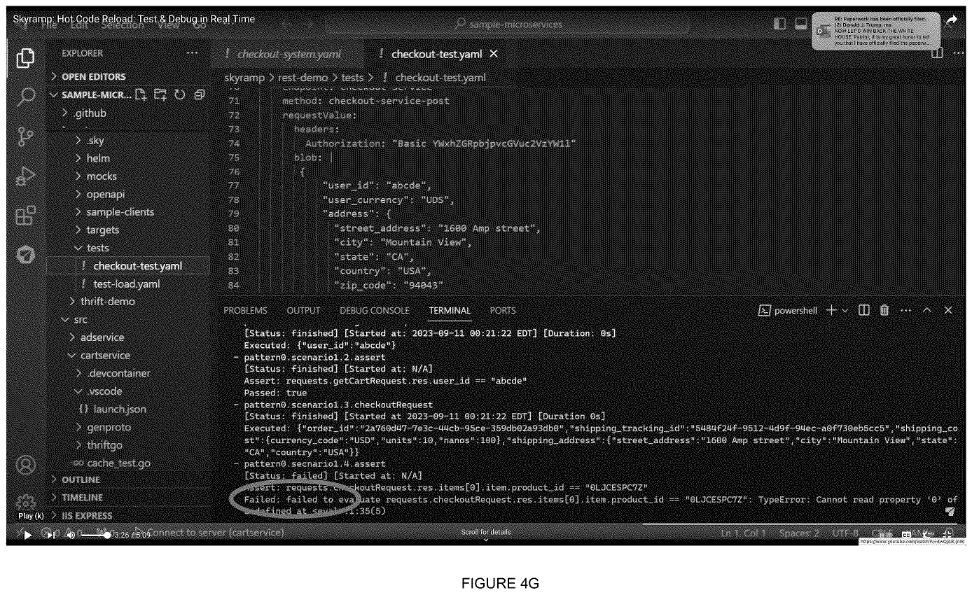

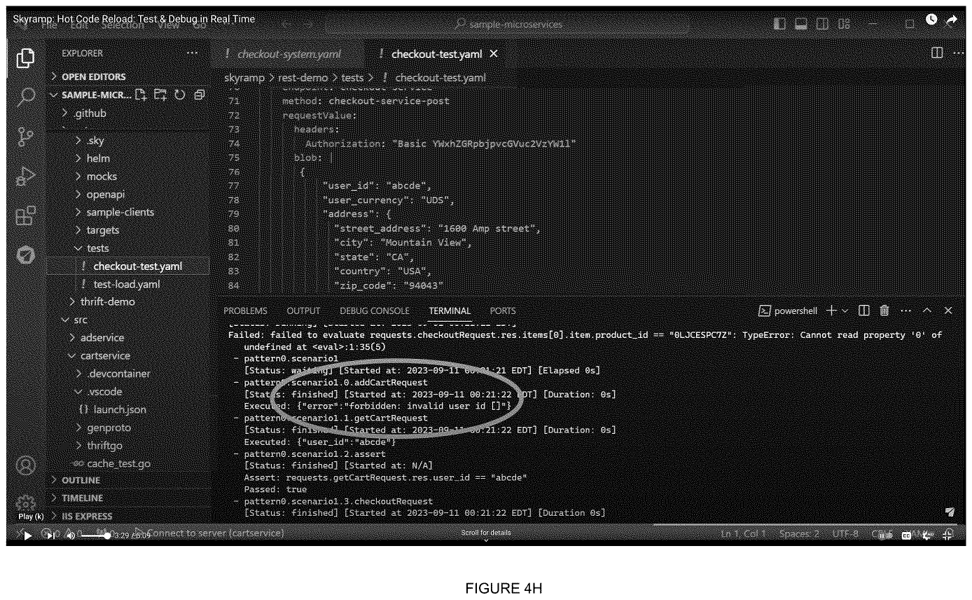

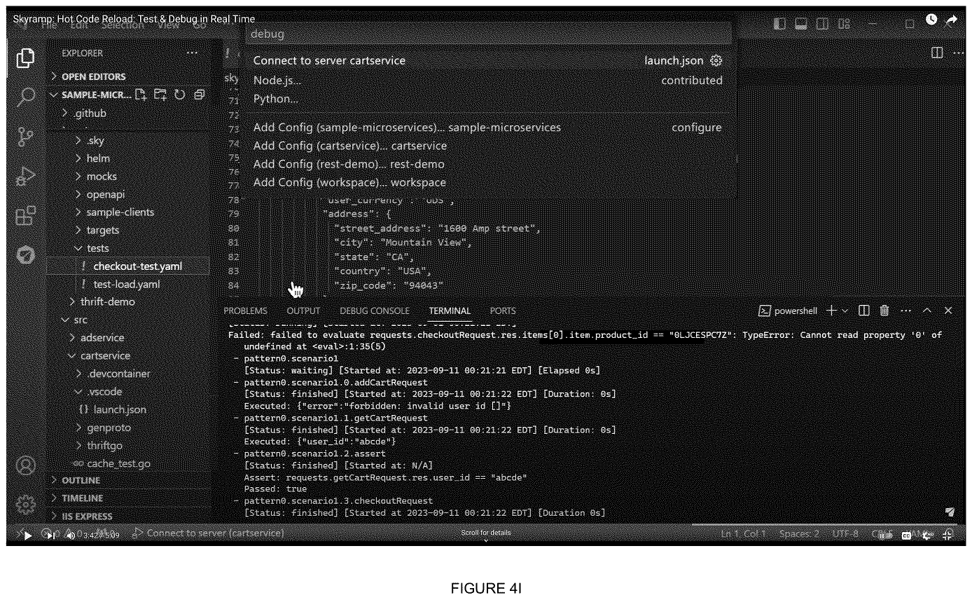

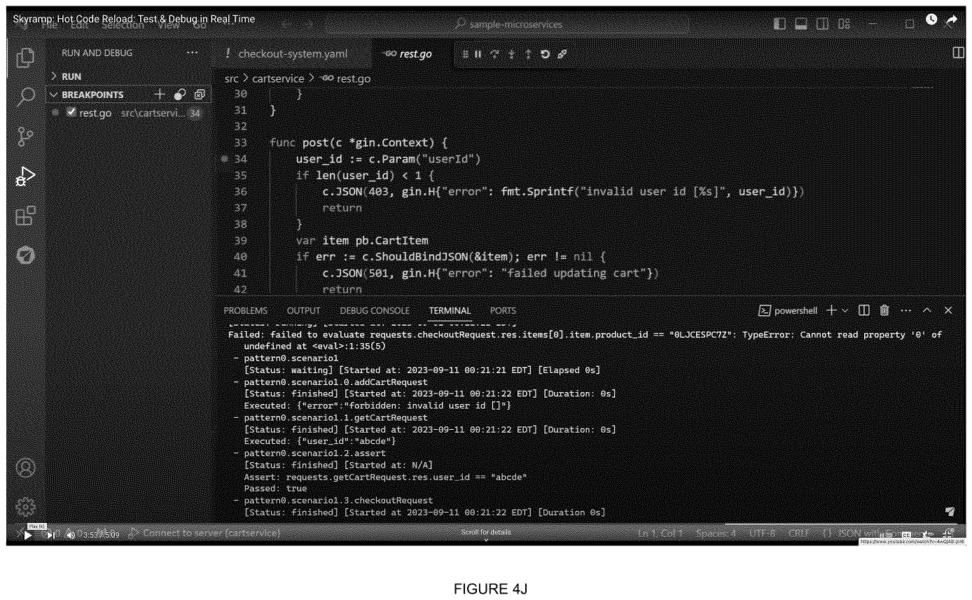

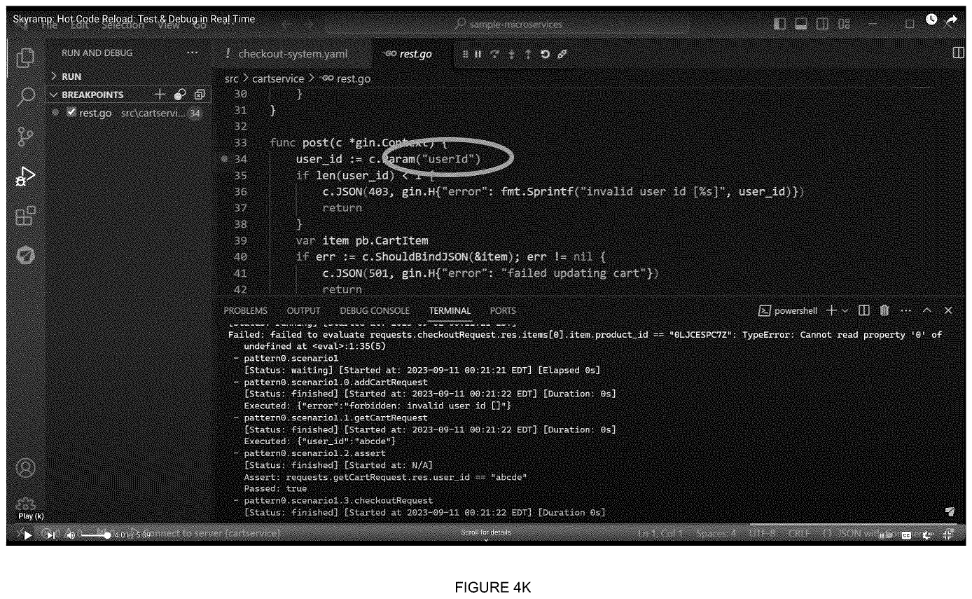

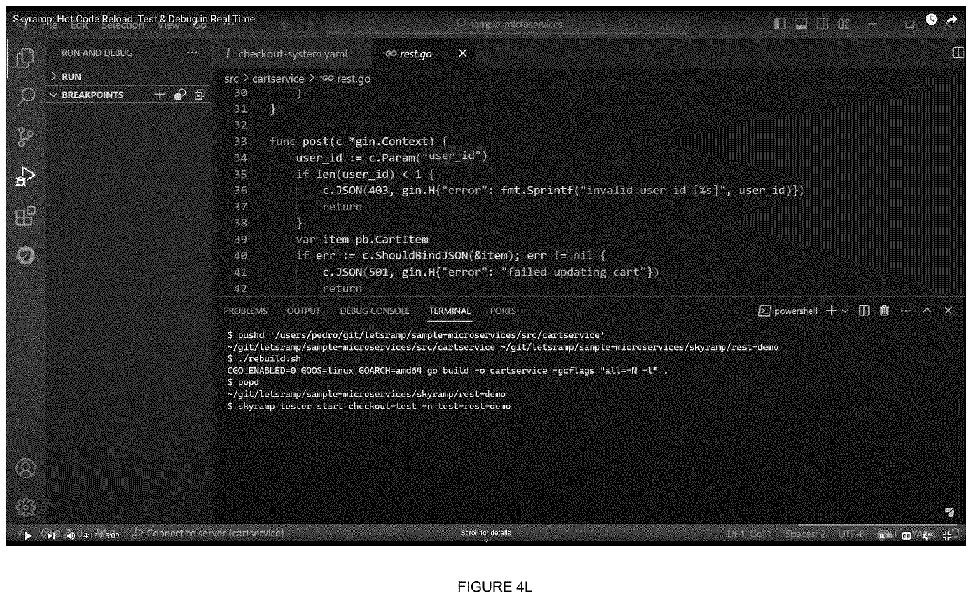

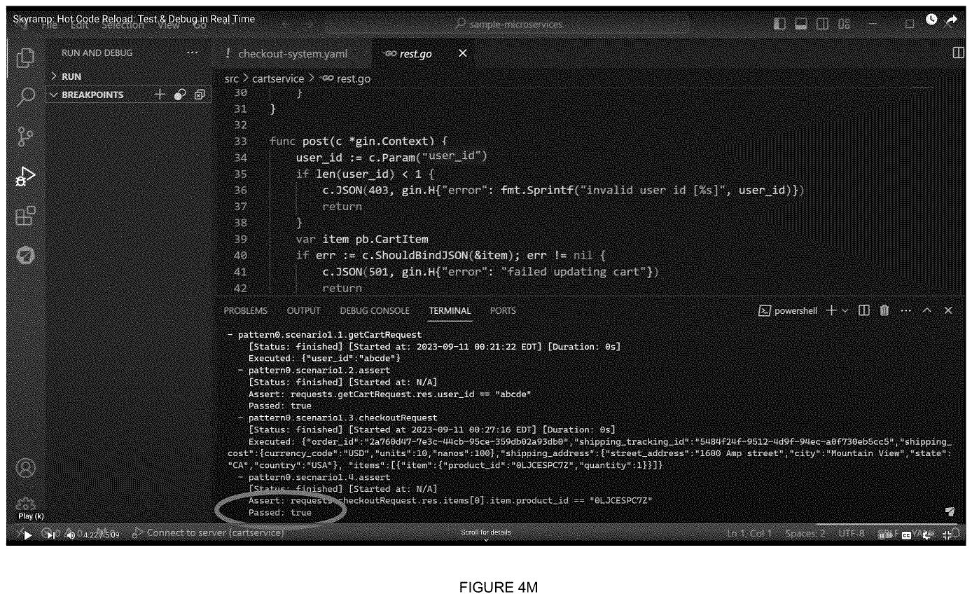

FIGS. 4A-4M show a screenshot sequence when using the hot code reload feature of Skyramp to enable real-time iterative testing and debugging of code, under an embodiment. This example also includes use of the Cloud native microservices demo application Online Boutique as described herein.

This example assumes there was an issue reported with checkout for Online Boutique. The relevant services are deployed using Skyramp deployer configured with hot code reload to debug the issue. Once the relevant services are up, the tester is used to verify that there is indeed an issue with the checkout subsystem. Finally, the code is debugged, and the bug is fixed and then validated, all of which are performed in real-time in a Kubernetes cluster without any redeployments.

This example begins with a user cloning the hot code reload demo branch from the Skyramp sample microservices repository on GitHub (FIG. 4A). This will be used as the code base. The VS code is then used to load the project. Note, this same flow works with any other IDE.

Referring to the target description file, a debug section is used to deploy the services that need hot code reload (FIG. 4B). This enables making code changes without tearing down and redeploying services. The debugger is configured for VS code by matching the ports and source code paths in the launch.json file. From here a local Kubernetes cluster is deployed for the system under test. Following creation of the cluster the services are deployed.

The command “skyramp cluster creat-local” is used to create the cluster (FIG. 4C), and the deployer is then used to deploy the services in the cluster. Upon completion of the deployment, the status of the services is checked using the deployer status (FIG. 4D). With the system under test now deployed to the local cluster, the checkout subsystem can be tested.

This example demonstrates the use of Skyramp to create with a few simple inputs a natural test description that attempts to add an item to the cart (FIG. 4E) and then to check out (FIG. 4F). The test is executed and for purposes of this example the results show the test failed (FIG. 4G) as a result of a problem adding an item to the cart (FIG. 4H). With the hot code reload feature enabled, the debugger is immediately started in the IDE and debugging is commenced (FIG. 4I). Breakpoints are set in the code and the checkout process is stepped through (FIG. 4J). Examination of the variables indicates that when a product is added to the cart one of the parameters is not recognized (FIG. 4K).

To verify this is the problem a change is made to the code and the change is saved, and the service is rebuilt. Hot code reload makes it possible to rerun the test with the Skyramp tester without taking any other actions (FIG. 4L). With the code change in place the test now passes (FIG. 4M). The hot code reload feature therefore seamlessly enables real-time debugging while simultaneously testing microservices.

Skyramp and GitHub Codespaces with Docker

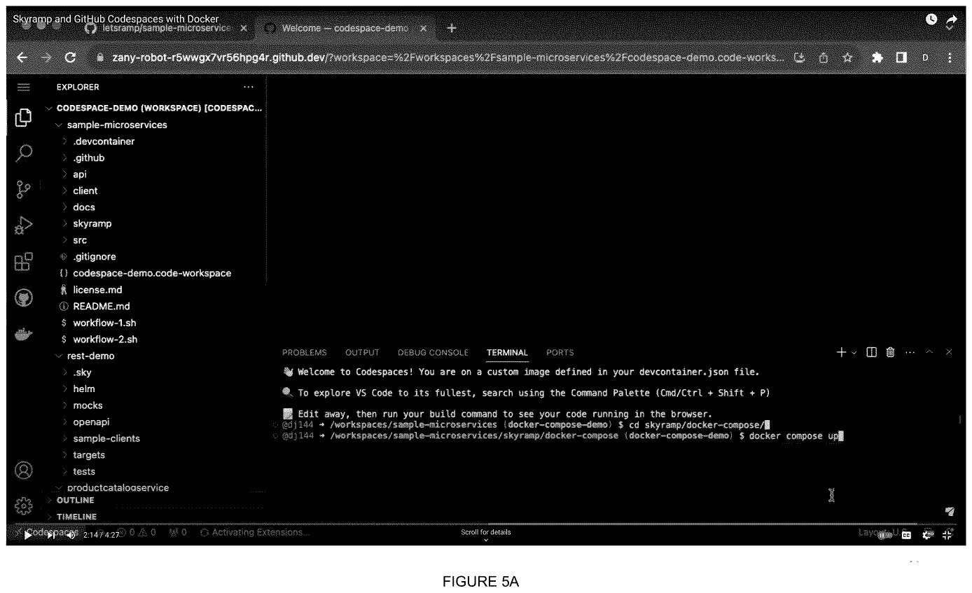

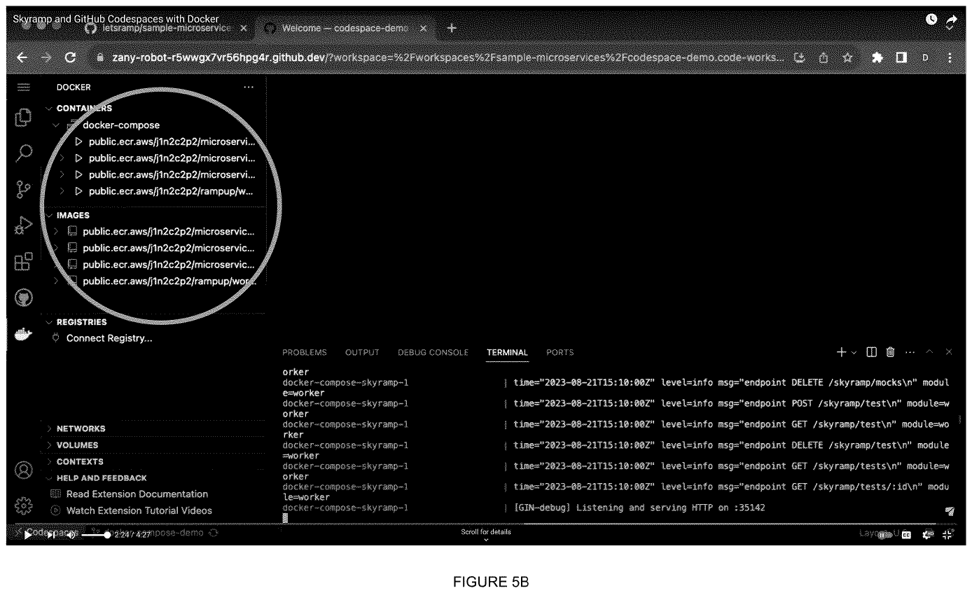

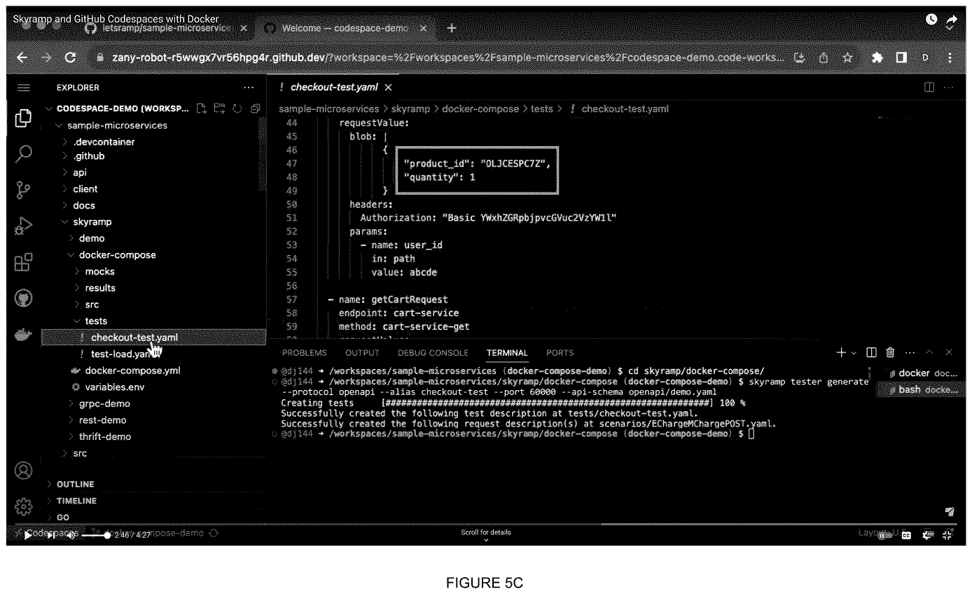

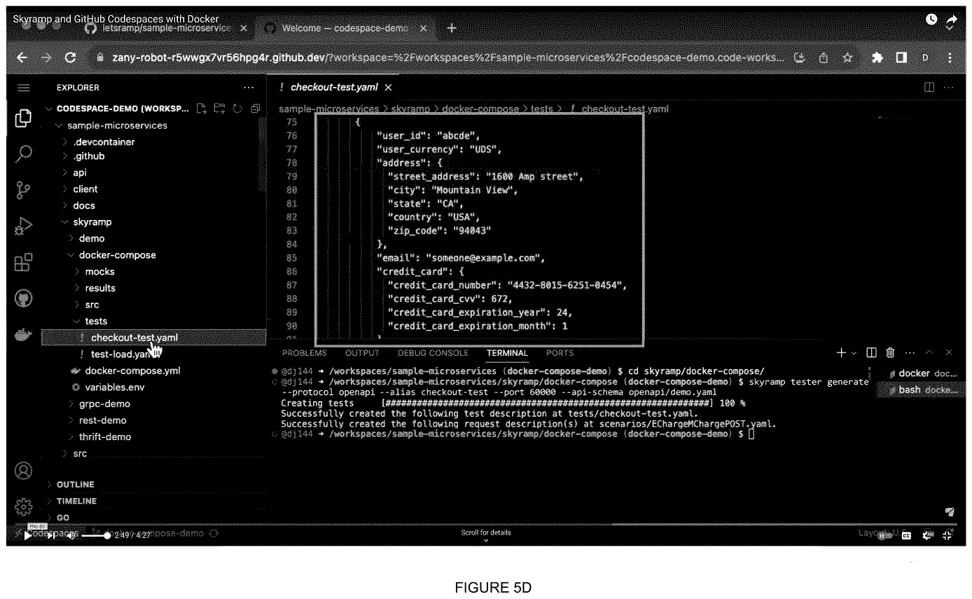

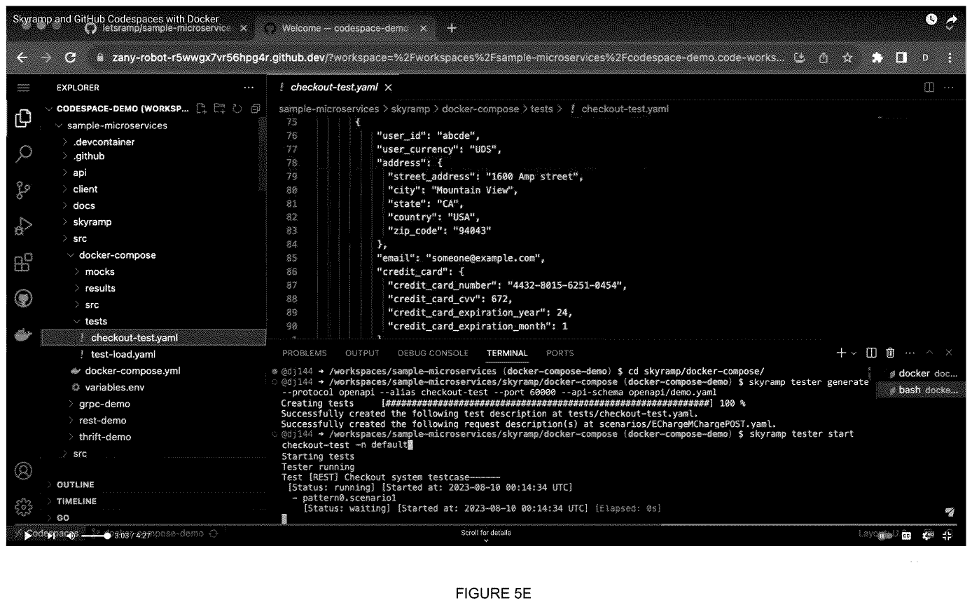

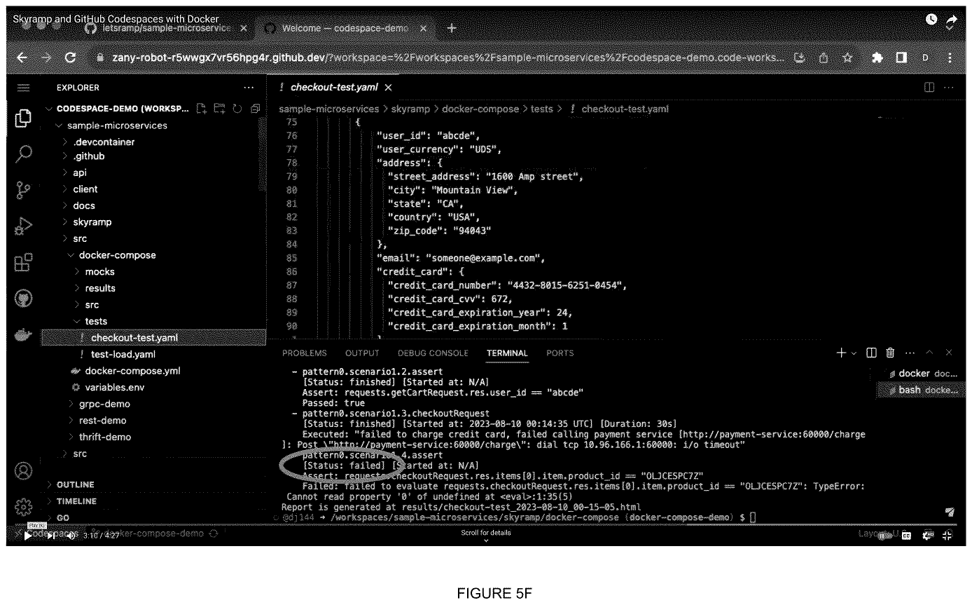

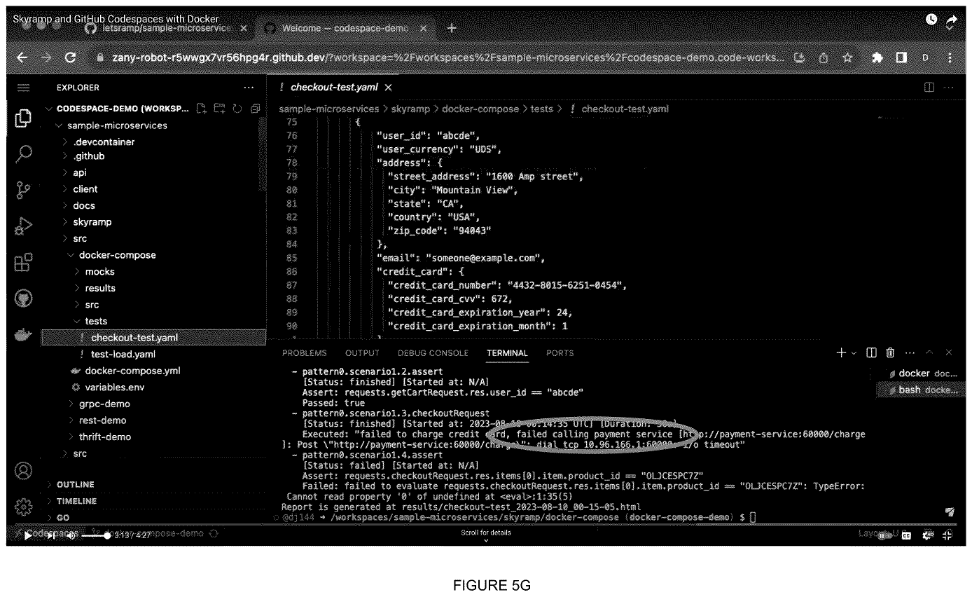

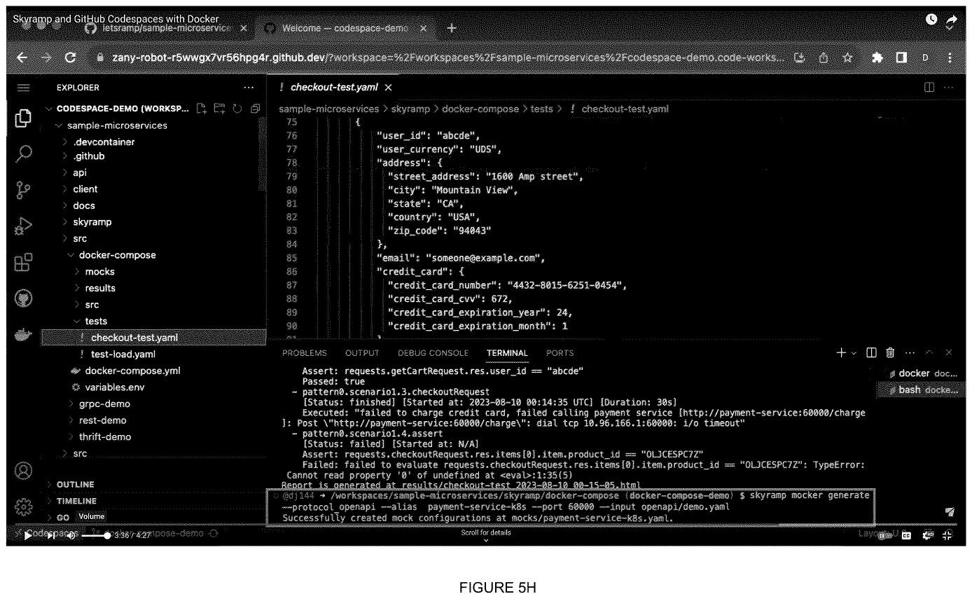

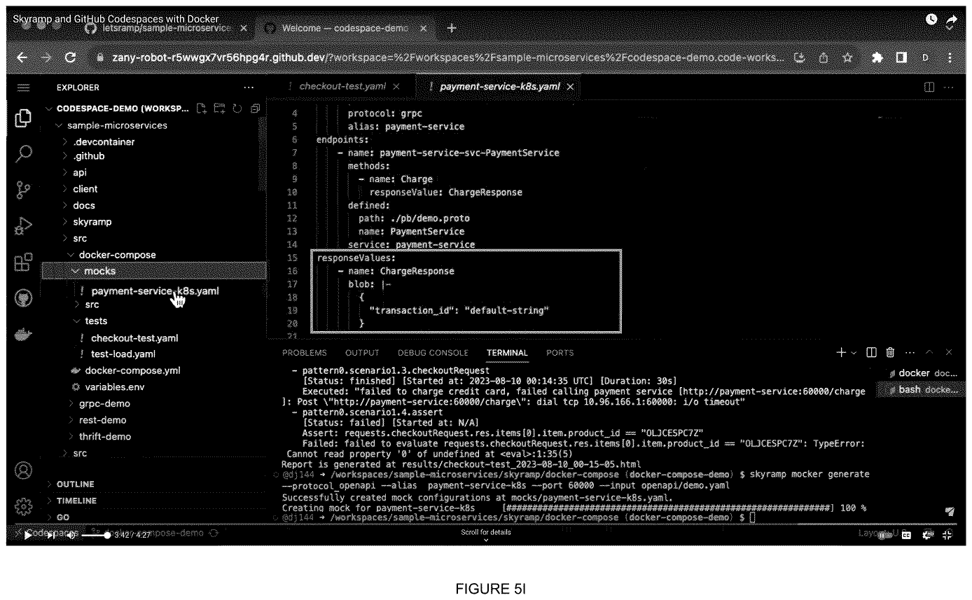

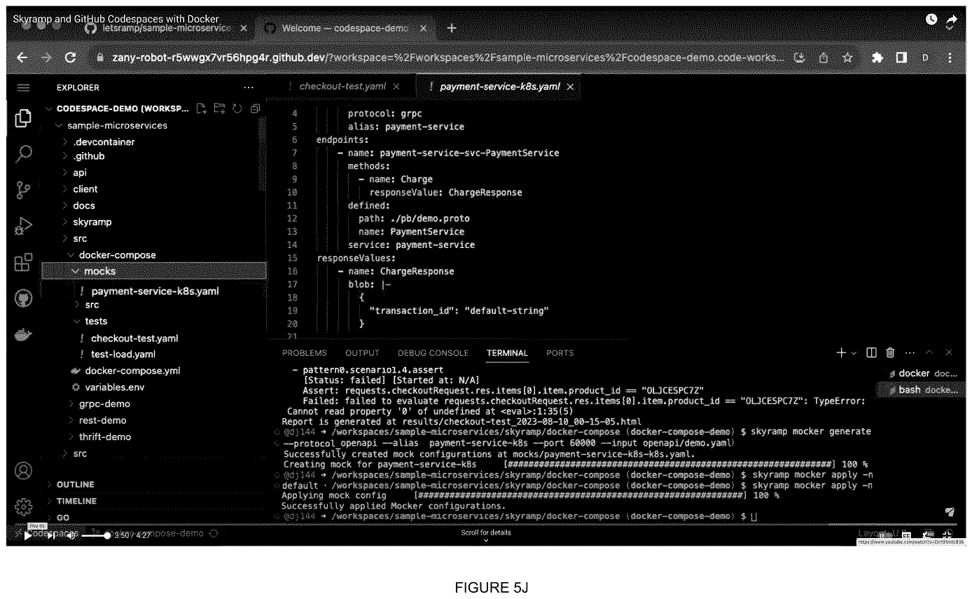

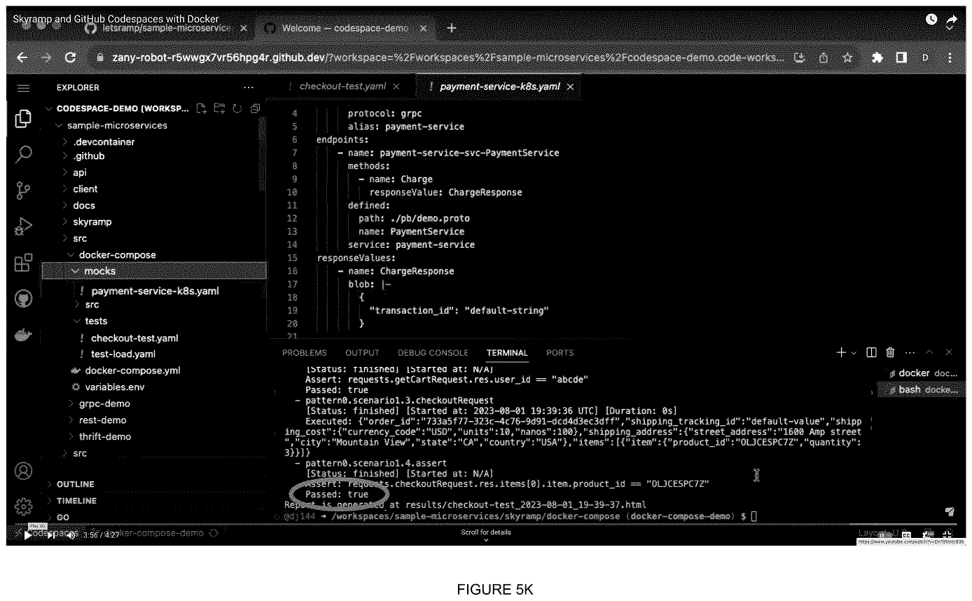

FIGS. 5A-5K show a screenshot sequence for Skyramp when testing and mocking microservices in a Docker cluster in any dev environment using GitHub code spaces, under an embodiment. This example includes use of the Cloud native microservices demo application Online Boutique to demonstrate testing whether the checkout subsystem of the app is functioning correctly. Typically, while iterating on code, tests tend to be one-offs and manual leading to repeated effort. The Skyramp tester however enables developers to focus on the payload and results and automate one-off tests for reuse and sharing.

To begin the example, and as described herein, from the docker compose demo branch in the sample microservices repository, “open in GitHub code spaces” is selected from the readme and then “create code space” is selected. The codespace VM is running a VS code server in a Dev container with the Skyramp client pre-installed from the configuration defined in the devcontainer.json file. Upon creation of the code space, a VS code “workspace” is present in the browser tab with the source code pre-loaded.

To test the checkout system of the application, the component services are brought up using Docker compose (FIG. 5A). With the system under test now deployed in the code space the Docker VS code extension is used to see the services to test (FIG. 5B). With the checkout subsystem and the worker in place, Skyramp is ready for use in functional integration testing.

This example demonstrates the use of Skyramp to create with a few simple inputs a natural test description that attempts to add an item to the cart (FIG. 5C) and then to check out (FIG. 5D). Skyramp tester is run to send the generated test description to the worker to test the checkout subsystem of the app (FIG. 5E). For purposes of this example the test fails (FIG. 5F) because the payment service is missing (FIG. 5G).

Skyramp is used to mock internal or external dependencies like the payment service (FIG. 5H) and avoid the complexity of deploying the missing dependency. Just like tests, mocks are also generated by Skyramp. Mock responses can either be static as in this generated description (FIG. 5I) or dynamically generated by a script. Following generation, the mock description is sent to the worker to mimic or stand in for the payment service (FIG. 5J). The test is repeated again with the mock in place and it now passes (FIG. 5K).

Missing dependencies will no longer derail the microservice testing process when using Skyramp. In this manner Skyramp makes functional integration testing for distributed applications easier by saving valuable time through automation and avoiding complicated dependency management.

A description follows of an alternative embodiment of Skyramp.

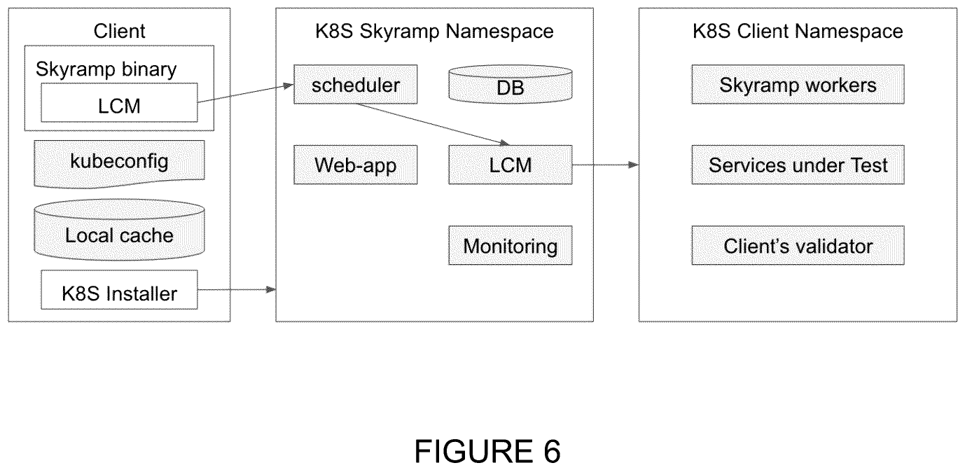

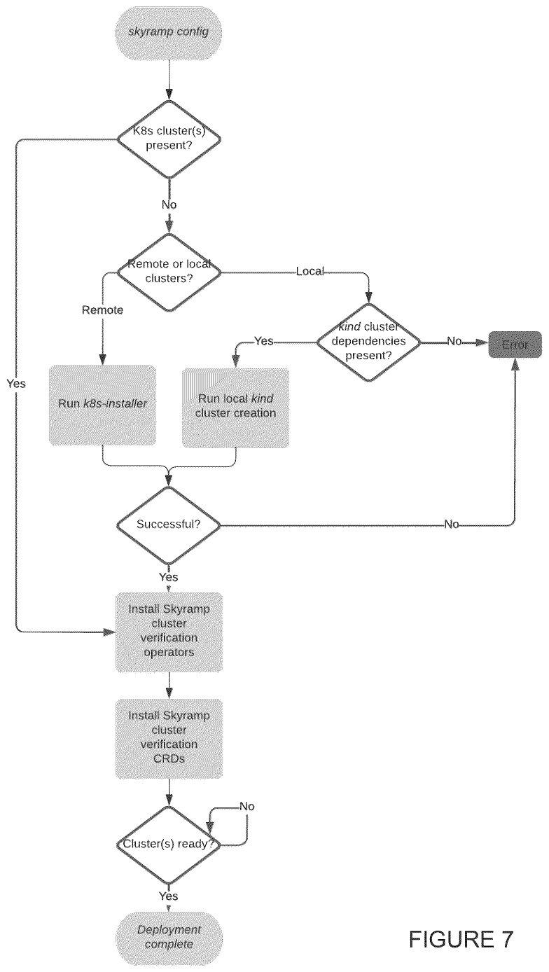

FIG. 6 is a block diagram of Skyramp components, under an alternative embodiment. FIG. 7 is a flow diagram of deployment of Skyramp components, under an alternative embodiment. Skyramp is configured to support multiple different modes of deployment, including deployment on a local machine and on a remote cluster. Deployment on a local machine is made possible because Skyramp is configured to mock dependencies which allows its targets to run with far fewer resources on a local machine (versus the more ample resources of a typical remote dev machine). Skyramp is configured to mock dependencies by enabling users to specify which service dependencies they want to mock in the target description file (YAML file that describes services needing to be deployed). Skyramp then automatically suggests default values for the mocks and creates the mock services for you.

If a user wishes to deploy Skyramp to a remote cluster however they need only to provide their existing kubeconfig files, or alternatively give Skyramp access to the remote machine. Skyramp clusters of an embodiment run in configurations including but not limited to running on a local machine (where the Skyramp binary is run), running on a set of remote machine(s) that are accessible via SSH, and running in an environment where at least two sets of Kubernetes clusters already exist, given via a set of kubeconfig files. There are many cases by which the clusters will exist or be provided. For example, a customer may provide Kubernetes clusters that are already deployed, rather than requiring Skyramp to create and initialize the clusters. A customer may also have many clusters that are created in different contexts. The Skyramp deployment methodology is flexible enough to handle all of these cases.

The example embodiment of FIG. 6 includes Skyramp components on a local client machine and in a Kubernetes cluster but is not so limited. More particularly, the local client machine includes the Skyramp binary including Configuration data (e.g., Kubernetes kubeconfig, cloud-related credentials, local cache including status information of Skyramp), Command Line Parser (e.g., takes commands from users, with Golang/cobra), Description Parser/Validator (e.g., container description parser/validator, target description Parser/Validator, builds objects internally), Builder (e.g., Kubernetes backend (translates objects to Kubernetes resources), Docker backend (translates objects to docker-compose), and LCM (e.g., deploys Kubernetes/docker resources, check status of resources until they are ready or fail). The local client machine also comprises the Skyramp Installer, which includes a container image running on the client's local machine, and has cloud-related packages installed (e.g., AWS, Azure, GCP, etc.). Given resources registered from users, the Installer is configured to create the K8S cluster, optimizes virtual machines (VMs) (possibly with daemonset), and deploy Mgmt Stack.

Skyramp components residing in the Kubernetes cluster can be in the Skyramp namespace and the client namespace but are not so limited. The components in the Skyramp namespace include a Scheduler, LCM, Skyramp web-app, monitoring, and management database. The Scheduler is configured to, given resources being used, schedule and send jobs to the LCM. The client binary communicates with the Skyramp scheduler. The LCM is configured to deploy/delete/maintain the K8S resources per target. The Skyramp Monitoring component monitors/collects status/results from Skyramp workers. The components in the client namespace of the K8S cluster include the Skyramp Worker configured to generate/respond traffic-per-traffic templates installed by the Skyramp binary.

Once Skyramp is installed via deployment of its components, a user can either initialize a new project folder, or clone an existing Skyramp project from a prespecified repository. The user then enters a command to initialize a new project. Optionally, Git can be enabled on Skyramp project folders in order to easily share container, target, and test descriptions across their team and organization.

A “target” is created when a user identifies a target they want to test and creates a target description file. A target is a subset of the application selected for testing as described herein and includes a list of services (including services that need to be mocked to isolate the services under test). When identifying a target all the services are to be included that are required for the test, and their dependencies. User can also specify which dependent services need to be mocked in order to isolate the target.

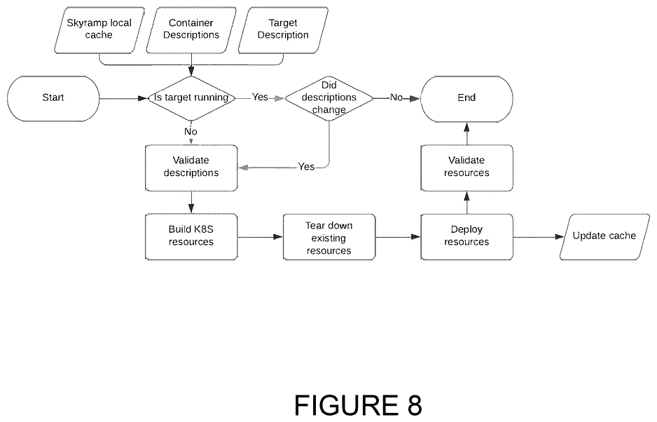

For each service specified in the target, the corresponding container description files are created or updated. The container description file includes a YAML file that captures all the information required to deploy a container but is not so limited. The targets are then deployed using a specified Skyramp command. FIG. 8 is a flow diagram of Skyramp deployment of a target (e.g., “up” command), under an alternative embodiment. Skyramp can run the target either remotely or locally if the local machine has sufficient processing power and memory to support the target. In either case, Kubernetes are used for orchestration.

For local deployment, Skyramp uses Docker. If running on a local machine, a local Kubernetes cluster is needed. Skyramp can automatically install the necessary software and set up a local Kubernetes cluster if needed. Alternatively, if the user is familiar with Kind or Minikube, they can bring up a cluster on the local machine and add the kubeconfig to Skyramp by running a specified command. The resources (yaml) file should also be updated to specify that the cluster is local.

If a target requires more resources than can be provided by a local machine, Skyramp can be pointed to VMs in the cloud by specifying credentials, hostname, IP, and role (master or worker) in the resources file. Optionally, if a cluster is already running on the VMs, the kubeconfig can be added to Skyramp. Regardless of whether a kubeconfig file is provided or not, the resources should be configured after any update to the resources file or kubeconfig.

The target is then deployed from the project folder. Following target deployment, the Skyramp-provided namespace information can be used by the target to interact with the API endpoints to be tested. Microservice testing is then performed on the deployed target.

Skyramp is configured to support users running three different types of tests including but not limited to functional, load, and stress tests. The functional tests verify how the system under test behaves with specific inputs and whether it functions as expected under normal conditions. Load tests allow developers to answer whether their system can handle a specific load scenario when operating under defined resource constraints. Given a set of resources, stress tests allow users to understand the behavior of their systems on increasing load conditions, and the results enable users to provision their systems with more confidence to handle different load scenarios.

Skyramp is configured to write once, run multiple test types in order to support ad-hoc, load, and stress testing using the same test scenarios. Instead of writing throwaway local tests, users can re-use Skyramp scenarios to run different types of tests. Skyramp is configured to take care of any additional work, for example setting up the load per the specification, or running validations from a script provided by the user.

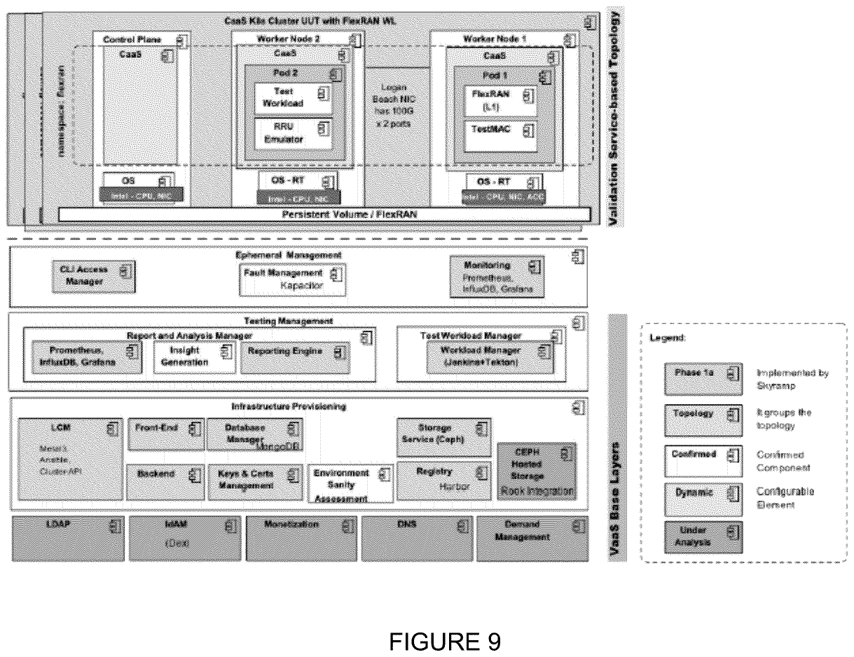

FIG. 9 is a block diagram of Skyramp components in an example deployment, under an alternative embodiment. In this example architecture, Skyramp provides a test automation platform and a repeatable process to allow customer onboarding on a Validation-as-a-Service (VaaS) product. The use of Skyramp enables the VaaS product developer to hide the complexity of deploying the VaaS product and launching tests of the VaaS product from their customers and improve their customers testing velocity. The Skyramp test automation platform will automatically deploy the VaaS product onto the product developer's customers platform and automate the process of running either a subset of tests or an entire suite of tests without the massive (hundreds of pages of documentation and information on thousands of tests) onboarding cost.

In this example embodiment, Skyramp deployment includes but is not limited to the following.

LCM: Skyramp LCM stack is configured to provision Kubernetes clusters using ansible, kind and cluster-api. The LCM stack is configured to provision/tear down on either local machines (knid) or remote clusters (cluster-api).

Front-End/Backend: Skyramp is configured to include a GUI, and current UX is through the terminal.

Database Manager: Skyramp is configured to use a combination of Kubernetes features and etcd to store/monitor status of clusters, pods and any other resources. The status of pods/services can be fetched on demand using a Skyramp command.

Keys and Certs Management: Users to provide Skyramp with an ssh key for access to their Kubernetes nodes.

Storage Service: Skyramp is configured to treat this as part of customer infrastructure and supports two cases: 1) Container description: specifies host file path to be used by Skyramp to mount; 2) Specified as part of Helm chart: Skyramp is configured to deploy helm-charts as-is.

Registry: Docker local registry is configured to host container images and helm-charts. Accessibility from worker nodes to be checked.

CLI Access Manager: Skyramp binary supports CLI access with a set of commands including but not limited to commands to deploy and clean up services, validate input files, manage running tests, check cluster status, and fetch logs among others.

### Test Workload Manager:

1. ‘Declarative’ Test creation:
   a. Configuration (yaml), not code; focus on the “what” of the test, Skyramp takes care of the “how”.
   b. Easy templates to create new tests, test suites.
2. Test setup:
   a. Deploy system under test into provisioned infrastructure; support automated creation of systems under test.
   b. Manage test environment, load any necessary files.
   c. Parse, validate and interpret test inputs.
3. Test execution:
   a. Parse and interpret test scenario (chain of commands); xequential, parallel, any combination of sequential/parallel.
   b. Run tests; supports parallel systems under tests and tests.
4. Test management:
   a. View currently active tests.
   b. Terminate running tests if needed.
   c. Support test scheduling.
5. Test logging:
   a. Fetch app logs.
   b. Fetch usage logs.
   c. Fetch test logs.
6. Test output validation:
   a. Collect test output.
   b. Compare against desired results.
7. Test clean up: restore provisioned infrastructure to original state.

Reporting Engine (Test Management): Skyramp is configured to generate visualizations of the test suite output.

Monitoring (Ephemeral Management): Skyramp is configured to monitor resource usage (CPU/memory) in the context of a running test.

### Skyramp Automated Software Testing

Generative artificial intelligence (AI) can now produce code in an instant. Tools like GitHub Copilot and Cursor promise to boost productivity while reducing the strain on developers. However, when code is being written faster than ever (often by AI), ensuring its quality and correctness becomes a huge challenge. In fact, a recent survey of software engineering leaders found that more than half observed AI coding tools introducing deployment errors at least half of the time. The same survey showed two-thirds of developers now spend more time debugging AI-generated code and spending more time fixing AI-related security issues that are introduced. Ironically, the AI that was supposed to save developer effort can end up creating more work.

Therefore, while AI can generate code quickly, but without proper context or testing, it can also generate bugs and vulnerabilities just as quickly. A very strong majority of engineers in the survey said AI tools have increased the “blast radius” of bad code that needs debugging. This is happening because AI code tools lack awareness of the specific architecture and environment in which the code operates. When AI suggests code that compiles but does not fit corresponding APIs, data models, or infrastructure, developers are left with the task of determining a solution. Debugging the code of another developer is hard enough but debugging code written by AI is close to impossible. Automated tests could detect these issues. Consequently, there is a need for a tool configured to better integrate AI into developer workflows by generating tests to ensure quality and correctness of the AI-generated code.

Skyramp as described in detail herein comprises a suite configured to fully automate software testing by automatically generating reliable tests to avoid production failures. Skyramp includes an AI-driven testing platform as described in detail herein configured to automatically generate functional and performance tests in seconds, covering everything from API endpoints to full user flows. By leveraging a blend of AI and proprietary scaffolding, Skyramp deterministically produces real, runnable tests that work out-of-the-box without a cloud being required. This local-first approach keeps code secure and ensures every test is consistent and trustworthy. It seamlessly supports the languages, frameworks, and tools already in use by integrating into CI/CD pipelines with zero friction. Skyramp therefore lets developer teams validate even complex microservices systems in a fraction of the time.

More particularly, Skyramp is configured to combine AI and proprietary scaffolding to understand application behavior and environment and automatically produce reliable deterministic, functional tests capable of being plugged directly into the CI pipeline or run before every code deploy. Skyramp of embodiments described herein includes Skyramp CLI, an AI-driven a command-line tool configured to automatically generate comprehensive functional and performance tests with a single command. Skyramp further comprises a Skyramp agent, also referred to herein as the agent, that is an autonomous quality assurance engine. The agent is configured to integrate seamlessly with tools already in use by developers and function as an AI quality assurance assistant handling all code testing in parallel: generating test cases, deploying them to the target environment, and validating results. The Agent thus makes the test generation, deployment, and validation process completely hands-off for developers. In short, Skyramp integrates AI configured to test code with AI that writes code to enable an autonomous code development flow.

Skyramp is configured to provide full-stack coverage by automatically exercising and testing every layer of a target application from backend services and databases to APIs and even UI flows, and load testing. Skyramp supports tests including at least integration tests, contract compliance tests, fuzzing for edge cases, and load/stress tests, thereby providing broad coverage all in one platform as described in detail herein. Therefore, instead of juggling separate tools for API testing, UI testing, load testing, and more, Skyramp unifies these capabilities to handle every critical test type, reducing tool sprawl and ensuring all parts of your application are validated together.

Skyramp includes an intelligent engine configured to enable developers to rapidly generate complex test scenarios without writing tedious boilerplate code. It is configured for cloud-native and microservice environments such that regardless of whether a developer is running on Kubernetes, Docker Compose, or any stack, it understands service interactions and external dependencies and can test complex workflows that other tools miss. All that is needed is to simply describe a scenario, record user interactions, or point Skyramp at a target application (or API specs) and it automatically generates a full test suite configured to run. Skyramp immediately provides reliable, modular tests that are easy to understand, maintain, and extend. Unlike generic AI code generators that might give different results on each run, Skyramp test generation is deterministic and runs entirely on a local client machine and produces standard test code that reside in the developer codebase. Thus, unlike cloud or LLM-based tools that can be unpredictable, Skyramp delivers the consistent repeatable tests every run. No cloud dependency means sensitive code and data never leave the developer environment. The deterministic generation capabilities of Skyramp ensure that the generated test will work out of the box and take care of all details (e.g., chaining of variables across requests).

Skyramp is configured for use with the tools in use by developers (e.g., JUnit, Pytest, Playwright, etc.). Tests are generated in a preferred language (e.g., Python, Java, TypeScript, etc.) and follow familiar patterns, so they seamlessly slot into existing developer test suites and CI/CD workflows.

Skyramp of embodiments described herein comprises self-maintaining tests by eliminating the need to constantly rewrite tests after minor changes. Further, it automatically updates tests by adjusting locators or response/request values when an application changes. The deterministic generation allows for clear, incremental differences that ensure developers know exactly what changed, making it easy to distinguish real failures from expected updates. Test suites thus remain current and stable with minimal effort.

Skyramp is aware of the developer infrastructure and dependencies and is configured to provide instant, infra-aware execution by enabling the running of tests instantly without worrying about external dependencies or environment setup. It can also hook into specs like OpenAPI or gRPC schemas and auto-mock external services, thereby eliminating uncertain tests caused by missing dependencies. In so doing, Skyramp automatically mocks external services as needed and handles routing requests to the right endpoints as the test environment changes, allowing tests to execute reliably out of the box. Tests are easily adapted for local development or CI/CD pipelines with a single parameter, ensuring consistent and seamless testing from your laptop to Kubernetes clusters in the cloud. Further, as the system under development evolves, it can regenerate tests at the click of a button, ensuring the test suite stays current with the corresponding codebase with minimal effort.

### Agentic Experience Level

Skyramp provides developers all the tools they need to generate and execute comprehensive functional tests directly in their development environments. Accessible via command line or through agentic IDEs, the solution is based on a comprehensive framework combining AI and proprietary scaffolding to deterministically generate tests that work out of the box.

The Skyramp platform of embodiments described herein comprises an Agentic Experience Layer, also referred to herein as the “agentic layer” or “agentic component”, configured to auto-generate and maintain regression tests across UI, API, integration, and end-to-end layers, in the scope of a pull request (PR). Skyramp with the agentic layer is configured to perform automated regression testing including running a defined set of tests against every code change to verify that previously working functionality continues to work. This automated testing is configured to identify integration failures, unexpected side effects, and dependency breakage before they reach production but is not so limited.

Skyramp automates functional and performance test generation across multiple programming languages and testing frameworks. Skyramp is accessible as a Command Line Interface (CLI) tool, an agent, or a Model Context Protocol (MCP) server as described herein but is not so limited. The quickest way to access and use Skyramp is to install the CLI which provides access to core test generation and trace collection functionality.

The Skyramp Agent brings powerful automated testing capabilities directly into an IDE. The agent is configured to generate and execute integration, contract, smoke, fuzz, load, E2E, and UI tests with AI assistance, without ever leaving the development flow.

The agentic layer comprises or couples to a component referred to herein as “testbot” configured to automatically recommend, generate, validate, and maintain AI-powered regression tests for every pull request so that development can accelerate without sacrificing reliability. Testbot functions as an AI-powered quality assurance (QA) and testing assistant that operates within the code editor (e.g., VS Code or Cursor) to automatically generate, maintain, and execute comprehensive test suites, thereby functioning as an intelligent personal QA engineer, bringing “vibe testing” to developer workflows. When code changes manifest testbot analyzes the differences, identifies which existing tests are impacted, self-heals brittle locators and outdated assertions, and runs the relevant suite to surface real regressions instead of flaky noise. New behaviors get coverage automatically, deprecated paths get pruned, and the test suite stays in lockstep with the product instead of degrading over time.

The Skyramp platform automatically generates regression tests from API specifications and application traces, producing test suites that assert against contracts and behavior rather than implementations. The platform comprises a deterministic execution engine configured to ensure that regression tests produce consistent results across environments. A regression test that passes in continuous integration (CI) and fails in production because of environment variability is not a viable regression test. The Skyramp isolation model eliminates this category of failure.

A regression is a code change that breaks something that was previously working. The change itself may be correct: the bug that was fixed is fixed, the added feature works, and the refactor compiles cleanly. But somewhere else in the system, behavior that used to work no longer works correctly.

The categories of regressions tested by the Skyramp platform include but are not limited to behavioral regressions, performance regressions, integration regressions, and security regressions. Behavioral regressions occur when the API endpoint returns a different response shape than it previously returned. The function that previously returned a sorted list now returns an unsorted list. These are changes to observable behavior that may or may not be intentional, and a regression suite should surface them for explicit decision.

Performance regressions are evidenced for example when a query that ran in 50 milliseconds now runs in 800 milliseconds because an index was dropped or a new code path introduced an N+1 query. Performance regressions are rarely caught by functional tests but frequently matter more to users than functional bugs.

Integration regressions occur when a contract service A has with service B has changed in a way that breaks the assumptions of service B. This is the category commonly missed by unit tests and effectively caught by specification-based or trace-based functional testing.

Security regressions involve an authentication check that was present in a first version accidentally being removed during a refactor of a second version. A rate limiting implementation that worked correctly was bypassed by a new API path.

The Skyramp automated regression suite architecture for regression testing in continuous integration and continuous delivery/deployment (CI/CD) is configured to run the full unit test suite plus the integration-level regression tests on every pull-request (PR) in order to complete testing before code review and to be comprehensive enough to catch the regressions missed by unit tests. Skyramp is further configured, on every merge to main, to run the complete regression suite including end-to-end tests. This is the final gate before deployment. Skyramp is also configured to run regression tests against production or staging on a regular schedule to catch regressions introduced by external changes (dependency updates, infrastructure changes, third-party API behavior changes) that are not triggered by code commits.

The Skyramp platform is configured to manage automated regression test suites at scale. Skyramp audits tests that have never failed instead of automatically deleting those tests. A test that has never produced a failing result may be redundant, may be testing something that does not matter, or may be guarding critical, stable code. The former two categories are safe to remove; the third is where the suite earns its keep. Skyramp “reviews” test suites with judgment rather than a simple retention rule: checks whether another test covers the same behavior, whether the code path is still exercised in production, and whether the cost of a silent regression would be catastrophic. In this way, the platform deletes redundant tests and retains the vigilant.

Skyramp is configured to update tests when contracts change intentionally. When a behavioral change is intentional (a response field is renamed, a default is changed, an error code is updated) the corresponding regression tests are immediately updated. In this way failing tests are not left as background noise.

The platform tracks regression coverage as a product of risk. Every production incident that was not caught by automated testing is a regression test gap. These gaps are tracked explicitly and closed to maintain a regression suite that validates every production bug category from recent years.

Skyramp generates regression tests based on user behavior. Application traces from production or staging environments are used as a source of regression test cases because they capture real behavior under real conditions. This can also help identify the critical user flows to target for slower end-to-end regression tests.

Skyramp positions AI as an intelligent orchestrator in a three-way collaboration between the human, a large language model, and a comprehensive suite of deterministic testing tools. The platform is configured to include deterministic tools that provide structure and reliability by defining clear specifications, required inputs and optional parameters: API schemas, authentication methods, endpoint URLs, expected behaviors. This provides necessary guardrails for AI behavior. The LLM analyzes code patterns, maps dependencies, facilitates communication, and translates user requirements into tool specifications, thereby providing autonomous analytical and investigative capabilities. The human guides priorities, validates assumptions, and ensures tests align with real-world usage and business goals.

Central to this schema is the Skyramp agentic layer and core library described in detail herein and providing deterministic capabilities configured to deliver reliability in test generation and execution. The Skyramp system is configured to create tests from explicit specifications, schemas, and traces using proven algorithms where the same inputs always produce the same tests, making version control meaningful and debugging straightforward. The system implements strict typing and constraint patterns that channel AI creativity through validated interfaces. These constraints do not limit capability and they ensure that tests generated are well-formed and valid.

The system operates to perform trace collection by capturing full-stack, real application behavior that represents how the application under test operates across user interactions, API calls, service communications, and data flows. Synchronized frontend and backend traces help address application behavior uncertainty from dynamic elements, async calls, and timing issues.

Skyramp is configured to include containerized execution by running tests in completely isolated containerized environments where dependencies are locked, state is reset between runs, and results are reproducible. Locked dependency versions ensure test frameworks and libraries remain constant across executions. Isolated environments prevent environment, state contamination and enable parallel, interference-free test execution.

The Skyramp agentic layer is configured to automatically create, manage, and execute comprehensive test suites through natural language conversations in your development environment. The platform makes enterprise-grade testing accessible through a user-friendly interface that is already part of most developers' workflows: AI collaboration in coding assistants and agentic integrated development environments (IDEs).

The agentic layer transforms interactions with a testing infrastructure. When describing testing needs, it automatically maps those requirements to deterministic tools from the Skyramp core library. Each deterministic tool has specific input needs, and the orchestrator fulfills these using the artifacts and patterns it discovers by analyzing the developer repository and based on reasonable inferences from codebase context. If it is unable to identify any inputs or parameters with certainty, it queries the user to clarify requirements and provide any missing information.

Beyond facilitating test creation, the agentic layer generates maintainable test code with proper modularization and reuse, recommends test types based on actual architecture and codebase analysis, and keeps tests current through automated maintenance as an application evolves. This intelligence enhances efficiency without sacrificing the deterministic reliability that testing requires.

The agentic layer comprises a test recommendation system and test maintenance system. The test recommendation system is configured for comprehensive repository analysis. It examines the project structure of a target project or application to understand whether it includes a REST API, full-stack application, or microservices system. The system then inventories the technology stack because framework choices influence what testing approaches work best. The system discovers artifacts like OpenAPI specifications and trace files that enable specific test generation types. Further, it analyzes authentication mechanisms, evaluates infrastructure configuration, and assesses existing test coverage to identify gaps. The result is actionable recommendations with specific test scenarios grounded in the actual code.

Test suites tend to decay over time as applications evolve. Tests break as APIs and codebases change. Accumulated failures cause developers to lose confidence and effectively abandon automated testing. The test maintenance system addresses this by treating tests as living code requiring regular attention. The system discovers Skyramp-generated tests in the developer repository, performs drift analysis comparing current code against the baseline that shaped original tests, executes tests to verify actual behavior, and automatically updates tests for manageable changes while providing detailed recommendations for complex breaking changes.

More particularly, the agentic layer acts as an intelligence layer over a core library which is configured to deliver deterministic capabilities for trace collection, test generation, mocking, and sandboxed test execution. The core library functions are encapsulated as agentic tools and made available to coding assistants and agentic IDEs. When a developer asks a question or describes a testing need in natural language, the agentic layer interprets the test type, design, and inputs required based on environmental context and user prompts and determines the core library functions required and the agentic tool calls and sequence needed to address your needs. The agentic layer additionally parses input data from natural language conversations and maps these to attributes in the core library function call and prompts the user to provide any missing parameters or to clarify scenarios, as needed. The layer provides step-by-step assistance for trace collection, test creation, and execution and gives developers access to a completely isolated test execution environment with all required dependencies automatically configured.

The agentic layer provides additional capabilities on top of the Skyramp core library by defining LLM-based tools for code optimization and test management. While deterministic tools provide the guardrails necessary for effective software testing, LLM-based tools leverage the full power of large language models to analyze your code repository, provide test recommendations, and automatically keep a test suite current. These tools add the contextual intelligence and adaptability required by the agentic layer to handle complex scenarios. These tools are configured to identify opportunities for code modularization and reuse to create test suites that are optimized for readability and maintenance. They also analyze a corresponding developer code repository to evaluate the technology stack, deployment strategy, CI/CD requirements and test coverage gaps. The LLM-based tools recommend tests that will deliver the highest value and impact based on environmental context and user preferences. Further, these tools convert natural language descriptions of test scenarios into specifications based on application and repository analysis for deterministic test generation. The tools maintain a test suite by automatically identifying outdated tests and applies corrective measures.

### MCP Server

Skyramp comprises a Model Context Protocol (MCP) server configured to provide powerful automated testing capabilities directly into agentic IDEs by generating and executing integration, contract, smoke, fuzz, load, E2E, and UI tests with AI assistance through natural language commands, without ever leaving the development flow. The MCP server is configured to include a native workflow for collecting traces that power reliable test generation. By working from traces, Skyramp ensures tests are built on real-world behavior, not assumptions, resulting in resilient tests that accurately mirror user flows and backend interactions. A trace is simply a log of user actions and system behavior captured during a test scenario. Skyramp operates as a man-in-the-middle proxy, capturing both UI activity and network traffic. It collects data from network traffic through the CLI, network traffic from the browser, and UI traces through an automation library recorder (e.g., Playwright, etc.). The Skyramp test generation engine then correlates these trace files to automatically produce high-fidelity test cases.

With the trace files collected, a developer can simply ask the MCP server to generate a test. In response to this request, Skyramp leverages the “playwright-ui-test.zip” and generates the test file (ui_test.spec.ts). Skyramp automatically modularizes and parameterizes the code for readability and reuse, and resolves reference errors, undefined variables, and potential runtime issues. Skyramp produces test code with smart selectors and intelligent waits that can be run immediately. Skyramp is configured to control details including but not limited to adjusting the specified language to another supported language, adjusting the specified framework to another supported framework for the selected test language, specifying the test file name (e.g., . . . and save the file as skyramp_test.spec.ts), specifying the output directory for the test file (e.g., . . . and save the file to the/tests folder), and specifying the trace file you want to leverage for the test generation (e.g., . . . and use the skyramp_playwright.zip as trace).

The UI test can now be run locally in response to an execution command using, for example, Playwright. Skyramp is configured to run the test in a visible browser so you can confirm the scenario step-by-step, printing a line for each test that is being run and listing all failures at the end but is not so limited.

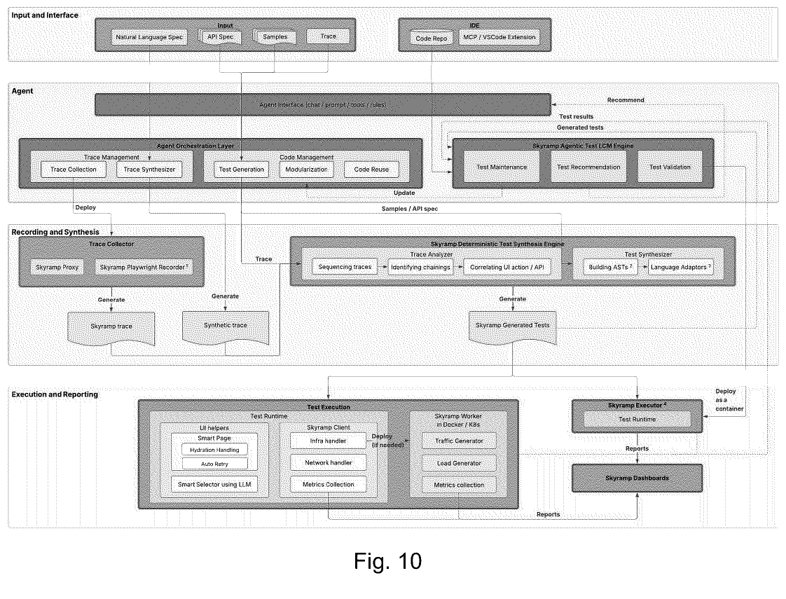

FIG. 10 is a block diagram of the Skyramp architecture comprising an MCP server, under an embodiment. The Skyramp MCP server brings powerful automated testing capabilities directly into agentic IDEs. The MCP server is configured to generate and execute integration, contract, smoke, fuzz, load, E2E, and UI tests with AI assistance through natural language commands, without ever leaving the development flow.

The MCP server architecture comprises an input and interface component, agent component, recording and synthesis component, and execution and reporting component as described in detail herein. The agent component includes but is not limited to an agent interface, agent orchestration layer, and agentic test lifecycle management (LCM) engine. The agent orchestration layer includes trace management and code management components. The trace management component includes trace collection and trace synthesizer components, and the code management component includes test generation, modularization, and code reuse components. The agentic test LCM engine or component includes test maintenance, test recommendation, and test validation components. An output of the test recommendation component is coupled as an input to the agent interface.

The recording and synthesis component includes a trace collector component and a deterministic test synthesis engine or component. The trace collector, which includes a proxy component and a Playwright recorder, is coupled to receive an input from the trace collection component of the agent orchestration layer and to output generated traces. The Skyramp Playwright recorder extends native Playwright capabilities for complex UI patterns, including DOM scoping, coordinate-based drawing/erasure, structural table cell selection, area selection, file upload detection, and picture snapshot.

The deterministic test synthesis engine includes trace analyzer and test synthesizer components. The trace analyzer component, which receives as inputs an output from the test generator of the code management component and a synthetic trace generated by the trace synthesizer of the trace management component, operates to sequence traces, identify chainings, and correlate UI actions/API.

The test synthesizer component of the deterministic test synthesis engine receives an input comprising samples/API specification information from the test generator of the code management component. The test synthesizer includes a component to build abstract syntax trees (ASTs) and a language adaptor component. Regarding the ASTs, Skyramp of embodiments supports smoke, contract, fuzz, integration, UI, E2E, and load tests as described in detail herein. Regarding the language adaptor, Skyramp supports languages including Python/Pytest, Python/Robot, Javascript/Playwright, Typescript/Playwright, and Java/Junit for example. The test synthesizer generates an output comprising generated tests that is coupled as an input to both the agentic test LCM engine of the agent component and the test execution and executor components of the execution and reporting component.

The execution and reporting component or layer includes test execution, executor, and dashboard components. Skyramp generated tests are coupled as an input to both the test execution and executor components of the execution and reporting component. The executor is also coupled to receive an input from the agentic test LCM engine of the agent layer. The Skyramp executor uses containerized execution environments to eliminate dependency conflicts in a local developer environment but is not so limited.

The test execution component includes a test runtime component and a Skyramp worker component (in Docker/K8s). An output of the test execution component comprises test results and is coupled as an input to the agentic test LCM engine.

The test runtime component includes a UI helper component and Skyramp client. Outputs of the Skyramp executor as well as both the Skyramp client and worker include reports and are coupled as inputs to the dashboard.

### Agent

Skyramp of embodiments herein includes an agent configured to provide automated testing capabilities directly in the IDE by generating and executing integration, contract, smoke, fuzz, load, E2E, and UI tests with AI assistance without ever leaving the development flow. The agent is configured to generate end-to-end (E2E) tests as described in detail herein using the Skyramp Extension in VSCode. An E2E test validates an application's entire workflow from start to finish, combining front-end interactions and back-end operations in a single test, to ensure all integrated components work together seamlessly.

Skyramp comprises a native workflow for collecting traces for E2E testing that power reliable test generation. By working from traces, Skyramp ensures tests are built on real-world behavior, not assumptions, resulting in resilient tests that accurately mirror user flows and backend interactions. Skyramp performs trace collection for E2E testing as described in detail herein.

The test generation engine then correlates the collected trace files to automatically generate high-fidelity test cases. Skyramp leverages “skyramp_playwright.zip” and “skyramp-traces.json” and generates a test file (e2e_test.spec.ts) and automatically modularizes and parameterizes the code for readability and reuse. Skyramp resolves reference errors, undefined variables, and potential runtime issues and produces test code with smart selectors and intelligent waits that can be run immediately. Skyramp test generation is configured to control details including but not limited to adjusting the specified language to another supported language and adjusting the specified framework to another supported framework for the selected test language. Skyramp specifies the test file name (e.g., . . . and save the file as skyramp_test.spec.ts), the output directory for the test file (e.g., . . . and save the file to the/tests folder), and two trace files the developer wants to leverage for the test generation (e.g., . . . and use skyramp-traces.json and skyramp_playwright.zip as the trace inputs). The key of an authentication header is specified (e.g., and use the X-API-KEY as the authentication header) as are the endpoints to be included in the test generation. (e.g., . . . and include only https://demoshop.skyramp.dev/* for this test). Skyramp further specifies endpoints to be excluded from the test generation (e.g., . . . and exclude demoshop.skyramp.dev/api/v1/products/* from the test).

The E2E test can now be run in response to an execution command using, for example, Playwright. Skyramp is configured to run the test in a visible browser so you can confirm the scenario step-by-step, printing a line for each test that is being run and listing all failures at the end but is not so limited.

The E2E can be executed locally but is not so limited. In executing the test locally, smart selector capabilities can be enabled that automatically update flaky selectors at runtime using the LLM API, which is exported as API KEY as an environment variable. When executing the E2E test using Skyramp executor which handles all dependencies and executes the test in a containerized environment, an API key can be set using environment variables but embodiments are not so limited.

### Agentic Tools

Skyramp comprises agentic tools to provide a comprehensive suite of capabilities configured to be consumed by AI agents and MCP implementations. These tools enable intelligent automation of test generation, execution, and optimization workflows through natural language interactions. Skyramp agentic tools fall into two primary categories based on their implementation approach, deterministic core library-based tools and LLM-based tools as described in detail herein.

The deterministic core library-based tools provide an interface to Skyramp core library functions to generate tests through deterministic algorithms and rule-based logic. They are configured to systematically analyze structured inputs such as API specifications, trace files, and configuration parameters, then applying predefined transformation rules to produce reliable, predictable test outputs. The configuration centers on consistency and reproducibility such that given the same inputs, these tools will generate identical or functionally equivalent tests every time. This deterministic approach ensures that test generation follows explicit, traceable logic paths, making the process transparent and debuggable.

These deterministic core library-based tools are purpose-built for structured testing scenarios where specifications and contracts are well-defined. They transform formal documentation (like OpenAPI schemas) into executable test code, convert captured application traces into test scenarios, and generate tests that validate against explicit contracts and specifications. The core library implements sophisticated parsing and code generation algorithms that understand API structures, HTTP protocols, and testing framework conventions, enabling the creation of production-ready test code without requiring manual intervention or interpretation.

The LLM-based tools use Large Language Models to provide intelligent analysis, management, and optimization capabilities for testing workflows. They function by processing unstructured or semi-structured inputs, such as existing codebases, test files, code changes, or natural language descriptions, and using AI reasoning to understand context, identify patterns, and make strategic decisions. The configuration emphasizes adaptability and contextual awareness, allowing the tools to understand code semantics, infer relationships between components, and provide intelligent recommendations even when information is incomplete or ambiguous.

The LLM-based tools are purpose-built for analysis and management scenarios requiring deep contextual understanding, pattern recognition, and intelligent decision-making. They are configured to analyze codebases to understand architecture and testing readiness, evaluate priority of different test types based on codebase characteristics, generate actionable recommendations with ready-to-use commands, identify opportunities for code reuse and optimization across test files, and intelligently determine which tests are relevant to specific code changes. The LLM component enables semantic understanding of code relationships, intelligent matching of similar functionality across files, and the ability to adapt recommendations and optimizations based on existing codebase patterns and conventions.

The deterministic core library-based tools and LLM-based tools are configured to work autonomously or in combination, creating a comprehensive testing ecosystem. Deterministic tools provide the foundation for reliable, specification-driven test generation and execution, while LLM-based tools add intelligence for analysis, management, and optimization. Together, they enable agents to analyze codebases to understand testing needs, evaluate priority and recommend optimal test strategies, generate tests from various sources using deterministic tools, execute and validate tests across different environments, optimize test suites through intelligent code reuse and modularization, and provide continuous feedback and improvement suggestions based on code changes and test results.

### Test Generation Tools

Tool categories of embodiments include test generation tools comprising a generate contract test tool, a generate integration test tool, a generate smoke test tool, a generate fuzz test tool, a generate load test tool, a generate UI test tool, a generate E2E test tool, and a generate scenario test tool. The test generation tools form the core of Skyramp testing capabilities, enabling automated creation of various test types from different sources including API specifications, captured traces, and natural language descriptions.

### Test Generation Tools—Generate Contract Test Tool

The generate contract test tool generates contract tests that verify API implementations match their OpenAPI or Swagger specifications and is used for validating API responses against schema definitions, ensuring request and response contracts are maintained, and catching breaking changes in API implementations. The tool uses an API schema file and endpoint configuration including the base URL and HTTP method. A developer can provide sample request and response data to validate against, configure assertion options for body values, and specify path parameters, query parameters, or form parameters as needed. The tool supports authorization headers for authenticated endpoints and allows SSL verification to be skipped for testing environments. It further enables selection of a target language and testing framework, and configure the runtime environment as local, Docker, or Kubernetes.

### Test Generation Tools—Generate Integration Test Tool

The generate integration test tool generates integration tests that chain multiple API calls together, using responses from one request as inputs to subsequent requests. This tool is also useful for testing complete workflows like create-read-update-delete sequences, validating data consistency across multiple endpoints, and testing complex business processes involving multiple API calls. This tool accepts all the same parameters as contract test generation but adds powerful chaining capabilities through a ‘chainingKey’ parameter, which specifies the JSON path for extracting values from responses to use in subsequent requests. It can optionally work from backend trace files to automatically generate chained test sequences. The tool supports code reuse from existing test files to avoid duplication and can create modularized, parameterized test functions for better maintainability.

### Test Generation Tools—Generate Smoke Test Tool

The generate smoke test tool generates lightweight smoke tests for quick health checks and basic API validation. Smoke tests are used for verifying API availability and basic functionality, running quick regression tests after deployments, and integrating into CI/CD pipelines for fast feedback. The tool uses a similar configuration to contract tests but is optimized for speed and simplicity. It focuses primarily on status code validation and basic response structure checking, with minimal assertion complexity to enable faster execution. These tests serve as a first line of defense to quickly identify if critical API endpoints are functioning.

### Test Generation Tools—Generate Fuzz Test Tool

The generate fuzz test tool generates fuzz tests that send malformed, unexpected, or edge-case inputs to discover security vulnerabilities and robustness issues. Fuzz testing is essential for security testing and vulnerability discovery, input validation testing, and exploring edge cases and boundary conditions. This tool automatically generates various types of malformed inputs including invalid data types, boundary values, special characters, and malformed JSON structures. It tests how the API handles unexpected inputs and helps identify potential security vulnerabilities or crash conditions. The tool shares configuration parameters with contract test generation but focuses on generating diverse input variations to stress-test the API error handling functionality.

### Test Generation Tools—Generate Load Test Tool

The generate load test tool generates load and performance tests to validate API behavior under various traffic conditions. Load testing is crucial for performance benchmarking, capacity planning, stress testing, and bottleneck identification. In addition to standard endpoint configuration, this tool uses load-specific parameters including test duration, number of concurrent threads, target requests per second, and ramp-up configuration. It enables specification of how quickly the load should increase to target levels through ramp-up duration and interval settings. The tool can execute the load test multiple times for statistical reliability. Load tests help a developer understand how an API performs under realistic traffic conditions and identify performance degradation points.

### Test Generation Tools—Generate UI Test Tool

The generate UI test tool generates UI tests from captured traces, converting user interactions into automated test scripts. This tool is used for automating repetitive UI testing, creating regression tests from manual testing sessions, and documenting user workflows as executable tests. The tool uses a frontend trace file captured during user interactions. It enables specification of a target language and testing framework, enables code reuse to leverage existing test functions, and enables modularization to create parameterized, reusable test components. The tool analyzes the trace to extract selectors, user interactions, and navigation patterns, then generates idiomatic test code that accurately reproduces the recorded behavior while optimizing for maintainability and readability.

### Test Generation Tools—Generate E2E Test Tool

The generate E2E test tool generates comprehensive end-to-end tests that validate entire user journeys from UI interactions through backend services. E2E tests are essential for full application flow testing, integration of frontend and backend validation, and ensuring critical business workflows function correctly across all layers. This tool uses both a frontend trace and a backend trace file to capture the complete application behavior. It supports authorization headers for backend API calls and can enable code reuse and modularization for better test organization. The tool intelligently combines UI interactions with backend validations, ensuring that user actions produce the expected effects both in the interface and in the underlying data and services. This provides the most comprehensive testing approach for validating complete user experiences.

The Skyramp generate scenario tool generates test scenarios from natural language descriptions, automatically mapping them to API calls using OpenAPI specifications. It is used for rapid test creation from requirements, enabling business analysts to describe tests in plain language, and supporting exploratory testing automation. This tool requires a short, descriptive scenario name and a natural language prompt describing what is wanted to be tested. An OpenAPI schema (as a file path or URL) is provided and the destination host is specified. The AI parses the description to determine the appropriate HTTP method, API path, request body, expected response, and status code. Optionally a base URL can be provided if not specified in the schema. The tool translates business requirements into technical test implementations without requiring detailed API knowledge.

### Trace Collection Tools

Tool categories of embodiments include trace collection tools comprising a start trace collection tool and a stop trace collection tool. The trace collection tools are configured to enable capturing of real application behavior, which can then be used to generate accurate and realistic tests. These tools capture both frontend user interactions (e.g., through Playwright) and backend API calls, creating a complete picture of application behavior that can be transformed into automated tests.

### Trace Collection Tools—Start Trace Collection Tool

The start trace collection tool initiates trace collection for capturing user interactions and backend API calls and is used for recording user sessions that can be converted into tests, capturing production-like behavior patterns, and documenting complex workflows for automation. For authenticated applications, a path can be provided to saved session storage to avoid manual login during each trace collection.

The tool enables specification of browser viewport size to match that of a target device or resolution, supporting presets like HD, Full HD, 2K, or custom dimensions. For backend tracing, workers can be deployed (e.g., in Docker) or Kubernetes environments, specifying network configuration and port settings. Service-level filtering through include and exclude parameters lets developers focus traces on specific components of your application.

### Trace Collection Tools—Stop Trace Collection Tool

The stop trace collection tool stops trace collection and saves captured traces to specified files. It is used to complete trace recording session, save traces for subsequent test generation, and export traces for analysis or sharing. When stopping collection, output filenames can be provided for both the trace (e.g., a ZIP file) and the backend trace (e.g., a JSON file). An output directory can be specified for organized storage and provide the worker container name for proper cleanup of trace collection infrastructure. This tool ensures all collected data is properly saved and trace collection resources are cleaned up.

### Analysis and Optimization Tools

Skyramp of embodiments includes analysis and optimization tools configured to help understand codebases, recommend testing strategies, and improve test quality through code reuse and modularization. The analysis and optimization tools include but are not limited to an analyze repository tool, a map tests tool, a recommend tests tool, a code reuse tool, and a code modularization tool.

### Analysis and Optimization Tools—Analyze Repository Tool

The analyze repository tool analyzes a code repository to understand its structure, technology stack, and testing readiness and is used for quickly understanding new codebases, assessing current testing readiness, and identifying testing opportunities across the application. The absolute path to the repository you want to analyze is provided, and a selection is made between a quick scan for rapid feedback or a full comprehensive analysis for detailed insights. Optionally, focus areas can be specified like ‘api’, ‘frontend’, or ‘infrastructure’ to concentrate the analysis on specific aspects of your codebase. The tool identifies the technology stack including languages, frameworks, and libraries and discovers API endpoints, detects frontend frameworks, identifies database and infrastructure components, and assesses existing test coverage. The analysis includes documentation quality assessment and provides a testing readiness score with recommendations for improvement.

### Analysis and Optimization Tools—Map Tests Tool

The map tests tool calculates priority scores for different Skyramp test types based on repository analysis. It assists developers in prioritizing testing efforts, identifying the most valuable tests to implement first, and optimizing the overall testing strategy based on specific application characteristics.

The tool takes the analysis report from ‘skyramp_analyze_repository’ and evaluates how well each test type aligns with your codebase. Custom weight multipliers can be provided to emphasize certain test types based on your priorities or focus the evaluation on specific test types if you're only interested in a subset. The scoring considers technology stack compatibility, API surface area, code complexity metrics, risk assessment, and return on investment potential. The output provides priority scores for each applicable test type along with clear rationale explaining why certain tests scored higher. It recommends an optimal order for implementing different test types based on specific application needs.

### Analysis and Optimization Tools—Recommend Tests Tool

The recommend tests tool generates actionable test recommendations with ready-to-use generation prompts. It provides specific, implementable guidance for creating a test suite, helping bootstrap test creation with clear next steps. The tool takes both the priority scores from test mapping and the original repository analysis to create comprehensive recommendations. It enables specification of a number of recommendations a developer wants and sets a minimum score threshold to filter out low-priority suggestions. Each recommendation includes a rank, ready-to-use generation commands with all necessary parameters filled in, clear rationale explaining why this test is recommended, and implementation guidance for getting started.

### Analysis and Optimization Tools—Code Reuse Tool

The code reuse tool finds and reuses existing test functions from the workspace to avoid code duplication. It is used for maintaining DRY (Don't Repeat Yourself) principles in a test suite, improving test maintainability by centralizing common functionality, and reducing overall code duplication across test files. The path is provided to a test file that needs code reuse optimization. The tool scans the workspace for existing test files (looking for Skyramp-generated tests by default), identifies reusable functions that could benefit the target test file, suggests appropriate imports and function calls, and updates the test file to leverage existing code rather than duplicating functionality. The LLM intelligently matches functionality across test files, understanding semantic similarity even when function names differ. It generates proper import statements, refactors test code to use shared functions, and ensures the updated tests maintain their original behavior while leveraging the reused code.

### Analysis and Optimization Tools—Code Modularization Tool

The code modularization tool modularizes test files after code reuse, creating parameterized and well-organized test functions and is used for improving test organization and structure, creating parameterized test functions that can handle multiple test cases, and enhancing overall test maintainability and readability. The path is provided to a test file that should be modularized. This tool is run after code reuse has been completed to further optimize the test structure but is not so limited. The tool analyzes the test file to identify modularization opportunities, extracts common patterns that can be parameterized, creates reusable functions with clear parameters, and refactors the test file into a more maintainable structure. The LLM understands testing best practices and applies them to restructure your tests. It creates fixtures, helper functions, and parameterized tests where appropriate, while maintaining test clarity and ensuring all test cases remain properly covered.

### Utility Tools

Skyramp further comprises utility tools configured to provide supporting functionality for authentication, API analysis, and other common tasks. The utility tools of embodiments include but are not limited to a read file tool, a login tool, a logout tool, a parse open API tool, an execute test tool, and a verify with Skyramp tool.

### Utility Tools—Read File Tool

The read file tool efficiently reads multiple files in batches for analysis or processing. This tool is used for bulk file analysis, efficient context gathering across multiple files, and processing collections of files in your workspace. An array of file paths (either relative to workspace root or absolute paths) is provided. The tool reads them in configurable batches with specified text encoding (e.g., default UTF-8). This tool includes error handling for individual files so that problems with one file don't prevent reading others. This tool is used when agents need to gather context from multiple files efficiently.

### Utility Tools—Login Tool

The login tool authenticates users with Skyramp services and is used for initial setup and configuration, establishing authenticated sessions, and gaining access to cloud-based Skyramp features. The tool manages secure authentication flow, handles token management for subsequent operations, and persists session information for continued use. Once authenticated, a developer can access premium features, save test results to the cloud, and leverage the Skyramp infrastructure for test execution.

### Utility Tools—Logout Tool

The logout tool logs out from Skyramp services and is used for session cleanup, following security best practices, and switching between different user accounts. The tool invalidates authentication tokens, cleans up session data, and ensures a secure logout process.

Utility Tools—Parse open API Tool

The parse open API tool analyzes OpenAPI specifications to identify required path parameters and other API details. This tool helps a developer understand API requirements before generating tests, validate API specifications for completeness, and extract detailed parameter information including types and constraints. The path to an OpenAPI specification file is provided. Optionally a specific endpoint URL is provided to analyze. The tool extracts required and optional path parameters, identifies parameter types and validation constraints, and provides comprehensive endpoint metadata. This information is particularly useful when preparing to generate tests or when a developer needs to understand API requirements.

### Utility Tools—Execute Test Tool

The execute test tool executes Skyramp-generated tests in the specified environment and is used for running generated tests as part of CI/CD pipelines, validating test functionality during development, and executing comprehensive regression test suites. The path is provided to the test file (either relative to the workspace root or as an absolute path), the test type is specified (integration, contract, smoke, fuzz, load, e2e, or UI), and the programming language of the test is indicated. The workspace path helps locate dependencies and configuration. Tests can be executed in local, Docker, or Kubernetes environments depending on how they were generated and the infrastructure setup.

### Utility Tools—Verify With Skyramp Tool

The verify with Skyramp tool verifies code changes by running appropriate Skyramp tests and is used for pre-commit verification, automating code review validation, and enabling continuous validation during development. The tool automatically identifies which tests are relevant to code changes and executes them to provide quick feedback on code quality. It integrates seamlessly into development workflows to catch issues early, before they reach production or even before commits are finalized thereby enabling a fast feedback loop for developers making changes.

### Skyramp Core Library Capabilities

Skyramp is configured to include the core library as described herein. The core library capabilities of embodiments include smoke tests, contract tests, fuzz tests, integration tests, load tests, UI tests, and E2E tests but are not so limited. These tests are described in detail herein.

### Skyramp Core Library Capabilities—Smoke Test (Specific Method)

Skyramp uses core library capabilities to generate smoke tests. CLI is used to access functionality but the same features can be activated in the agentic experience by including a reference in the natural language prompt. Smoke testing is a preliminary check used to verify that an endpoint is accessible and returns a valid response. Smoke tests are useful for quickly identifying critical defects after significant changes.

Skyramp is configured to generate a smoke test for a specific method of a REST API. To create a smoke test, one of an OpenAPI schema file (JSON/YAML) and sample request data (JSON blob or JSON file) are input. To create a smoke test for a single method, the method and URL to be tested against is specified in the command. The command is configured to specify the URL to the endpoint targeted for testing, the API method to test, the test output language, the test execution framework of choice, and to point to the OpenAPI schema used to generate the test.

The test file anatomy of a smoke test includes key elements of the generated test file, allowing for quick adjustments, if needed. The header of each test file shows when the test was generated and the command used to generate it. The body of the test file imports all relevant libraries and specifies the URL for all test requests. Each method being tested has a function that includes but is not limited to invocation of Skyramp client, definition of the authentication header, definition of the request body, formation of the request, and assertion against expected status code.

The generated smoke test can be generated without any adjustments. However, the smoke test can be tuned using adjustments or additional information. Adjustments include but are not limited to specifying a sample JSON blob to use as the request body, specifying the expected status code, specifying the name of the generated test file, and specifying the directory in which the generated test file is to be stored.

Upon execution, outputs are printed (e.g., Pytest) by printing a line for each test that is being run and listing all failures at the end.

### Skyramp Core Library Capabilities—Smoke Test (All Methods)

Skyramp is configured to generate smoke tests for all methods of an endpoint at once thereby enabling full testing coverage quickly for a given endpoint while ensuring the endpoint baseline functions work as expected. To generate a smoke test for an entire REST API endpoint, the OpenAPI schema (JSON or YAML file) is specified. Skyramp generates test cases for all available methods of the specified endpoint URL and its direct children. If the parent of the specified endpoint has relevant methods, they will also be included in the generated test.

To generate smoke tests for all methods of an endpoint, the endpoint targeted for testing is specified. When testing a service, replace it with the URL to the endpoint targeted for testing. The test generation command does not include any specified API method and instead points to the OpenAPI schema used to generate the test. When paired with an OpenAPI spec, Skyramp will generate tests for all methods of the endpoint, its direct parent (if any), and its direct children. Further, the test output language is specified (e.g, Python, Typescript, Java, etc.) along with the selected test execution framework.

The generated smoke test can be tuned or adjusted using additional flags including but not limited to a flag to specify the expected status code, a flag to specify the name of the generated test file, and a flag to specify the directory in which to store the generated test file.

The generated tests are then executed (e.g., Pytest). The test output prints a line for each test that is being run and lists all failures at the end. In order to ensure that all functions of the smoke test succeed, the product_id path parameter can be updated. Skyramp generates parameterized test code, allowing for quick updating of the value at the top of each function that requires a path parameter.

### Skyramp Core Library Capabilities—Contract Test (Specific Method)

A contract test asserts that inter-application messages conform to a shared understanding that is documented in an API contract. In this context, every contract is between a client (consumer) and a server (provider). The consumer side is interested in making sure that the client can handle an expected response correctly. The provider side is interested in making sure that the server response matches an expected response.

To generate a contract test for a specific method of a REST API endpoint, one of the OpenAPI schema file (JSON or YAML file) and sample request and response data (JSON blob or JSON file) are specified. The command is configured to specify the URL to the endpoint targeted for testing, the API method to test, the test output language, the test execution framework of choice, and to point to the OpenAPI schema used to generate the test.

The test file anatomy of a contract test includes key elements of the generated test file, allowing for quick adjustments, if needed. The header of each test file shows when the test was generated and the command used to generate it. The body of the test file imports all relevant libraries and specifies the URL for all test requests. Each method being tested has a function that includes but is not limited to invocation of Skyramp client, definition of the authentication header, definition of the request body, definition of the expected response body, creation of the request, and generated assertions including a status code assertion, schema check, and body valve checks.

The generated contract test can be generated without any adjustments. However, the test can be tuned using adjustments or additional information. Adjustments include but are not limited to specifying a sample JSON blob to use as the request body, specifying the expected status code, specifying the name of the generated test file, and specifying the directory in which the generated test file is to be stored.

Adjustments also include specifying how many assertions Skyramp should generate on the response body for the contract test. Skyramp evaluates the endpoint to determine what values are expected, and then the test checks to see whether they are returned.

Upon execution, outputs are printed (e.g., Pytest) by printing a line for each test that is being run and listing all failures at the end.

### Skyramp Core Library Capabilities—Contract Test (All Methods)

Skyramp is configured to generate contract tests for all methods of an endpoint at once thereby enabling full testing coverage quickly for a given endpoint while ensuring the endpoint baseline functions work as expected. To generate a smoke test for an entire REST API endpoint, the OpenAPI schema (JSON or YAML file) is specified. Skyramp generates test cases for all available methods of the specified endpoint URL and its direct children. If the parent of the specified endpoint has relevant methods, they will also be included in the generated test.

To generate contract tests for all methods of an endpoint, the endpoint targeted for testing is specified. When testing a service, replace it with the URL to the endpoint targeted for testing. The test generation command does not include any specified API method and instead points to the OpenAPI schema used to generate the test. When paired with an OpenAPI spec, Skyramp will generate tests for all methods of the endpoint, its direct parent (if any), and its direct children. Further, the test output language is specified (e.g, Python, Typescript, Java, etc.) along with the selected test execution framework.

The generated smoke test can be tuned or adjusted using additional flags including but not limited to a flag to specify the expected status code, a flag to specify the name of the generated test file, and a flag to specify the directory in which to store the generated test file. Adjustments also include specifying how many assertions Skyramp should generate on the response body for the contract test. Skyramp evaluates the endpoint to determine what values are expected, and then the test checks to see whether they are returned.

The generated tests are then executed (e.g., Pytest). The test output prints a line for each test that is being run and lists all failures at the end. In order to ensure that all functions of the smoke test succeed, the product_id path parameter can be updated. Skyramp generates parameterized test code, allowing for quick updating of the value at the top of each function that requires a path parameter.

### Skyramp Core Library Capabilities—Fuzz Test (Specific Method)

Fuzz testing (or fuzzing) uncovers bugs and vulnerabilities by injecting random, invalid, or unexpected inputs into an application to reveal edge cases and security flaws that traditional testing often misses, thereby ensuring software remains robust and secure even under unpredictable conditions.

To generate a fuzz test for a specific method of a REST API, one of the OpenAPI schema file (JSON or YAML file) and sample request data (JSON blob or JSON file) are specified. The command is configured to specify the URL to the endpoint targeted for testing, the API method to test, the test output language, the test execution framework selected, and to point to the OpenAPI schema used to generate the test.

The generated fuzz test can be generated without any adjustments. However, the test can be tuned using adjustments or additional information. Adjustments include but are not limited to specifying a sample JSON blob to use as the request body, specifying the key of the authentication header, specifying the expected status code, specifying the name of the generated test file, and specifying the directory in which the generated test file is to be stored.

Upon execution, outputs are printed (e.g., Pytest) by printing a line for each test that is being run and listing all failures at the end.

The test file anatomy of a fuzz test includes key elements of the generated test file, allowing for quick adjustments, if needed. The header of each test file shows when the test was generated and the command used to generate it. The body of the test file imports all relevant libraries and specifies the URL for all test requests. Each method being tested has a function that includes but is not limited to invocation of Skyramp client, definition of the authentication header, definition of the request body (based on API schema or sample data), definition of all fuzzed body values, definition of all expected response status codes for fuzzed body values, definition of all expected response status codes for none body values, loop through all fuzzed values (for each loop, creates a request with the fuzzed body value, creates a request with the fuzzed value being none), and status code assertion.

The generated fuzz test will execute a request with the default body values from the API spec or sample data provided. The test then iterates through each body value, changing the selected body value with a fuzzed value and None while keeping the default values for all other keys. It then asserts the status codes of all requests. This is done at the end of the loop to avoid premature failure that would lead to unnecessary reruns of the test.

### Skyramp Core Library Capabilities—Fuzz Test (All Methods)

Skyramp is also configured to generate fuzz tests for all methods of an endpoint at once thereby enabling full testing coverage quickly for a given endpoint while ensuring the endpoint baseline functions work as expected. To generate a fuzz test for an entire REST API endpoint, the OpenAPI schema (JSON or YAML file) is specified. Skyramp generates test cases for all available methods of the specified endpoint URL and its direct children. If the parent of the specified endpoint has relevant methods, they will also be included in the generated test.

To generate fuzz tests for all methods of an endpoint, the endpoint targeted for testing is specified. When testing a service, replace it with the URL to the endpoint targeted for testing. The test generation command defines the URL to the endpoint targeted for testing. The test generation command does not specify an API method so that when paired with an OpenAPI spec, Skyramp generates tests for all endpoints at the URL, its direct parent (if any), and its direct children. The test generation command also specifies the test output language along with the selected test execution framework. Further, the command points to the OpenAPI schema used to generate the test.

The generated fuzz test can be tuned or adjusted using additional flags including but not limited to a flag to specify the key of the authentication header, a flag to specify the expected status code, a flag to override path parameters from the endpoint URL or the pre-defined values in the API schema, a flag to specify the name of the generated test file, and a flag to specify the directory in which to store the generated test file.

The generated fuzz tests are then executed (e.g., Pytest). The test output prints a line for each test that is being run and lists all failures at the end.

### Skyramp Core Library Capabilities—Integration Test (Specific Endpoint)

Integration testing verifies that different components of a system work together as expected and exposes issues arising from interactions between modules, APIs, or external systems that unit tests might miss. By validating data flow, dependencies, and system behavior, integration testing ensures software functions reliably in real-world environments.

To generate integration tests for REST APIs for all methods of an endpoint, an OpenAPI schema file (JSON or YAML file) is specified. Skyramp generates a test including all available methods of the specified endpoint URL and its direct children. If the parent of the specified endpoint has relevant methods, they will also be included in the generated test.

To create an integration test for an endpoint a command is configured to specify the endpoint targeted for testing, define the URL to the endpoint, specify the test output language, the test execution framework selected, and to point to the OpenAPI schema used to generate the test.

The generated integration test can be used without any adjustments. However, the test can be tuned using adjustments or additional information. Adjustments include but are not limited to flags to specify the environment in which the test is to be run, specify the key of the authentication header, enable override of path parameters from the endpoint URL or the pre-defined values in the API schema, specify the name of the generated test file, and specify the directory in which to store the generated test file.

Upon execution, outputs are printed (e.g., Pytest) by printing a line for each test that is being run and listing all failures at the end.

The test file anatomy of an integration test includes key elements of the generated test file, allowing for quick adjustments, if needed. The header of each test file shows when the test was generated and the command used to generate it. The body of the test file imports all relevant libraries and specifies the URL for all test requests. Each method being tested has a function that includes but is not limited to invocation of Skyramp client, definition of the authentication header, a set of requests executed in sequence (assertion against response status code per request). For tests generated using an OpenAPI spec, Skyramp evaluates the final path segment to identify the resource being tested and generates chained requests for all available methods (e.g., POST, GET, PUT) of that resource such that the test completes a CRUD lifecycle (“create the resource, then update, then delete”).

### Skyramp Core Library Capabilities—Integration Test (Multiple Endpoints)

Skyramp is configured to generate integration tests that span across multiple endpoints or services using trace information to generate the test case reliably. As described herein, a trace is a log of a set of actions executed in a particular window or scenario in your system. Traces can be used to simulate real-world scenarios of product usage, and those traces can in turn be used to generate tests that give you confidence that said scenario will be resilient in production traffic. Skyramp can function as a “Man-in-the-Middle” proxy that monitors traffic and allows developers to simply record the scenario targeted for testing. For integration tests, Skyramp is configured to collect both HTTP traffic from a browser UI and backend traffic through the CLI. In this way developers can collect a trace that can be directly supplied for Skyramp test generation.

Skyramp is configured to generate an integration test from the trace. Unlike other commands, test generation from a trace does not require a specified URL because all relevant information is extracted directly from the trace. The command to generate the test specifies the test output language, specifies the test execution framework of choice, and points to the Skyramp-collected trace used to generate the test.

The generated integration test can be used without any adjustments. However, the test can be tuned using adjustments or additional information. Adjustments include but are not limited to specifying a comma-separated list of URLs for Skyramp to generate requests, specifying a comma-separated list of URLs for which Skyramp is not to generate requests, selecting the test runtime environment (e.g., Local, Docker, Kubernetes), and specifying the name of the generated test file.

Upon execution the test automatically identifies the relevant path parameters, intelligently chains the different requests together, and executes the test against the captured URLs. Test outputs are printed (e.g., Pytest) by printing a line for each test that is being run and listing all failures at the end.

### Skyramp Core Library Capabilities—Load Test (Specific Method)

Load testing assesses system performance by simulating real-world traffic and usage patterns in order to identify bottlenecks, scalability limits, and stability issues by measuring how the software behaves under expected and peak loads. Ensuring a system can handle demand without degradation is key to maintaining reliability and a smooth user experience.

Unlike other types of Skyramp tests, load tests are run asynchronously. This means that all requests are packaged in a scenario, sent to a Skyramp worker component responsible for executing the test, and executed without any individual responses being communicated back to the program runtime.

For load testing scenarios with multiple chained API calls and simulations of high-volume traffic, async test execution enables significantly higher test performance and simulate more realistic load on the system through concurrent requests and defining varying degrees of load on the system.

To generate a load test for a single method of a REST endpoint, one of the OpenAPI schema file (JSON or YAML file) and sample request data (JSON blob or JSON file) are specified. The command is configured to specify the URL to be tested against, the API method to test, the test output language, the test execution framework selected, and to point to the OpenAPI schema used to generate the test.

The generated load test can be generated without any adjustments. However, the test can be tuned using adjustments or additional information. Adjustments include but are not limited to specifying number of times Skyramp executes the defined request, duration of the load test execution in seconds, number of concurrent threads for load test where concurrent threads represent virtual users enabling the testing of the vertical scalability of the service, the duration that Skyramp incrementally increases the requests per second (RPS) until the target RPS are reached, how often Skyramp increases the RPS until target RPS are reached, the maximum RPS of the load test, the name of the generated test file, and the directory to store the generated test file.

Load tests are run using Python directly, which allows us to display more meaningful test results, but they are not so limited. Based on the load configuration, the test will execute as many POST requests as possible against the service within a specified time period, collect failure rates and latency metrics, and validate against the expected response status code. Unlike other types of Skyramp tests, load testing is asynchronous, and every command in the test scenario is executed without waiting for feedback from the program runtime to allow for a more realistic simulation of load on the system. If a load duration rather than a count is provided, the Skyramp worker tries to maximize RPS for the specified load test duration while collecting the latency and failure rate of those requests. The test output shows the overall results and performance of the load test.

The test file anatomy of a load test includes key elements of the generated test file, allowing for quick adjustments, if needed. The header of each test file shows when the test was generated and the command used to generate it. The body of the test file imports all relevant libraries and specifies the URL for all test requests. Below, the load test configuration is generated based on the flags specified in the command. If a trace is used to generate the load test, a single function is generated that includes all API calls in the trace; otherwise a function is generated per method tested. A load test function includes but is not limited to invocation of Skyramp client, definition of the authentication header, creation of a Skyramp scenario to serve as an encapsulation of all relevant requests. Each API function included in the test includes definition of the request body (based on API schema or sample data) and formation of the request that can be executed asynchronously. The load test function further includes collection and print statement of the load test results.

The generated load test will execute as follows. Any requests being tested will be created and added to an AsyncScenario with their expected status code assertion. The scenario will then be sent to a Skyramp worker component for execution (based on the Skyramp client specified) using the load test configuration defined in the generation command. Unlike other Skyramp test types, load testing is asynchronous meaning every request in the test will be executed without waiting for feedback to allow for a more accurate simulation of real-time traffic to a system and therefore a more accurate understanding of the stresses a system could face.

### Skyramp Core Library Capabilities—Load Test (Multiple Endpoints)

Skyramp is configured to generate load tests that span across multiple endpoints or services using trace information to generate the test case reliably. As described herein, a trace is a log of a set of actions executed in a particular window or scenario in your system. Traces can be used to simulate real-world scenarios of product usage, and those traces can in turn be used to generate tests that give you confidence that said scenario will be resilient in production traffic. Skyramp can function as a “Man-in-the-Middle” proxy that monitors traffic and allows developers to simply record the scenario targeted for testing. For integration tests, Skyramp is configured to collect both HTTP traffic from a browser UI and backend traffic through the CLI. In this way developers can collect a trace that can be directly supplied for Skyramp test generation.

Trace collection with Skyramp involves running a command that includes information to specify a comma-separated list of URLs for Skyramp to filter for during trace collection or in a trace file, and the name of the generated trace file.

The generated load test can be used without any adjustments. However, the test can be tuned using adjustments or additional information. Adjustments include but are not limited to specifying a comma-separated list of URLs for which Skyramp is not to filter for, specifying the name (string) of the Docker component network, and specifying a port number for Skyramp.

Skyramp is configured to generate a load test from the trace. Unlike other commands, test generation from a trace does not require a specified URL because all relevant information is extracted directly from the trace. The command to generate the test specifies the test output language, specifies the test execution framework of choice, and points to the Skyramp-collected trace used to generate the test.

The generated load test can be used without any adjustments. However, the test can be tuned using adjustments or additional information. Adjustments include but are not limited to specifying a comma-separated list of URLs for Skyramp to generate requests for, specifying a comma-separated list of URLs for which Skyramp is not to generate requests, selecting the test runtime environment (e.g., Local, Docker, Kubernetes), specifying the name of the generated test file, specifying the number of times Skyramp executes the defined request, specifying duration of the load test execution in seconds, specifying umber of concurrent threads for load test (concurrent threads represent virtual users enabling testing of the vertical scalability of the service), specifying the duration that Skyramp incrementally increases the requests per second (RPS) until the target RPS are reached, specifying how often Skyramp increases the RPS until target RPS are reached, and specifying the maximum RPS of the load test.

Skyramp is configured to generate customized load testing scenarios using the Skyramp worker component and library functions.

### Skyramp Core Library Capabilities—UI Test

A UI test is a test that verifies the visual elements and functionality of an application user interface. A UI test ensures that the UI elements (buttons, text fields, menus, etc.) are displayed correctly, work as expected, and provide a smooth, intuitive user experience. Skyramp uses a trace to generate UI tests. A trace is a log of a set of actions executed in a particular window or scenario in your system. Traces can be used to simulate real-world scenarios of product usage, and those traces can in turn be used to generate tests that give you confidence that said scenario will be resilient in production traffic. Skyramp is configured to collect traffic from UI interactions and collect a trace from the traffic for test generation.

A command is executed to start collecting traces, you need to run the following command. This command spawns a new shell configured to collect all relevant backend network traffic as well as a browser and inspector (e.g., Playwright). The command enables Playwright to capture UI activities and specifies the name of the generated Playwright trace file. Additional flags of the command specify the name (string) of the Skyramp Docker component network and specify a port number for Skyramp. The spawned Playwright Browser is used to collect the traces for the test scenario.

Upon completion of the scenario trace collection is ended in the shell. The endpoints for which Skyramp was able to collect backend traces is shown. Skyramp is configured to create trace files including “ui_test_playwright.zip”, which includes all collected traces from Playwright and will be used for the UI test generation.

Following collection of the traces and execution of the command to generate the UI test, Skyramp creates a fully executable Python test file (ui_test.py) that can be run immediately. Unlike other commands, test generation from a trace does not require a specified URL because all relevant information is extracted directly from the trace. The command to generate the UI test specifies the test output language, specifies the test execution framework of choice, and points to the Playwright trace file to use for test generation.

While Skyramp can execute the generated tests without any additional adjustments to the code, adjustments can be used to tune the UI test. The adjustments include but are not limited to a flag to specify the name of the generated test file and a flag to specify the directory to write the generated test file.

The Skyramp UI test reduces flakiness by automatically detecting flaky selectors and replacing them with more stable alternatives. It also identifies when additional hydration is needed, ensuring your application is fully loaded before the next action runs. This reduces test flakiness and improves overall reliability.

Skyramp also generates resilient UI selectors that adapt to application changes, reducing test maintenance and eliminating false failures caused by fragile CSS or XPath selectors.

Skyramp is configured to automatically add intelligent waiting logic in the test to ensure that a web page fully loads its JavaScript code (a process otherwise known as hydration). These waits lead to less flaky tests since they ensure elements on the page being validated against appear and do not cause the test to timeout.

When a UI test is generated via the Skyramp agentic layer (available via VSCode Extension or MCP Server) described in detail herein, the generated test will be automatically parameterized and modularized to make the test code more readable and allow for potential re-usability of code.

Test outputs are printed (e.g., Pytest) by printing a line for each test that is being run and listing all failures at the end.

The Skyramp generated test is editable and runnable like any other executable file. The key elements of each generated test file include a header which shows when the test was generated and what command was used to generate it. The body of the test file imports all relevant libraries and specifies the URL for all test requests. The main test function replicates the scenario of UI actions recorded by the Playwright trace file, in exact chronological order of actions performed.

Skyramp generates intelligent UI selectors configured to automatically adapt to application changes and avoid brittle selectors that break with every UI update. Instead of relying on fragile CSS classes or XPath positions, it creates robust selectors using semantic HTML structure, visual context, and multiple fallback strategies. This significantly reduces test maintenance overhead, eliminates false test failures that block deployments, and allows teams to focus on building features rather than constantly fixing broken tests.

Further, Skyramp automatically adds intelligent waiting logic in the test to ensure that a web page fully loads its JavaScript code (a process otherwise known as hydration). These waits lead to less flaky tests since they ensure elements on the page being validated against appear and do not cause the test to timeout.

When a UI test is generated via the Skyramp agentic experience (available via VSCode Extension or MCP Server), the generated test is automatically parameterized and modularized to make the test code more readable and allow for potential re-usability of code.

### Skyramp Core Library Capabilities—E2E Test

Skyramp core library is configured to generate E2E tests. CLI can be used to access functionality but the same features can be activated in the Skyramp agentic Experience by including a reference in the natural language prompt.

An end-to-end (E2E) test validates the entire workflow of an application from start to finish, simulating real-world user scenarios. It ensures that all integrated components, including front-end, back-end, and external systems, work together seamlessly to deliver the expected functionality and performance. To generate E2E tests that span across multiple endpoints or services, Skyramp uses a trace to generate the test case reliably. A trace is a log of a set of actions executed in a particular window or scenario in your system. Traces can be used to simulate real-world scenarios of product usage, and those traces can in turn be used to generate tests that give you confidence that said scenario will be resilient in production traffic.

Skyramp can function as a “Man-in-the-Middle” proxy that monitors traffic and is configured to record a scenario to be tested. Skyramp can collect traffic from different sources including but not limited to HTTP traffic from a browser UI, backend traffic through the CLI, and UI traces through the recorder (e.g., Playwright).

To collect a trace for direct use in Skyramp test generation, a command is executed to spawn a new shell configured to collect all relevant backend network traffic as well as a Playwright Browser and Inspector. All visited web links traffic will also be part of the collected trace. The command is configured to enable Playwright to capture UI activities, specify a comma-separated list of URLs for which Skyramp will collect traces (Skyramp will only collect traces for those domains and exclude all others), specify the name of the generated Skyramp trace file, and specify the name of the generated Playwright trace file.

Skyramp is configured to execute the command to collect the trace without any additional adjustments to the code, however adjustments are available for use to tune the command. The adjustments include but are not limited to flags to specify a comma-separated list of URLs for which Skyramp is not to collect traces, the name (string) of the Docker network, and a port number for Skyramp. The spawned shell and Playwright Browser are used by Skyramp to collect the traces for the targeted test scenario.

Upon completion of the scenario used for trace collection, the trace collection is ended in the spawned shell. Endpoints for which Skyramp was able to collect backend traces are then revealed. Skyramp creates two trace files including a first file including the backend traces that were collected and a second file which is a zip file including all collected traces from Playwright. Both traces will be used for the generation of the E2E test.

Skyramp is configured to generate the E2E test from the collected trace information in response to a command. Upon completion, Skyramp creates a fully executable Python test file (e2e_test.py) that can be run immediately. Unlike other commands, test generation from a trace does not require a specified URL because all relevant information is extracted directly from the trace. The command to generate the trace specifies the test output language and the test execution framework of choice, points to the Skyramp-collected trace used to generate the test (all relevant scenario and request information is extracted directly from this file), and points to the Playwright trace used to generate the test (all relevant scenario information and UI actions are extracted directly from this file).

While Skyramp can execute the generated E2E test without any additional adjustments to the code, adjustments can be used to tune the test. The adjustments include but are not limited to a flag to specify a comma-separated list of URLs for Skyramp to generate requests (use of this flag automatically excludes all other domains from the test, a flag to specify a comma-separated list of URLs for which Skyramp is not to generate requests (use of this flag will only exclude the domains specified in the command and keep all other domains in the test), a flag to specify the name of the generated test file, and a flag to specify the directory to write the generated test file.

The Skyramp E2E test when executed enables simulation of more complex customer scenarios by allowing the developer to define a test scenario using both UI actions and API calls. At runtime, Skyramp automatically detects flaky selectors and replaces them with more stable alternatives. It also identifies when additional hydration is needed, ensuring the target application is fully loaded before the next action runs and thereby reducing test flakiness and improving overall reliability. Skyramp generates resilient UI selectors that adapt to application changes, reducing test maintenance and eliminating false failures caused by fragile CSS or XPath selectors. Furthermore, Skyramp automatically adds intelligent waiting logic in the test to ensure that a web page fully loads its JavaScript code (a process otherwise known as hydration). These waits lead to less flaky tests since they ensure elements on the page being validated against appear and do not cause the test to timeout. When an E2E test is generated via the Skyramp agentic experience (available via VSCode Extension or MCP Server), the generated test is automatically parameterized and modularized to make the test code more readable and allow for potential re-usability of code.

Upon execution the test automatically identifies the relevant path parameters, intelligently chains the different requests together, and executes the test against the captured URLs. Test outputs are printed (e.g., Pytest) by printing a line for each test that is being run and listing all failures at the end.

The generated E2E test enables simulation of more complex customer scenarios by allowing developers to define a test scenario using both UI actions and API calls. Skyramp generates intelligent UI selectors configured to automatically adapt to application changes and avoid brittle selectors that break with every UI update. Instead of relying on fragile CSS classes or XPath positions, it creates robust selectors using semantic HTML structure, visual context, and multiple fallback strategies. This significantly reduces test maintenance overhead, eliminates false test failures that block deployments, and allows teams to focus on building features rather than constantly fixing broken tests.

Skyramp automatically adds intelligent waiting logic in the test to ensure that a web page fully loads its JavaScript code (a process otherwise known as hydration). These waits lead to less flaky tests since they ensure elements on the page being validated against appear and do not cause the test to timeout.

When a UI test is generated via the Skyramp agentic experience (available via VSCode Extension or MCP Server), the generated test is automatically parameterized and modularized to make the test code more readable and allow for potential re-usability of code.

### Skyramp Testbot

To achieve AI-accelerated development, development teams adopted coding assistants that can generate code instantly. But this breaks a fundamental assumption in modern software development: that engineers can keep regression tests synchronized with the system as it evolves. While AI removes much of the cost of writing code, it does not remove the cost of verifying it. As code begins to evolve at machine speed, the regression suite falls behind. Tests become stale, noisy, and incomplete, and CI stops being a reliable signal. Verification becomes the bottleneck.

A common assumption is that LLMs can simply generate tests automatically. In practice that approach breaks down once those tests run against real systems. Reliable testing is not just a generation problem but is instead about maintaining a set of invariants as the codebase evolves. Tests need to remain structurally stable, so generated tests can be maintained automatically and integrate with existing fixtures, page-object models, and modular test code. They also need to remain behaviorally correct, meaning they interact with the system the same way real users and services do, across authentication, distributed services, and UI state, without relying on brittle assumptions about selectors or implicit application state. Further, tests need to remain environment-safe, meaning tests are idempotent, isolate their setup and teardown, and do not corrupt the environments in which they run. The invariants only become visible once large, automated test suites are run against real systems, and they are the reason naive approaches to automated test generation tend to fail in practice.

Experience shows solving this requires two things working together. First, the system must infer what behaviors a PR is intended to preserve or change, using workspace-level intelligence about the repository and its execution environment. Second, the system must deterministically synthesize and maintain corresponding tests so they remain structurally stable as the system evolves. Testbot does this by automatically recommending, generating, validating, and maintaining regression tests for every PR so that development can accelerate without sacrificing reliability.

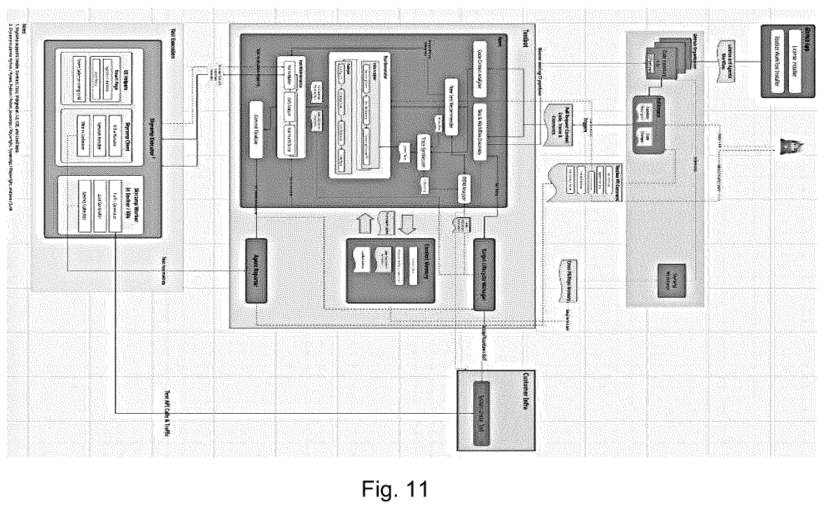

The Skyramp agentic layer includes or couples to the testbot system component as described in detail herein. FIG. 11 is a block diagram of the Skyramp architecture comprising the testbot, under an embodiment. The testbot is configured to automatically recommend, generate, validate, and maintain AI-powered regression tests for every PR so that development can accelerate without sacrificing reliability. Testbot operates within the code editor (e.g., VS Code or Cursor) to bring “vibe testing” (using conversational AI to create and execute software tests) to developer workflows by automatically generating, maintaining, and executing comprehensive test suites.

Testbot comprises components including but not limited to a testbot agent, target lifecycle manager, context memory, and an agent reporter. The testbot agent, which receives inputs comprising pull request context, code, traces, and comments as well as information of CI pipelines of the development environment, is coupled to the target lifecycle manager, context memory, and agent reporter. The agent outputs are coupled as inputs to the Skyramp executor. The executor outputs are coupled to the agent reporter and the system under test

Testbot comprises an invariant framework comprising automated verification systems to preserve a set of invariants as both the target application and the test suite evolve. Invariants are constraints on software components which restrict their behavior in some desirable way, but whose maintenance entails some kind of proof obligation discharge. Such constraints may act not only over the input and output domains, as in a purely functional setting, but also over the underlying state space, as in the case of reactive components. These invariants arise from the behavior of real systems rather than from any specific implementation of Testbot. A software system invariant is a logical condition or property that must always remain true throughout the execution of a program or a specific phase of its operation. Invariants serve as the “ground truths” of a system, ensuring its state remains consistent and valid even as data changes or operations occur.

Invariants are typically categorized by where and when they must hold true. Key types of invariants include but are not limited to loop invariants, class/object invariants, representation invariants, system-level invariants, and domain invariants.

A loop invariant comprises a property that is true before a loop begins, at the start of every iteration, and after the loop terminates. These are essential for proving the correctness of algorithms.

Class/object invariants include constraints that must hold for every instance of a class throughout its observable lifetime, specifically after construction, before destruction, and before/after any public method call.

Representation invariants comprise rules defining the required structure for a data structure to be considered valid (e.g., a binary search tree's left child must always be less than its parent).

System-level invariants include high-level properties spanning the entire system, such as a financial ledgers total supply always equaling the sum of all user balances.

Domain invariants include business rules that define the fundamental laws of a specific application context (e.g., “no user can withdraw more than their current balance”).

Skyramp includes invariants configured to include invariants which provide a formal way to reason about whether code does what it is supposed to do. If an invariant is violated, the system is in an incorrect state.

Invariants of embodiments are further configured (often via assertions) to help catch bugs early at the point of origin rather than letting errors propagate. Skyramp invariants also define the security boundaries of a system. Auditors use them to identify potential exploits by trying to find ways to violate these “immutable” rules.

Skyramp invariants are further configured to act as a contract between different parts of the software, clearly communicating what a developer can rely on without needing to check the internals of a function or class.

Regarding enforcement and detection, while many invariants are implicit in a developer's mind, they can be made explicit through assertions and contracts, static analysis, and dynamic inference. Under assertions and contracts, code (e.g., assert (balance >=0) or specialized libraries (e.g., Microsoft Code Contracts) are configured to verify conditions at runtime. Static analysis includes tools that check code for potential invariant violations during the compilation phase. Using dynamic inference, tools like Daikon analyze program execution traces to automatically detect likely invariants that the programmer may have missed.

Invariant Framework (with Mechanisms)

The invariant framework of Skyramp comprises automated verification systems to preserve a set of invariants as both the target application and the test suite evolve. The invariants preserved by Skyramp include but are not limited to structural stability, behavioral correctness, and environment safety. A description follows of each Skyramp invariant including the invariant definition, why it exists (failure modes), and the mechanisms used by the system to enforce the variant.

### Structural Stability Invariant

The structural stability invariant requires tests that remain structurally stable as the implementation evolves. A test should continue to express the same verification intent even when the underlying implementation details change. The structural stability invariant exists because software systems evolve continuously. Small refactors frequently change implementation details while preserving behavior. Typical failure cases include but are not limited to CSS classes or DOM structure changing, API fields or response formats evolving, helper functions being reorganized, UI components being wrapped or refactored, and framework upgrades altering internal interfaces. When tests are tied directly to these implementation details they become brittle and break even though the system behavior remains correct.

Testbot is configured to enforce structural stability invariants through deterministic synthesis and structural control over generated tests. Key mechanisms to enforce structural stability invariants include but are not limited to AST-based deterministic synthesis, integration with existing testing abstractions, and test modularization and reuse. Using AST-based deterministic synthesis, tests are generated and maintained as structured programs rather than free-form text, allowing the system to modify them structurally as the code evolves. Integration with existing testing abstracts comprises generated tests reusing fixtures, page-object models, and helper libraries so the tests conform to the repository's architecture.

### Behavioral Correctness Invariant

The behavioral correctness invariant requires tests to interact with the system the same way real users and services do in that they must respect the actual runtime dependency graph and behavior of the application. The behavioral correctness invariant exists because real applications operate across multiple layers of state and distributed services. Valid execution depends on satisfying the same conditions that real interactions require.

Examples of the behavioral correctness invariant include system interaction boundaries, behavioral preconditions, and execution realism but are not so limited. System interaction boundaries comprise authentication and session flows, frontend/backend boundaries, distributed service interactions, internal APIs and service meshes, Kubernetes networking and cluster services, and infrastructure dependencies. Behavioral preconditions comprise authenticated sessions required before actions, dependency chains between services, database state prerequisites, foreign-key constraints, and workflow ordering requirements. Execution realism comprises multi-service transactions, concurrent requests and load conditions, and real user workflows. When tests ignore these behavioral constraints they may pass in isolation while failing to represent real system behavior.

Testbot is configured to enforce the behavioral correctness invariant through system-level reasoning about the repository and its runtime environment. Key mechanisms to enforce behavioral correctness invariants include but are not limited to PR success-criteria inference, workspace-level intelligence, test recommendation engine, and execution across real system boundaries. Under the PR success-criteria inference, Skyramp analyzes the pull request together with repository context to infer what behaviors the change is intended to preserve or modify. Workspace-level intelligence comprises structured knowledge about the repository captures code structure, dependencies, historical test behavior, and coverage. Skyramp includes a test recommendation engine configured to enforce behavioral correctness invariants by, rather than generating tests blindly, determining which tests should be created, updated, or retired. Skyramp is further configured for execution across real system boundaries in that the execution environment allows tests to interact with real infrastructure boundaries including distributed services and internal networking.

### Environment Safety Invariant

The environment safety invariant requires that tests not corrupt the execution environment. Each test must execute in a way that preserves the integrity of shared system state. This invariant exists because test environments often share infrastructure such as databases, staging services, or distributed clusters. Without careful isolation, tests interfere with one another.

Typical failure modes include but are not limited to state contamination, execution collisions, and incomplete cleanup as described here. The state contamination failure mode involves leftover test data, duplicate resources, and shared database mutations. Execution collisions refer to concurrent tests modifying shared state, and resource contention or deadlocks. The incomplete cleanup failure mode involves partial test failures leaving orphaned state, and side effects breaking later tests.

Testbot is configured to enforce the environment safety invariant through controlled execution and lifecycle management. Skyramp comprises target lifecycle management configured to enforce this invariant by managing the deployment and lifecycle of the system under test. Management of the deployment and lifecycle under an embodiment includes automatic resource cleanup and state isolation, and a test maintenance engine. Execution feedback triggers updates to tests when environment safety violations are detected.

### Global Verification Mechanism

Skyramp embodiments described herein comprise a global verification mechanism including a hidden executor loop configured to enforce all invariants simultaneously rather than belonging to a single invariant. The global verification mechanism operates to execute generated or updated tests internally before being surfaced to developers. This execution stage validates that the tests satisfy all invariants by detecting structural instability, behavioral inconsistencies, environment contamination, and flaky or nondeterministic behavior. The system may perform multiple internal runs, feeding execution feedback into the maintenance engine until the tests stabilize. Once it is determined the tests satisfy the invariants they surfaced to the user.

### Secondary Invariants (Emergent)

Skyramp further comprises secondary invariants configured to arise once the primary invariants are enforced. The secondary invariants of embodiments include but are not limited to an economical efficiency invariant, a temporal determinism invariant, and a compliance safety invariant.

Under the economical efficiency invariant Skyramp is configured to maximize verification signal while minimizing execution cost by pruning redundant tests, selecting minimal test sets per PR, and changing-impact analysis for coverage.

The temporal determinism invariant is configured to ensure tests remain stable despite asynchronous behavior. This invariant is configured to enable Skyramp to control or avoid network latency variation, race conditions, eventual consistency delays, async workflows to name a few.

The compliance safety invariant is configured to ensure tests avoid exposing sensitive data. This invariant is configured to enable Skyramp to prevent PII leakage, prevent credentials in test artifacts, and sanitize test inputs to name a few.

### Architecture Layers

The Skyramp system architecture of embodiments comprises three layers that together maintain the verification invariants. A first layer is configured to perform verification planning configured to infer PR success criteria and determine what verification artifacts should exist. A second layer is configured to perform verification artifact synthesis by generating and updating those artifacts deterministically. A third layer is configured to perform verification stabilization by validating tests privately against the real system until the tests satisfy the invariants.

The verification planning layer is configured to use pull-request context and workspace intelligence to infer what behaviors the change is intended to modify or preserve. This layer determines what tests should exist, which existing tests should be updated, and which tests have become stale but is not so limited.

The verification artifact synthesis layer is configured to generate or update selected tests through deterministic synthesis. This layer includes but is not limited to perform AST-based generation, modularization and reuse, parameterization of test inputs, and integration with repository test structures.

The verification stabilization layer is configured to deploy the system under test and execute tests internally. The hidden executor loop validates invariants, feeds failures into the maintenance engine, and repeats until the tests stabilize. Only then are the results surfaced to the developer.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The invention is preferably implemented using hardware, software or a combination of hardware and software. The software can also be embodied as computer readable code on a computer readable medium. The computer readable medium is any data storage device that can store data that can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The description herein is presented to enable any person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown but is to be accorded the widest scope consistent with the claims.

While this invention has been described in terms of several preferred embodiments, there are alterations, permutations, and equivalents, which fall within the scope of this invention. It should also be noted that there are many alternative ways of implementing the methods and apparatuses of the present invention. Further, the various aspects, embodiments, implementations or features of the invention can be used separately or in any combination. It is therefore intended that the following appended claims be interpreted as including all such alterations, permutations, and equivalents as fall within the true spirit and scope of the present invention.

What is claimed is:

1. A system comprising:
a library component executing on a client computer and comprising a deployer to deploy in a cluster a microservice of an application; and
a worker component executing in the cluster and coupled to the library component, wherein the worker component comprises a tester to execute a test of operation of the microservice, wherein the test is a regression test; and
an agentic component coupled to the library component to automatically generate, validate, and maintain the test to preserve a set of invariants as code of the microservice and the application change during development.

2. The system of claim 1, wherein the agentic component comprises at least one of a verification planning component, a verification artifact synthesis component, and a verification stabilization component.

3. The system of claim 2, wherein the verification planning component is configured to infer success criteria of a pull-request (PR) and determine verification artifacts that should exist.

4. The system of claim 3, wherein the verification artifact synthesis component is configured to generate and update the artifacts.

5. The system of claim 4, wherein the verification stabilization component is configured to validate the artifacts privately against the microservice until the artifacts satisfy the set of invariants.

6. The system of claim 2, wherein the verification planning component is configured to use intelligence about a repository and execution environment of the system corresponding to a pull-request (PR) to determine behavior the PR is intended to at least one of preserve and change.

7. The system of claim 6, wherein the verification planning component is configured to determine at least one of what tests should exist, which existing tests should be updated, and which existing tests have become stale.

8. The system of claim 2, wherein the verification artifact synthesis component is configured to use deterministic synthesis to at least one of generate and update tests.

9. The system of claim 8, wherein the verification artifact synthesis component is integrated with system repository test structures.

10. The system of claim 8, wherein the verification artifact synthesis component is configured to use abstract syntax tree (AST) as a base for the generation of tests.

11. The system of claim 8, wherein the verification artifact synthesis component is configured to modularize test files to create parameterized test functions configured for reuse in at least one additional test case.

12. The system of claim 2, wherein the verification stabilization component is configured to execute tests internally against the microservice.

13. The system of claim 12, wherein the verification stabilization component includes an executor loop configured to validate the invariants and feed failures into a maintenance engine.

14. The system of claim 13, wherein the verification stabilization component is configured to repeat the validation of the invariants and the feeding of failures into a maintenance engine until the tests stabilize.

15. The system of claim 14, wherein the verification stabilization component is configured to output results of the tests when the tests stabilize.

16. The system of claim 1, wherein the set of invariants includes a structural stability invariant.

17. The system of claim 16, wherein the test is configured to maintain a same verification intent when underlying implementation details of the test change.

18. The system of claim 17, wherein changes in the implementation details comprise at least one of cascading style sheets (CSS) classes, document object model (DOM) structure, API fields, response formats, helper functions, UI components, framework upgrades.

19. The system of claim 16, wherein the test is generated and maintained as a structured program, wherein generating the test comprises modifying the test structurally during the development.

20. The system of claim 16, wherein the test is generated to reuse at least one of fixtures, page-object models, and helper libraries so the tests conform to an architecture of the repository.

21. The system of claim 16, wherein the test is restructured into reusable components configured to propagate structural changes consistently.

22. The system of claim 1, wherein the set of invariants includes a behavioral correctness invariant.

23. The system of claim 22, wherein the test is configured to interact with the microservice in a way real users and services interact with the microservice.

24. The system of claim 23, wherein the test is configured to conform with an actual runtime dependency graph and behavior of the microservice.

25. The system of claim 22, wherein the test is configured to operate with behavioral preconditions and operate across multiple layers of state and distributed services in a way real users and services interact with the application.

26. The system of claim 22, wherein a pull-request (PR) and context of a code repository corresponding to at least one of the test and the microservice are analyzed to infer behavior that a change is intended to preserve or modify.

27. The system of claim 22, wherein structured knowledge is generated about a code repository corresponding to at least one of the test and the microservice to capture information of code structure, dependencies, historical test behavior, and coverage.

28. The system of claim 22, wherein a test t is determined to be at least one of created, updated, and retired.

29. The system of claim 22, wherein the test is configured to interact with infrastructure boundaries including distributed services and internal networking.

30. The system of claim 1, wherein the set of invariants includes an environment safety invariant.

31. The system of claim 30, wherein the test is configured to avoid corrupting an execution environment.

32. The system of claim 31, wherein the test is configured to execute to avoid interfering with other tests in a test environment, wherein the interfering comprises at least one of state contamination, execution collisions, and incomplete cleanup.

33. The system of claim 30, wherein the test is isolated to avoid interference with shared infrastructure of associated test environments, wherein the shared infrastructure includes at least one of databases, staging services, and distributed clusters.

34. The system of claim 30, wherein the test is configured to execute to preserve integrity of shared system state.

35. The system of claim 30, wherein deployment and lifecycle of the test are managed to enforce the environment safety invariant.

36. The system of claim 35, wherein resource cleanup and state function are automatically performed to enforce the environment safety invariant.

37. The system of claim 35, wherein the test is updated when execution feedback detects violations of the environment safety invariant.

38. The system of claim 1, wherein the worker component comprises a mocker to execute a mock to mimic endpoints of the microservice in the cluster during the test.

39. A system comprising:
a worker component executing in a cluster and coupled to a library component executing on a client computer, wherein the worker component comprises a tester to execute a test of operation in the cluster of an application, wherein the test is a regression test; and
an agentic component coupled to the library component to automatically generate, validate, and maintain the test to preserve a set of invariants as code of the application changes during development.
